(19) United States
(12) Patent Application Publication
(10) Pub. No.: US 2014/0058763 A1
(43) Pub. Date: Feb. 27, 2014

(54) Fraud detection methods and systems

(71) Applicant: Deloitte Development LLC, Hermitage, TN (US)

(72) Inventors: Frank M. Zizzamia, Collinsville, CT (US); Michael F. Greene, Boston, MA (US); John R. Lucker, Simsbury, CT (US); Steven E. Ellis, Linthicum Heights, MD (US); James C. Guszcza, Santa Monica, CA (US); Steven L. Berman, Havertown, PA (US); Amin Torabkhani, New York, NY (US)

(21) Appl. No.: 13/987,437

(22) Filed: Jul. 24, 2013

Related U.S. Application Data
(60) Provisional application No. 61/675,095, filed on Jul. 24, 2012.
(60) Provisional application No. 61/783,971, filed on Mar. 14, 2013.

(51) Int. Cl. G06Q 40/08

(52) U.S. Cl. CPC G06Q 40/08
USPC 705/4

(57) ABSTRACT

An unsupervised statistical analytics approach to detecting fraud utilizes cluster analysis to identify specific clusters of claims or transactions for additional investigation, or utilizes association rules as tripwires to identify outliers. The clusters or sets of rules define a “normal” profile for the claims or transactions used to filter out normal claims, leaving “not normal” claims for potential investigation. To generate clusters or association rules, data relating to a sample set of claims or transactions may be obtained, and a set of variables used to discover patterns in the data that indicate a normal profile. New claims may be filtered, and not normal claims analyzed further. Alternatively, patterns for both a normal profile and an anomalous profile may be discovered, and a new claim filtered by the normal filter. If the claim is “not normal” it may be further filtered to detect potential fraud.

### CROSS-REFERENCE TO RELATED PROVISIONAL APPLICATIONS

This application claims the benefit of U.S. Provisional Patent Application Nos. 61/675,095 filed on Jul. 24, 2012, and 61/783,971 filed on Mar. 14, 2013, the disclosures of which are hereby incorporated herein by reference in their entireties.

### COPYRIGHT NOTICE

Portions of the disclosure of this patent document contain materials that are subject to copyright protection. The copyright owner has no objection to the facsimile reproduction of the patent document or patent disclosure as it appears in the U.S. Patent and Trademark Office patent files or records solely for use in connection with consideration of the prosecution of this patent application, but otherwise reserves all copyright rights whatsoever.

### FIELD OF THE INVENTION

The present invention generally relates to new machine learning, quantitative anomaly detection methods and systems for uncovering fraud, particularly, but not limited to, insurance fraud, such as is increasingly prevalent in, for example, automobile insurance coverage of third party bodily injury claims (hereinafter, “auto BI” claims), unemployment insurance claims (hereinafter, “UI” claims), and the like.

### BACKGROUND OF THE INVENTION

Fraud has long been and continues to be ubiquitous in human society. Insurance fraud is one particularly problematic type of fraud that has plagued the insurance industry for centuries and is currently on the rise.

In the insurance context, because bodily injury claims generally implicate large dollar expenditures, such claims are at enhanced risk for fraud. Bodily injury fraud occurs when an individual makes an insurance injury claim and receives money to which he or she is not entitled—by faking or exaggerating injuries, staging an accident, manipulating the facts of the accident to incorrectly assign fault, or otherwise deceiving the insurance company. Soft tissue, neck, and back injuries are especially difficult to verify independently, and therefore faking these types of injuries is popular among those who seek to defraud insurers. It is estimated that 36% of all bodily injury claims, for example, involve some type of fraud.

In the unemployment insurance arena, about $54.8 billion UI benefits are paid annually in the U.S., of which about $6.0 billion are paid improperly. It is estimated that roughly $1.5 billion, or about 2.7% of benefits, of such improper payments are paid out on fraudulent claims. Additionally, roughly half of all UI fraud is not detected by the states, as determined by state level BAM (Benefit Accuracy Measurement) audits.

One type of insurance that is particularly susceptible to claims fraud is auto BI insurance, which covers bodily injury of the claimant when the insured is deemed to have been at-fault in causing an automobile accident. Auto BI fraud increases costs for insurance companies by increasing the costs of claims, which are then passed on to insured drivers. The costs for exaggerated injuries in automobile accidents alone have been estimated to inflate the cost of insurance coverage by 17-20% overall. For example, in 1995, premiums for the typical policy holder increased about $100 to $130 per year, totaling about $9-$13 billion.

One difficulty faced in the auto BI space is that the insurer does not often know much about the claimant. Typically, the insurer has a relationship with the insured, but not with the third party claimant. Claimant information is uncovered by the claims adjuster during the course of handling a claim. Typically, adjusters in claims departments communicate with the claimants, ensure that the appropriate coverage is in place, review police reports, medical notes, vehicle damage reports and other information in order to verify and pay the claims.

To combat fraud, many insurance companies employ Special Investigative Units (SIUs) to investigate suspicious claims to identify fraud so that payments on fraudulent claims can be reduced. If a claim appears to be suspicious, the claims adjuster can refer the claim to the SIU for additional investigation. A disadvantage of this approach is that significant time and skilled resources are required to investigate and adjudicate claim legitimacy.

Claims adjusters and SIU investigators are trained to identify specific indicators of suspicious activity. These “red flags” can tip the claims professional to fraudulent behavior when certain aspects of the claim are incongruous with other aspects. For example, red flags can include a claimant who retains an attorney for minor injuries, or injuries reported to the insurer well after the claim was reported, or, in the case of an auto BI claim, injuries that seem too severe based on the damage to the vehicle. Indeed, claims professionals are well aware that, as noted above, certain types of injuries (such as soft tissue injuries to the neck and back, which are more difficult to diagnose and verify, as compared to lacerations, broken bones, dismemberment or death) are more susceptible to exaggeration or falsification, and therefore more likely to be the bases for fraudulent claims.

There are many potential sources of fraud. Common types in the auto BI space, for example, are falsified injuries, staged accidents, and misrepresentations about the incident. Fraud is sometimes categorized as “hard fraud” and “soft fraud,” with the former including falsified injuries and incidents, and the latter covering exaggerations of severity involved with a legitimate event. In practice, however, there is a spectrum of fraud severity, covering all manner of events and misrepresentations.

Generally speaking, a fraudulent claim can be uncovered only if the claim is investigated. Many claims are processed and not investigated; and some of these claims may be fraudulent. Also, even if investigated, a fraudulent claim may not be recognized. Thus, most insurers do not know with certainty, and their databases do not accurately reflect, the status of all claims with respect to fraudulent activity. As result, some conventional analytical tools available to mine for fraud may not work effectively. Such cases, where some claims are not properly flagged as fraudulent, are said to present issues of “censored” or “unlabeled” target variables.

Predictive models are analytical tools that segment claims to identify claims with a higher propensity to be fraudulent. These models are based on historical databases of claims and patterns of fraud within those databases. There are two basic categories of predictive models for detecting fraud, each of which works in a different manner: supervised models and unsupervised models.

Supervised models are equations, algorithms, rules, or formulas that are trained to identify a target variable of interest from a series of predictive variables. Known cases are shown to the model, which learns the patterns in and amongst the predictive variables that are associated with the target variable. When a new case is presented, the model provides a prediction based on the past data by weighting the predictive variables. Examples include linear regression, generalized linear regression, neural networks, and decision trees.

A key assumption of these models is that the target variable is complete—that it represents all known cases. In the case of modeling fraud, this assumption is violated as previously described. There are always fraudulent claims that are not investigated or, even if investigated, not uncovered. In addition, supervised predictive models are often weighted based on the types of fraud that have been historically known. New fraud schemes are always presenting themselves. If a new fraud scheme has been devised, the supervised models may not flag the claim, as this type of fraud was not part of the historical record. For these reasons, supervised predictive models are often less effective at predicting fraud than other types of events or behavior.

Unlike supervised models, unsupervised predictive models are not trained on specific target variables. Rather, unsupervised models are often multivariate and constructed to represent a larger system simultaneously. These types of models can then be combined with business knowledge and claims handling and investigation expertise to identify fraudulent cases (both of the type previously known and previously unknown). Examples of unsupervised models include cluster analysis and association rules.

Accordingly, there is a need for an unsupervised predictive model that is capable of identifying fraudulent claims, so that such claims can be identified earlier in the claim lifecycle and routed more effectively for claims handling and investigation.

### SUMMARY OF THE INVENTION

Generally speaking, it is an object of the present invention to provide processes and systems that leverage advanced unsupervised statistical analytics techniques to detect fraud, for example in insurance claims. While the inventive embodiments are variously described herein, in the context of auto BI insurance claims and, also, “UI” claims, it should be understood that the present invention is not limited to uncovering fraudulent auto BI claims or UI claims, let alone fraud in the broader category of insurance claims. The present invention can have application with respect to uncovering other types of fraud.

Two principal instantiations of the invention are described hereinafter: the first, utilizing cluster analysis to identify specific clusters of claims for additional investigation; the second, utilizing association rules as tripwires to identify out-of-the-ordinary claims or “outliers” to be assigned for additional investigation.

Regarding the first instantiation, the process of clustering can segment claims into groups of claims that are homogeneous on many dimensions simultaneously. Each cluster can have a different signature, or unique center, defined by predictive variables and described by reason codes, as discussed in greater detail hereinafter (additionally, reason codes are addressed in U.S. Pat. No. 8,200,511 titled “Method and System for Determining the Importance of Individual Variables in a Statistical Model” and its progeny—namely, U.S. patent application Ser. Nos. 13/463,492 and 61/792,629—which are owned by the Applicant of the present case, and which are hereby incorporated herein by reference in their entireties). The clusters can be defined to maximize the differences and identify pockets of like claims. New claims that are filed can be assigned to a cluster, and all claims within the cluster can be treated similarly based on business experience data, such as expected rates of fraud and injury types.

Regarding the second, association rules, instantiation, a pattern of normal claims behavior can be constructed based on common associations between claim attributes (for example, 95% of claims with a head injury also have a neck injury). Probabilistic association rules can be derived on raw claims data using, for example, the Apriori Algorithm (other methods of generating probabilistic association rules can also be utilized). Independent rules can be selected that describe strong associations between claim attributes, with probabilities greater than 95%, for example. A claim can be considered to have violated the rules if it does not satisfy the initial condition (the “Left Hand Side” or “LHS” of the rule), but satisfies the subsequent condition (the “Right Hand Side” or “RHS”), or if it satisfies the LHS but not the RHS. If the rules describe a material proportion of the probability space for the RHS conditions, then violating many of the rules that map to the RHS space are an indication of anomalous claims.

The choice of the number of rules that must be violated before sending a claim for further investigation is dependent on the particular data and situation being analyzed. Choosing fewer rules violations for which a claim is submitted to SIU can result in more false positives; choosing more rules violations can decrease false positives, but may allow truly fraudulent claims to escape detection.

Still other aspects and advantages of the present invention will in part be obvious and will in part be apparent from the specification.

The present invention accordingly comprises the several steps and the relation of one or more of such steps with respect to each of the others, and embodies features of construction, combinations of elements, and arrangement of parts adapted to effect such steps, all as exemplified in the detailed disclosure hereinafter set forth, and the scope of the invention will be indicated in the claims.

### BRIEF DESCRIPTION OF THE DRAWINGS

The patent or application file contains at least one drawing executed in color. Copies of this patent or patent application publication with color drawings will be provided by the Office upon request and payment of the necessary fee.

For a fuller understanding of the invention, reference is made to the following description, taken in connection with the accompanying drawings, in which:

FIG. 1 illustrates an exemplary process of scoring and routing claims using a clustering instantiation of the present invention;

FIG. 2 illustrates an exemplary process for scoring and routing claims using an association rules instantiation of the present invention;

FIG. 3 is an exemplary rules process and recalibration system flow according to an embodiment of the present invention;

FIG. 4 illustrates an exemplary process according to an embodiment of the present invention by which clusters can be defined;

FIG. 5 illustrates an exemplary process according to an embodiment of the present invention by which association rules can be defined;

FIG. 6 depicts an exemplary heat map representation of the profile of each cluster generated in a process of scoring and routing claims using a clustering instantiation of the present invention;

FIG. 7 illustrates an exemplary data-driven cluster evaluation process according to an embodiment of the present invention;

FIG. 8 depicts an exemplary decision tree used to further investigate a cluster according to an embodiment of the present invention;

FIG. 9 depicts an exemplary heat map clustering profile in the context of identifying unemployment insurance fraud according to an embodiment of the present invention;

FIG. 10 graphically depicts the lag between loss date and the date an attorney was hired in the context of an auto BI claim being scored using association rules according to an embodiment of the present invention;

FIG. 11 graphically depicts loss date to attorney lag splits to illustrate an aspect of binning variables in the context of an auto BI claim being scored using association rules according to an embodiment of the present invention;

FIGS. 12a and 12b graphically depict property damage claims made by a claimant over a period of time as well. as a natural binary split to illustrate an aspect of binning variables in the context of an auto BI claim being scored using association rules according to an embodiment of the present invention;

FIG. 13 illustrates an exemplary automated binning process having applicability to scoring both auto BI claims and UI claims using association rules according to an embodiment of the present invention;

FIGS. 14a-14d show sample results of applying the binning process illustrated in FIG. 13 to an applicant's age with a maximum of 6 bins;

FIGS. 15 and 16 illustrate exemplary processes for testing association rules in the context of both auto BI claims and UI claims according to an embodiment of the present invention;

FIGS. 17a and 17b graphically depict the length of employment in days variable for the construction industry before and after a binning process in the context of a UI claim being scored using association rules according to an embodiment of the present invention;

FIGS. 18a and 18b graphically depict the number of previous employers of an applicant over a period of time as well as a natural binary split to illustrate an aspect of binning variables in the context of a UI claim being scored using association rules according to an embodiment of the present invention; and

FIG. 19 illustrates how using a combination of normal and anomaly rules on a set of claims or transactions can significantly increase the detection of fraud in exemplary embodiments of the present invention.

### DETAILED DESCRIPTION OF THE PREFERRED EMBODIMENTS

As noted above, two principal instantiations of the invention are described herein—the first, utilizes cluster analysis to identify specific clusters of claims for additional investigation. The second utilizes association rules to quantify “normal” behavior, and thus set up a series of “tripwires” which, when violated or triggered, indicate “non-normal” claims, which can be referred to a user for additional investigation. Generally, if properly implemented, fraud is found in the “non-normal” profile. These two instantiations are next described; first the clustering, followed by the association rules.

It is also noted that in the following description the term “claim” is repeatedly used as the object, construct or device in which the fraud is assumed to be perpetrated. This was found to be convenient to describe exemplary embodiments dealing with automotive bodily injury claims, as well as unemployment insurance claims. However, this use is merely exemplary, and the techniques, processes, systems and methods described herein are equally applicable to detecting fraud in any context, in claims, transactions, submissions, negotiations of instruments, etc., for example, whether it is in a submitted insurance claim, a medical reimbursement claim, a claim for workmen's compensation, a claim for unemployment insurance benefits, a transaction in the banking system, credit card charges, negotiable instruments, and the like. All of these constructs, devices, transactions, instruments, submissions and claims are understood to be within the scope of the present invention, and exemplified in what follows by the term “claim.”

### I. Cluster Analysis Instantiation

In order to separate fraudulent from legitimate claims, claims can be grouped into homogenous clusters that are mutually exclusive (i.e., a claim can be assigned to one and only one cluster). Thus, the clusters are composed of homogeneous claims, with little variation between the claims within the cluster for the variables used in clustering. The clusters can be defined on a multivariate basis and chosen to maximize the similarity of the claims within each cluster on all the predictive variables simultaneously.

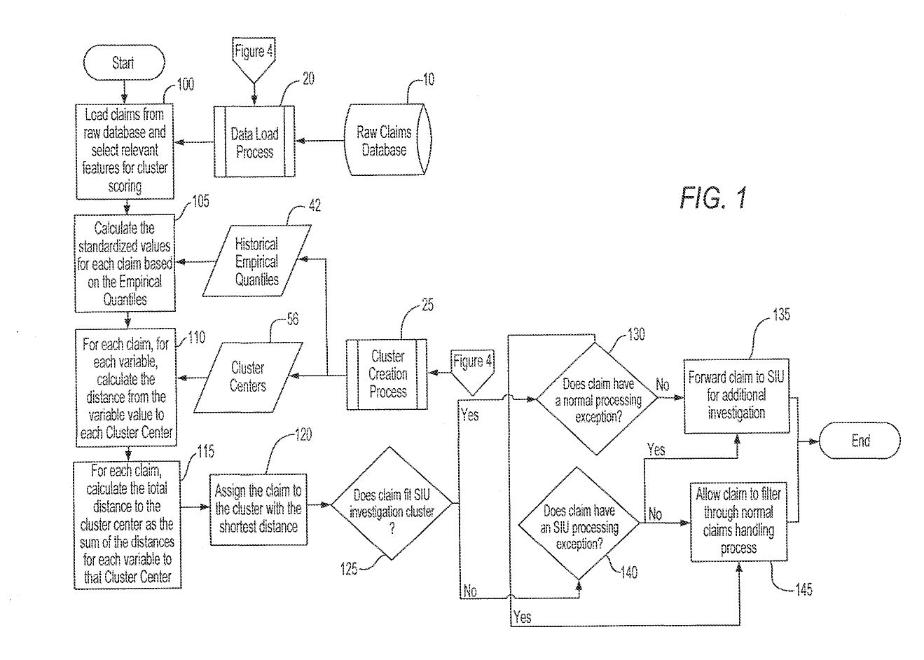

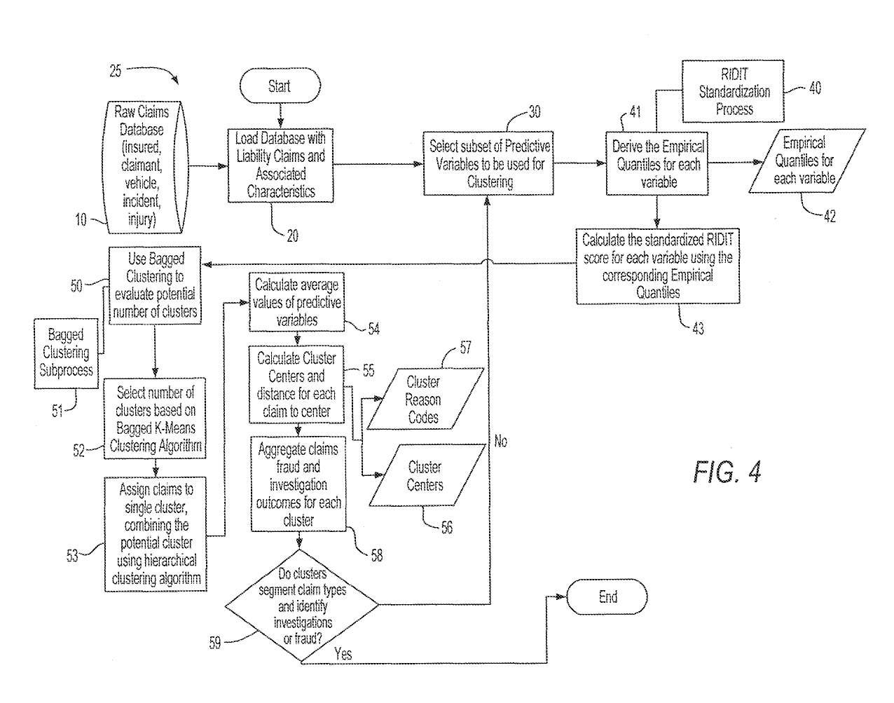

Turning now to the drawing figures (and starting with FIG. 4), FIG. 4 illustrates an exemplary process 25 according to an embodiment of the present invention by which the clusters can be created. At step 20, data describing the claims are loaded from a Raw Claims Database 10. At step 30, a subset of predictive variables to be used for clustering are selected, and the extracted raw claims data are standardized according to a data standardization process (steps 40-43). The clusters are defined using a suitable clustering algorithm and evaluated based on the ability to segment fraudulent from non-fraudulent claims (steps 50-59). The variables and number of clusters are chosen to best segment claims and identify fraudulent ones. Then, clusters can be analyzed for content and capability to predict fraudulent claims (see FIG. 1).

The clusters can be defined based on the simultaneous, multivariate combination of predictive variables concerning the claim, such as, for example, the timeline during which major events in the claim unfolded (e.g., in the auto BI context, the lag between accident and reporting, the lag between reporting and involvement of an attorney, the lag to the notification of a lawsuit), the involvement of an attorney on the claim, the body part and nature of the claimant's injuries, and the damage to the different parts of the vehicle during the accident. For simplicity, it can be assumed that there are K clusters and that there are V specific predictive variables used in the clustering. The target variables (SIU investigation and fraud determination) may not be included in the clustering, first as these can be used to assess the predictive capabilities of the clusters, and second, because to do so could bias the data towards clustering on known fraud, not just inherent, and often counter-intuitive patterns that correlate with fraud.

In various exemplary embodiments of the present invention, the subset of predictive variables chosen for the clustering depends on the line of business and nature of the fraud that may occur. For auto BI, for example, the variables used can be the nature of the injury, the vehicle damage characteristics, and the timeline of attorney involvement. For fraud detection in other types of insurance, other flags may be relevant. For example, in the case of property insurance, relevant flags may be the timeline under which scheduled property was recorded, when calls to the police or fire department were made, etc.

Each of the V predictive variables to be included in the clustering can be standardized before application of the clustering algorithm. This standardization ensures that the scale of the underlying predictive variables does not affect the cluster definitions. Preferably, RIDIT scoring can be utilized for the purposes of standardization (FIG. 4, step 40), as it provides more desirable segmentation capabilities than other types of standardization in the case of auto BI, for example. However, other types of standardization such as the Z-score transformation (Z=(X−μ/σ), linear interpolation, or other types of variable standardization used to make the center and scale of the predictive variables the same may be used. RIDIT standardization is based on calculating the empirical quantiles for a distribution (steps 41 and 42) and transforming the values to account for these quantiles in spacing the post-transformation values (step 43). Most clustering methods rely on averages, which can be highly sensitive to scale and outlier values, thus variable standardization is important.

The clusters can be defined (step 50) using a variety of known algorithmic clustering methods, such as, for example, K-means clustering, hierarchical clustering, self-organizing maps, Kohonen Nets, or bagged clustering using a historical database of claims. Bagged clustering (step 51) is a preferred method as it offers stability of cluster selection and the capability to evaluate and choose the number of clusters.

Typically, selecting the number of clusters (step 52) is not a trivial task. In this case, bagged clustering can be used to determine the optimal number of clusters using the provided variables and claims. The bagged clustering provides a series of bootstrapped versions of the K-means clusters, each created on a subset of randomly sampled claims, sampled with replacement. The bagged clustering algorithm can combine these into a single cluster definition using a hierarchical clustering algorithm (step 53). Multiple numbers of clusters can be tested, k=V/10, . . . , V (where V is the number of variables). For each value of k, the proportion of variance in the underlying V variables explained by the clusters can be calculated. The k can be selected at the point of diminishing returns, where adding additional clusters does not greatly improve the amount of variance explained. Typically, this point is chosen based on the scree method (a/k/a, the “elbow” or “hockey stick” method), identifying the point where additional cluster improvement results in drastically less value.

Predictive variables can be averaged for the claims within each cluster to generate cluster centers (steps 54, 55 and 56). These centers are the high dimension representation of the center of each claim. For each claim, the distance to the center of the cluster can be calculated (step 55) as the Euclidean Distance from the claim to the cluster center. Each claim can be assigned to the cluster with the minimum Euclidean Distance between the cluster center K and the claim i:

$$d ( i , k ) = {( {\sum }_{v = 1}^{V} {( {i}_{v} - {k}_{v} )}^{2} )}^{\frac{1}{2}}$$

where i=1, . . . N for each claim, v=1, . . . , V for each predictive variable, and k=1, K for each cluster.

Then, claim i can be assigned to cluster k where d(i,k)=argminₖ{d(i,k)} for a given claim.

For each cluster, a reason code for each variable can be calculated (step 57). Each variable in the cluster equation can contribute to the Euclidean Distance and can form the Reason Weight (RW) from the squared difference between the cluster center and the global mean for that variable. For each variable, the Reason Weight can be calculated using the cluster mean μ_{k,v} and the appropriate global mean and standard deviation for each variable, μ_{k,v} and σ_{k,v} respectively. The cluster mean for each variable is the mean of the variable for claims assigned to the cluster, and the global mean is the mean of the variable over all claims in the database. Then, the Reason Weight is:

$${RW}_{k , v} = \frac{{μ}_{k , v} - {μ}_{v}}{{σ}_{v}}$$

The reason codes can then be sorted by the descending absolute value of the weight. The reason codes can enable the clusters to be profiled and examined to understand the types of claims that are present in each cluster.

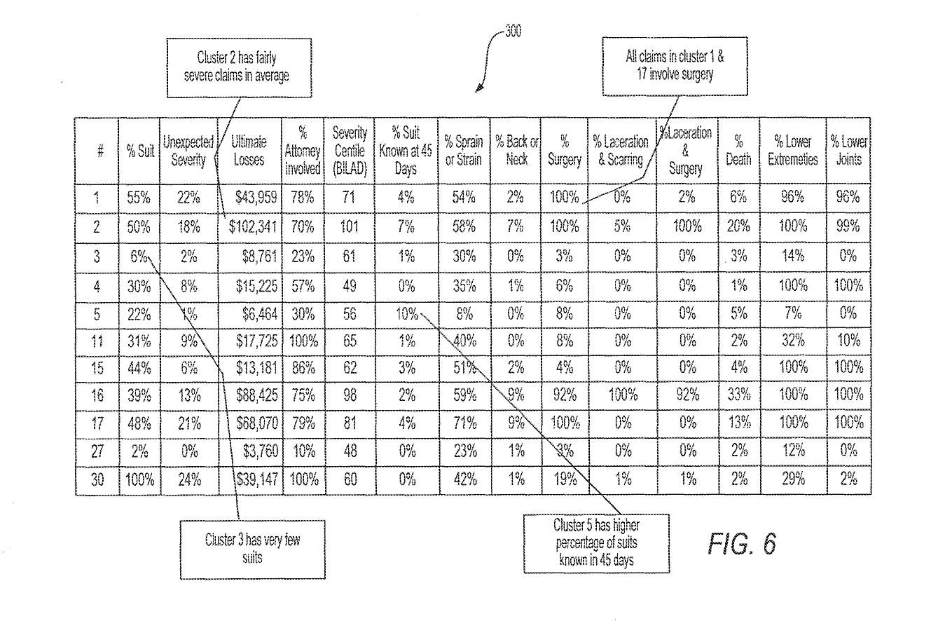

Also, for each predictive variable, the average value within the cluster (i.e., μ_{k,v}) can be used to analyze and understand the cluster. These averages can be plotted for each cluster to produce a “heat map” (see, e.g., FIG. 6) or visual representation of the profile of each cluster.

The reason codes and heat map help identify the types of claims that are present in each cluster, which allows a reviewer or investigator to act on each type of claim differently. For example, claims from certain clusters may be referred to the SIU based on the cluster profile alone, while claims from other clusters might be excluded for business reasons. As an example, the clustering methodology is likely to identify claims with very severe injuries and/or death. Claims from these clusters are less likely to involve fraud, and combatting this fraud may be difficult given the sensitive nature of the injury and presence of death. In this case, the insurer may choose not to refer any of these claims for additional investigation.

After the clusters have been defined using the clustering methodology, the clusters can be evaluated on the occurrence of investigation and fraud using the determinations on the historical claims used to define them (see, e.g., FIG. 4, step 58). In conjunction with the profile of the cluster, it is possible to identify which cluster signature should be referred for investigation in the future.

Appendix A sets forth an exemplary algorithm for creating clusters to evaluate new claims.

FIG. 1 illustrates an exemplary process according to an embodiment of the present invention by which claims can be handled based on the clustering score. The exemplary claims scoring process illustrated in FIG. 1 pre-supposes that the clusters have been defined through a cluster creation process 25 such as discussed above with reference to FIG. 4. That process provides, at steps 56 and 42, respectively, the inputs of the cluster centers and historical empirical quantiles.

At step 100, the raw data describing the claims are loaded (via a data load process 20; see FIG. 4) from the Raw Claims Database 10 for scoring, and, each time a claim is to be scored, relevant information required for the scoring (including those variables defined during the cluster creation process that are used to define the clusters) is extracted. Claims may be scored multiple times during the lifetime of the claim, potentially as new information is known.

For each claim attribute included in the scoring, standardized values for each variable are calculated based on the historical empirical quantiles for the claim (step 105). In some illustrative embodiments, this can be effected according to the method described in the cluster creation process described above with reference to FIG. 4. In that process, the RIDIT transformation is used as an example, and the historical empirical quantiles from that process are defined as follows:

for all vᵢεvεv calculate: Γᵢ=[(vᵢ+2qᵢ)/Σᵢ₌₁^{N}vᵢ]−1; i=1, 2, . . . N,

where qᵢ=max{Empirical Historical Quantile such that vᵢ≦qᵢ}

Each claim can then be compared against all potential clusters to determine the cluster to which the claim belongs by calculating the distance from the claim to each cluster center (steps 110 and 115). The cluster that has the minimum distance between the claim and the cluster center is chosen as the cluster to which the claim is assigned. The distance from the claim to the cluster center can be defined using the sum of the Euclidean Distance across all variables V, as follows:

$${d}_{k , i} = \sqrt{{\sum }_{v = 1}^{V} {( {h}_{i}^{v} - {r}_{i} )}^{2}} .$$

At step 120, the claim is assigned to the cluster that corresponds to the minimum/shortest distance between the scored claim and the center (i.e., the cluster with the lowest score). Claims can then be routed through the SIU referral and claims handling process according to predefined rules.

If the claim is assigned to a cluster that is assigned for investigation (in whole or in part), then the claim can be forwarded to the SIU. Additionally, exceptions can be included, so that certain types of claims are never forwarded to the SIU. These types of rules are customizable. For example, as noted above, a given claims department may determine that claims involving a death are very unlikely to be fraudulent, and in these cases SIU investigations will not be undertaken. Then, even for claims assigned to clusters intended for investigation, if a claim involves a death, this claim may not be forwarded to the SIU. This would be considered a normal handling exception. Similarly, it may be determined that some types of claims should always be forwarded to the SIU. For example, it is possible that claims involving a particular claimant are highly suspicious based on previous interactions with that claimant. In this case, the claim would be referred to the SIU regardless of the clustering process. This would be an SIU handling exception. Thus, referring to FIG. 1, if the claim is assigned to a cluster that requires additional investigation, i.e., the claim fits an SIU investigation cluster (step 125) and is not subject to a normal processing exception (step 130), the claim is then referred for investigation (step 135); otherwise, the claim is routed through the normal claims processing system (step 145)—that is, unless there is an SIU processing exception that requires referral for investigation (step 140).

Each cluster can be analyzed based on the historical rate of referral to the SIU and the fraud rate for those clusters that were referred. Clusters where high percentages of claims were referred and high rates of fraud were discovered represent areas where the claims department should already know to refer these claims for additional investigation. However, if there are some claims in these clusters that were not referred historically, there is an opportunity to standardize the referral process by referring these claims to the SIU, which are likely to result in a determination of fraud.

Clusters with types of claims having high rates of referral to the SIU but low historical rates of fraud provide an opportunity to save money by not referring these claims for additional investigation as the likelihood for uncovering fraud is low.

Lastly, there are clusters that have low rates of referral, but high rates of fraud if the claims are referred. These clusters might contain previously unknown types of fraud that have been uncovered by the clustering process as a set of like claims with a high rates of fraud determination. However, it is also possible that these types of claims are not referred to the SIU because of a predefined reason, such as the claim involved a death. In some embodiments, these complex claims might be fully analyzed and referred only when there is the highest likelihood of fraud. In such cases, rules can be defined, stored and automatically executed as to how to handle each cluster based on the composition and profile of each cluster.

It should be understood that if the clusters are not effective at assisting in claims handling and SIU referral (step 59 in FIG. 4), predictive variables can be removed or additional variables can be added. The cluster creation process can then be restarted (e.g., at step 30 in FIG. 4).

The rules for referral to the SIU can be preselected based on the cluster in which the claim is assigned. For example, the determination can be made that claims from five of the clusters will be forwarded to the SIU, while claims from the remaining clusters will not.

Appendix B sets forth an exemplary algorithm for scoring claims using clusters.

The following examples more granularly describe clustering analysis in the context of both auto BI claims, and then UI claims.

### Auto BI Example

### Variable Selection:

Table 1 below identifies variables used in the auto BI clustering model example.

TABLE 1

| Category | Variable Examples |
|---|---|
| Claim Timeline | Report lag |
| | Relation to policy effective/expiration |
| | dates |
| | Lag to opening BI line |
| Attorney/Litigation | Attorney involvement (and lag to add) |
| | Known suit (and lag) |
| | Relation to a statute of limitations |
| Injury Information | Body part (e.g., neck/back, joint, |
| | head) |
| | Nature of injury (e.g., laceration, |
| | sprain) |
| Vehicle Damage | Parts of vehicle damaged |
| | Both insured and claimant vehicles |
| | available |
| Claimant and Insured | Past history of claims |
| | Demographics of home location |
| | Distance to insured, accident location, |
| | and attorney |
| | Vehicle attributes (e.g., age, value) |
| Claim Information | Size of claim and severity model |
| | scores |
| | Emergency room involvement |
| Household 3^{rd} Party Data | Income |
| | Household demographics |
| | Lifestyle information |
| Claim Adjuster Free Form Text | Detailed text from adjusters |
| | Exact language for use in probabilistic |
| | text mining |
| Individually Identified Entities | Claimants |
| for Network Analysis | Attorneys |
| | Physicians, health care clinics, |
| | pharmacies, etc. |
| Other | Miscellaneous |

The original data extract contains raw or synthetic attributes about the claim or the claimant. To select a relevant subset of variables for fraud detection purposes, two steps can be applied:

1—Variable selection based on business rules data and common hypotheses to create a subset of the variables that are historically or hypothetically related to fraud.

2—Removal of highly correlated/similar variables:

In order to cluster the claims into like groups it is recommended to remove variables with high degrees of correlation to avoid double counting when measuring similarity between two claims. This is common in many of the text mining variables where a 0 or 1 flag is created to indicate if certain key words such as “head”, “neck”, “upper body injury”, etc. are detected in the claimant's accident report. Prior to clustering, the correlation of these attributes should be examined and if two text mining variables such as “txt_head” and “txt_neck” are highly correlated (e.g., 80% or higher) only one of them should be included in the model.

When selecting variables for fraud detection, the initial round of variable selection can be rules-based, drawing on common hypotheses in the context of the fraud domain.

The starting point for variable selection is the raw data that already exists and that is collected by the insurer on the policy holders and the claimants. Additional variables may be created by combining the raw variables to create a synthetic variable that is more aligned with the business context and the fraud hypothesis. For example, the raw data on the claim can include the accident date and the date on which an attorney became involved on the case. A simple synthetic variable can be the lag time in days between the accident date and the attorney hire date.

In exemplary embodiments of the present invention, various synthetic variables can be automatically generated, with various pre-programmed parameters. For example, various combinations, both linear and nonlinear, of each internal variable with each external variable can be automatically generated, and the results tested in various clustering runs to output to a user a list of useful and predictive synthetic variables. Or, the synthetic generation process can be more structured and guided. For example, distance between various key players in nearly all fraudulent claims or transactions is often indicative. Where a claimant and the insured live very close to each other, or where a delivery address for online ordered merchandise is very far from the credit card holder's residence, or where a treating chiropractor's office is located very far from the claimant's residence or work address, often fraud is involved. Thus, automatically calculating various synthetic variable combinations of distance between various locations associated with key parties to a claim, and testing those for predictive value, can be a more fruitful approach per unit of computing time than a global “hammer and tongs” approach over an entire variable set.

In the exemplary process for variable selection in auto BI claims fraud detection described hereinafter, variables can be classified into, for example, 9 different categories. Examples from each category are set forth below:

### 1—Claim Timeline

In fraud detection, knowing the chronology and the timing of events can inform a hypothesis around different types of BI claims. For example, when a person is injured, the resulting claim is typically reported quickly. If there is a long lag until the claim is reported, this can suggest an attempt by the claimant to allow the injury to heal so that its actual severity is harder to verify by doctors and can be exaggerated.

Also, an attorney typically gets involved with a claim after a reasonable period of about 2-3 weeks. If the attorney is present on the first day, or if the attorney becomes involved months or years later, this can be considered suspicious. In the first instance, the claimant may be trying to pressure a quick settlement before an investigation can be performed; and in the second instance, the claimant may be trying to collect some financial benefit before a relevant statute of limitations expires, or the claimant may be trying to take advantage of the passage of time when evidence has become stale to concoct a revisionist history of the accident to the claimant's advantage.

Additionally, if the claim happens very quickly after the policy starts, this suggests suspicious behavior on the part of the insured. The expectation is that accidents will occur in a uniform distribution over the course of the policy term. Accidents occurring in the first 30 days after the policy starts are more likely to involve fraud. A typical scenario is one where the insured signs up for coverage and immediately stages an accident to gain a financial benefit quickly before premiums become due.

Variables derived based on the timeline of events can include the Policy Effective Date, the Accident Date, the Claim Report Date, the Attorney Involvement Date, the Litigation Date, and the Settlement Date.

A lag variable refers to the time period (usually, days) between milestone events. The date lags for the BI application are typically measured from the Claim Report Date of the BI portion of the claim (i.e., when the insurer finds out about the BI line).

Table 2 below sets forth examples of variables based on lag measures:

TABLE 2

| Variable Name | Description |
|---|---|
| BILADATTY_LAG | Lag between Attorney and Report |
| | Date |
| REPORTLAG | Lag (in days) between accident date |
| | and report date |
| BILADLT_LAG | Lag between Report Date and |
| | Litigation |
| BILADST_LAG | Lag between Statute and Report Date |
| ACCPOLEXPLAG | Lag (in days) between accident date |
| | and policy term expiration date |
| ACCOPENLAG | Lag (in days) between accident date |
| | and BI line open date |

### 2—Attorney/Litigation

Attorney involvement and the timing around litigation can inform whether to refer a claim to the SIU. Based on this insight, relevant variables such as those set forth in Table 3 below can be included in the analysis dataset.

TABLE 3

| Variable Name | Description |
|---|---|
| TGTATTYIND | Attorney Presence Indicator |
| FraudCmtCaty | Claimant attorney >50 miles from |
| | claimant |
| NabLossCatyS | Shortest Dist Loss to Claimant Attorney |
| NabLossCatyL | Longest Dist Loss to Claimant Attorney |
| SUIT_WITHIN30DAYS | Suit within 30 days of Loss Reported Date |
| SUITBEFOREEXPIRATION | Suit 30 days before Expiration of Statute |
| | of Limitations |

### 3—Injury Information

Looking at the type of injury in conjunction with other information about an accident (such as speed, time of day and auto damage) helps in assessing the validity of the claim. Therefore, variables that indicate if certain body parts have been injured are worthy of inclusion. A majority of the variables in this category are indicators (0 or 1) for each body part. Table 4 below sets forth examples of injury information variables. The “TXT_” prefix indicates extraction using word matching from a description provided by the claimant (or a police report or EMT or physician report).

TABLE 4
Body Part Indicators

| | |
|---|---|
| TXT_PED_BIKE_SCOOTER | TXT_BRAIN_INJURY |
| TXT_PARTYING_PARTY | TXT_BURN |
| TXT_SPINAL_SCARRING | TXT_DEATH |
| TXT_SPINAL_SURGERY | TXT_DISMEMBERMENT |
| TXT_BRAIN_SCARRING | TXT_FRACTURE |
| TXT_BRAIN_SURGERY | TXT_JOINT_INJURY |
| TXT_FRACTURE_SPRAINS | TXT_LACERATION |
| TXT_FRACTURE_SCARRING | TXT_PARALYSIS |
| TXT_FRAUCTURE_SURGERY | TXT_SCARRING_DISFIGUREMENT |
| TXT_JOINT_SCARRING | TXT_SPINAL_CORD_BACK_NECK |
| TXT_JOINT_SURGERY | TXT_SURGERY |
| TXT_LACERATION_SCARRING | TXT_LOWER_EXTREMITIES |
| TXT_LACERATION_SURGERY | TXT_NECK_TRUNK |
| TXT_FRACTURE_MOUTH | TXT_UPPER_EXTREMITIES |
| TXT_FRACTURE_NECK | TXT_FRACTURE_HEAD |

As noted earlier, certain types of injuries are harder to verify, such as, for example, soft tissue injuries to the back and neck (lacerations, broken bones, dismemberment and death are verifiable and therefore harder to fake). Fraud tends to appear in cases where injuries are harder to verify, or the severity of the injury is harder to estimate.

### 4—Vehicle Damage

Information on vehicle damage in conjunction with body injury and other claim information (such as road condition, time of day, etc.) helps in assessing the validity of the claim. Similar to body part injuries, vehicle damage information, for example, can be included as a set of indicators that are extracted from the description provided by the claimant or the police report. Table 5 below sets forth examples of vehicle damage variables. There are two prefixes used for vehicle damage indicators: 1) “CLMNT_” refers to the vehicle damage on the claimant vehicle, and 2) “PRIM_” refers to the vehicle damage on the primary insured driver.

TABLE 5
Vehicle Damage Indicators

| | |
|---|---|
| CLMNT_FRONT | PRIM_SIDE_MIRROR |
| CLMNT_UNKNOWN | PRIM_ROLLOVER |
| CLMNT_REAR | PRIM_GLASS_ALL_OTHER |
| CLMNT_BUMPER | PRIM_ENGINE |
| CLMNT_OTHER | PRIM_ROOF |
| CLMNT_DRIVER_SIDE | PRIM_SIDE_MIRROR |

Although vehicle damage is easy to verify, not all types of vehicle damage signals are equally likely, and some are suspicious. For example, in a two-car rear-end accident, front bumper damage is expected on one vehicle and rear bumper damage on the other, but not roof damage. Additionally, combinations of vehicle damage should be associated with certain combinations of injuries. Neck/back soft tissue injuries, for example, can be caused by whiplash, and should therefore involve damage along the front-rear axis of the vehicle. Roof, mirror, or side-swipe damage may be indicative of suspicious combinations, where the injury observed would not be expected based on the damage to the vehicle.

### 5—Claims Adjuster's Free-Form Text

Variables in both the “Injury Information” and “Vehicle Damage” categories are typically extracted from the claims adjuster's free form notes or transcribed conversations with the claimant and insured. Variables in each of these two categories are only indicators with values of 0 and 1. Depending on the technique used for text mining, a value of 1 can mean, for example, the specific word or phrase following “TXT_” exists in the recorded notes and conversations.

The raw text can be used to derive a “suspicion score” for the adjuster. Additionally, unexpected combinations of notes and information may be picked up at a more detailed level than using strict text indicators.

The techniques used for extracting the information can range from simple searches for a word or an expression to more sophisticated techniques that build probabilistic models that take into account word distributions. Using more sophisticated algorithms (e.g., natural language processing, computational linguistics, and text analytics) allows more complex variables to be identified that reflect subjective information such as, for example, the speaker's affective state, attitude or tone (e.g., sentiment analysis).

In the instant example, simple keyword searches for expressions such as “BUMPER” or “SPINAL_INJURY” can be performed with numerous computer packages (e.g., Perl, Python, Excel). For example, the value of 1 for variable “CLMNT_BUMPER” can mean that the car bumper has been damaged in the accident. For other variables, key word searching can be augmented by adding rules regarding preceding or following words or phrases to give more confidence to the variable meaning. For example, a search for “JOINT_SURGERY” may be augmented by rules that require words such as “HOSPITAL”, “ER”, “OPERATION ROOM”, etc., to be in the preceding and following phrases.

### 6—Claimant and Insured Information

Basic information concerning the primary insured driver and the claimant are key to creating meaningful clusters of the claims. Historical information (e.g., past claims, or past SIU referrals) along with other information (e.g., addresses) should be selected for the clustering to better interpret the cluster results. Table 6 below sets forth examples of the information about the claimant and the primary insured that can be included for each claim.

TABLE 6

| Variable Name | Description |
|---|---|
| CLMSPERCMT | Claims Per CMT |
| FraudCmtPin | Distance of insured location to Claimant |
| | <=2 miles |
| PRIMINSLUXURYVEHIND | Indicates if primary insured's car is |
| | luxurious (0 = Standard, 1 = Luxury) |
| PRIMINSVHCLPSNGRINV | Number of passengers in primary |
| | insured's vehicle |
| PRIMINSVHCLEAGE | Age of primary insured's vehicle |

While an insurer generally knows the insured party well (in a data and historical sense), the insurer may not have encountered the claimant before. The CLMSPERCMT variable keeps track of cases where the insurer has encountered the claimant on a different claim. Multiple encounters should raise a red flag. Additionally, if the claimant's and insured's addresses are within 2 miles of each other, this could indicate collusion between the parties in filing a claim, and may be a sign of fraud.

### 7—Claim Information

Information about the claim, focused on the accident, is essential to understanding the circumstances surrounding the accident. Facts such as the road conditions, time of day, day of the week (weekend or not) and other information about the location, witnesses, etc. (as much as is available) if not consistent with other information may raise red flags as to the validity of the claimant's information or type of body injury claimed. Some exemplary variables are set forth in Table 7 below.

TABLE 7

| Variable Name | Description |
|---|---|
| HOLIDAY_ACC | Indicates if an accident occurred during the |
| | holiday season (1 = November, December, January) |
| ACCOPENLAG | Lag (in days) between accident date and BI |
| | line open date |

Another piece of information that can be used in the clustering model is the predicted severity of the claim on the day it is reported (see Table 8 below). This can be the output of a predictive model that uses a set of underlying variables to predict the severity of the claim on the day it is filed.

TABLE 8

| Variable Name | Description |
|---|---|
| PA_LOSS_CENTILE_BILAD | Claim Model Centile at report date |

Generally speaking, a centile score can be a number from 1-100 that indicates the risk that the claim will have higher than average severity for a given type of injury. For example, a score of 50 would represent the “average” severity for that type of injury, while a higher score would represent a higher than average severity. Additionally, these scores may be calculated at different points during the life of the claim. The claim may be scored at the first notice of loss (FNOL), at a later date, such as 45 days after the claim was reported, or even later. These scores may be the product of a predictive modeling process. The goal of this type of score is to understand whether the claim will turn out to be more or less severe than those with the same type of injury. Assessing claims taking into account injury type and severity using predictive modeling is addressed in U.S. patent application Ser. No. 12/590,804 titled “Injury Group Based Claims Management System and Method,” which is owned by the Applicant of the present case, and which is hereby incorporated by reference herein in its entirety.

### 8—Household 3^{rd} Party Data

This information sheds light on the people involved in the accident (including demographic information, in particular, financial status). Given that the goal of insurance fraud is to wrongfully obtain financial benefits, this information is quite pertinent as to tendency to engage in fraudulent behavior.

TABLE 9

| Variable Name | Description |
|---|---|
| RSENIOR_CLMT | Percentage of population in age 65+ |
| rpop25_clmt | Percentage of population in age 0-24 |
| RSENIOR_CLMT | Percentage of population in age 65+ |
| rpop25_clmt | Percentage of population in age 0-24 |
| rincomeh_clmt | Median household income |
| reducind_clmt | Education index (based on 4 factors: |
| | student/teacher ratio, revenue spent per |
| | student, avg educ attainment of the adult |
| | pop, and # of educational workers) |
| rttcrime_clmt | Total crime index (based on FBI data) |
| NOFAULT_IND | No-Fault State Indicator |
| OUTSIDEUS | Indicates if the accident occurred outside |
| | of the US (0 = no, 1 = yes) |

On average, fraud tends to come from areas where there is more crime and often is more prevalent in no-fault states.

### 9—Individually Identified Entities for Network Analysis

Although not included in the present example, fraud detection can be achieved through construction of social networks based on associations in past claims. If the individuals associated with each claim are collected and a network is constructed over time, fraud tends to cluster among certain rings, communities, and geometric distributions.

A network database can be constructed as follows:

1) Maintain a database of unique individuals encountered on claims. These represent “nodes” in the social network. Additionally, track the role in which the individual has been involved (claimant, insured, physician or other health provider, lawyer, etc.)

2) For each encounter with an individual, draw a connection to all other individuals associated with that claim. These connections are called “edges,” and form the links in the social network.

3) For each claim where a claim was investigated by SIU, increment the count of “investigations” associated with each node. Similarly, track and increment the number of “fraud” for each node. The ratio of known fraud to investigations is the “fraud rate” for each node.

Fraud has been demonstrated to circulate within geometric features in the network (small communities or cliques, for example). This analysis allows the insurer to track which small groups of lawyers and physicians tend to be involved in more fraud, or which claimants have appeared multiple times associated with different lawyers and physicians or pharmacists. As cases that were never investigated cannot have known fraud, this type of analysis helps find those rings of individuals where past behavior and association with known fraud sheds suspicion on future dealings.

Fraud for a given node can be predicted based on the fraud in the surrounding nodes (sometimes called the “ego network”). In other words, fraud tends to cluster together in certain nodes and cliques, and is not randomly distributed across the network. Communities identified through known community detection algorithms, fraud within the ego network of a node, or the shortest distance (within the social network) to a known fraud case are all potential predictive variables.

### Variable Imputation and Scaling:

Prior to running the clustering algorithm, each null value should be removed—either by removing the observation or imputing the missing value based on the other applications.

1) Imputing Missing Values:

If the variable value is not present for a given claim, the value can be imputed based on preselected instructions provided. This can be replicated for each variable to ensure values are provided for each variable for a given claim. For example, if a claim does not have a value for the, variable ACCOPENLAG (lag in days between the accident date and the BI line open date), and the instructions require using a value of 5 days, then the value of this variable for the claim would be 5.

2) Scaling:

For each observation in the present example, there are 78 attributes, which have different value ranges. Some variables are binary (i.e., 0 or 1); some variables capture number of days (1, 2, . . . 365, . . . ) and some values refer to dollar amounts. Since calculating the distance between the observations is at the core of the clustering algorithm, these values all need to be in the same scale. If the values are not transformed to a single scale, those with larger values, such as household income (in 000s of dollars), affect the distance between two observations whose other attribute values are age (0-100) or even binary (0-1).

Accordingly, in exemplary embodiments of the present invention, three common transformation techniques, for example, can be used to scale the data:

a. Linear Transformation:

Linear transformation is the computationally easiest and most intuitive. The attribute values are transformed to a 0-1 scale. The highest value for each attribute gets a value of 1 and the other values are assigned a value linearly proportional to the max value:

Linearly Transformed Attribute=Attribute Value for the claim/Max(Attribute Value across all claims)

Despite its simplicity, this method does not take into account the frequency of the observation values.

b. Normal Distribution Scaling (Z-Transformation):

The Z-Transform centers the values for each attribute around the mean value where the mean value is assigned to zero and any application with the Attribute Value greater (lower) than mean is assigned a positive (negative) mapped value. To bring value to the same scale, the difference of each value to the mean is divided by the standard deviation of the values for that attribute. This method works best for attributes where the underlying distribution is normal (or close to normal). In fraud detection applications, this assumption may not be valid for many of the attributes, e.g., where the attributes have binary values.

c. RIDIT (Using Values from Initial Data)

RIDIT is a transformation utilizing the empirical cumulative distribution function derived from the raw data. It transforms observed values onto the space (−1, 1). The RIDIT transformation can be used to scale the values to the (−1, +1) scale. Appendix B illustrates the formulation for the RIDIT transformation and Table 10 below illustrates exemplary inputs and outputs.

TABLE10

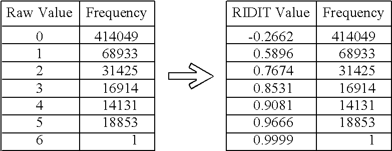

As shown, the mapped values are distributed along the (−1,+1) range based on the frequency that the raw values appear in the input dataset. The higher the frequency of a raw value, the larger its difference from the previous value in the (−1,+1) scale.

Clustering performed in multiple iterations on the same data using each of the three scaling techniques reveals RIDIT to be the preferred scaling technique here as it enables a reasonable differentiation between observations when clustering while it does not over account for rare observations.

In contrast, Z-Transformation is very sensitive to the dispersion in data and when the clustering algorithm is run on the data transformed based on normal distribution, it results in one very big cluster containing the majority (>60% up to 97%) of the observations and many smaller clusters with low number of observations. Such results can provide insufficient insight as they fail to adequately differentiate the claims based on a given set of underlying attributes.

Both RIDIT and linear transformation result in well distributed and more balanced clusters in terms of the number of observations. However, linear transformation despite the ease and simplicity in calculation can be misleading when working with data that is not uniformly distributed since it fails to adequately account for the frequency of values for a given attribute across observations. Distance measures can be overemphasized when using linear transformation in cases where a rare observation has a raw value higher than the observation mean, which may force a clusters to be skewed.

### Selecting the Number of Clusters:

The appropriate number of clusters is dependent on the number of variables, distribution of the attribute values and the application. Methods based on principal component analysis (PCA), such as scree plots, for example, can be used to pick the appropriate number of clusters. An appropriate number for clusters means the generated clusters are sufficiently differentiated from one another, and relatively homogeneous internally, given the underlying data. If too few clusters are selected, the population is not segmented effectively and each cluster might be heterogeneous. On the other hand, the clusters should not be too small and homogenized that there is no significant differentiation between a cluster and the one next to it. Thus, if too many clusters are picked, some clusters might be very similar to other clusters, and the dataset may be segmented too much. An exemplary consideration for choosing the number of clusters is identifying the point of diminishing returns. It should be appreciated, however, that further segmentation beyond the “point of diminishing returns” may be required to get homogeneous clusters. Homogeneity can also be defined using other statistical measures, such as, for example, the pooled multidimensional variance or the variance and distribution of the distance (Euclidean, Mahalanobis, or otherwise) of claims to the center of each cluster.

In an auto BI fraud detection application, the greater the number of clusters, the higher the percentage of (known) fraud that can be found in a given cluster. Even though the (known) fraud flag or SIU referral is not included in the clustering dataset (as noted above), with more clusters there will be clusters within which the rate of SUI referral or fraud is much higher than (e.g., more than 2×) the average rate.

Scree plots tend to yield a minimum number of clusters. While there are benefits in having more clusters, to find a cluster(s) with high (known) fraud rate, it is desirable, for example, to select a number between the minimum and a maximum of about 50 clusters. For example, for a dataset with 100 variables that are a mix of continuous, binary and categorical variables, where scree plots recommend 20 clusters, selecting about 40 can provide an appropriate balance between having unique cluster definitions and having clusters that have unusually high percentages of (known) fraud, which can be further investigated using techniques such as a decision tree.

In sum, the choice of the number of clusters should be a cost weighted trade-off between the size and homogeneity of the clusters. As a rule of thumb, at least 75% of the clusters should each have more than 1% of the data.

### Evaluation of Clusters:

After running the clustering algorithm on the data and creating the clusters, each cluster can be described based on the average values of its observations. Claims, in this running example, are clustered on 128 dimensions covering the injury, vehicle parts damaged, and select claim, claimant and attorney characteristics. The claims into 40 homogeneous clusters with each cluster highly similar on the 128 variables. Using a visualization technique such as, for example, a heat map is a preferred way to describe and define reason codes for each cluster. Each cluster has a “signature.” For example:
Cluster 1: claims involving joint or back surgery
Cluster 2: head and neck lacerations

Based on hypotheses about potential ways of committing BI fraud, clusters with descriptions similar to these hypotheses are selected. As the heat map 300 depicted in FIG. 6 shows, both clusters 2 and 16 have a higher average claims cost compared to the others in the subset of clusters presented. 70% of all the claims in these clusters involved an attorney with 40% (30%) of applications in cluster 2 (16) leading to a lawsuit, which could indicate potential fraud. However, looking at other variables, cases such as death and laceration are noted as body part injuries that present minimal chance of potential fraud since claimants will not be able to fake them.

On the other hand, all of the claims in cluster 15 involved lower joint or lower back injuries with very low death rate and laceration. Given that nearly 40% of claims resulted in a lawsuit and 82% of them involved an attorney, it is plausible to consider the likelihood of soft fraud in such claims (e.g., when the claimant includes hard-to-diagnose low cost joint or back pain that may not have been caused by the accident that is the subject of the claim).

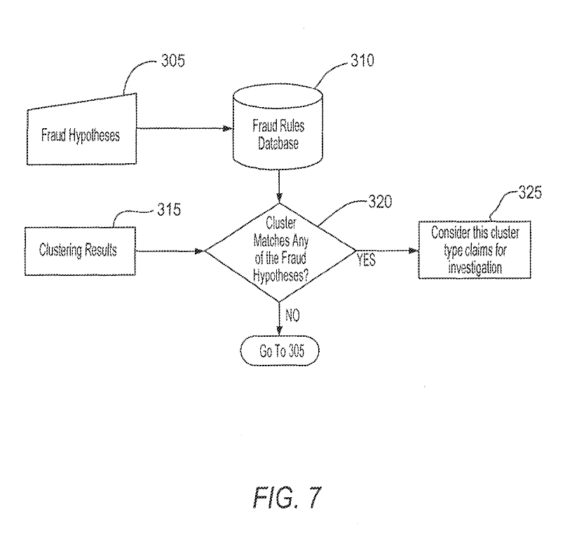

The process of cluster evaluation can be automated and streamlined using a data-driven process. Referring to FIG. 7, the process can include setting up rules based on the fraud hypotheses 305 and updating them as new hypotheses are developed. Each fraud scheme or hypotheses can be translated into a series of rules using the variables created to form a rules database 310. The results 315 of the clustering can then be passed through the rules database (step 320) and the resulting clusters 325 would be those to focus on.

### Reason Codes for Profiling:

Another method for profiling claims can be by using reason codes. As noted above, reason codes describe which variables are important in differentiating one cluster from another. For example, each variable used in the clustering can be a reason. Reasons can be ordered, for example, from the “most impactful” to the “least impactful” based on the distribution of claims in the cluster as compared to all claims.

If a known fraud indicator is available, then the following method may be used to determine the profile or reason a claim is selected into a particular cluster:

1. For each cluster k, calculate the fraud rate fₖ, k=1, . . . , K

2. For all clusters calculate f_{*}global fraud rate for all claims

3. Set

$$R = \{ \begin{matrix}+ if {f}_{k} - {f}_{*} > 0 \\ - if {f}_{k} - {f}_{*} \leq 0\end{matrix}$$

4. For each cluster k, calculate the mean uᵥ^{k}, k=1, . . . , K and v=1, . . . , V

5. For each variable v calculate μᵥ and σ*ᵥ the global mean and standard deviation for all claims

6. Calculate

$${W}_{v}^{k} = \frac{{μ}_{v}^{k} - {μ}_{v}^{*}}{{σ}_{v}^{*}}$$

7. For each cluster k generate R₊^{k}(j) or R₋^{k}(j) for 0<j≦V which may act as the top j reasons claim i is more (or less) likely to be fraudulent where R₊^{k}(j) or R₋^{k}(j) are ordered by |Wᵥ^{k}|

In the absence of a known fraud rate, the following method can be used to determine the cluster profile.

1. For each cluster k, calculate the mean fraud rate uᵥ^{k}, k=1, . . . , K and v=1, . . . , V

2. For each variable v calculate μ*ᵥ and σ*ᵥ the global mean and standard deviation for all claims

3. Calculate

$${W}_{v}^{k} = \frac{{μ}_{v}^{k} - {μ}_{v}^{*}}{{σ}_{v}^{*}}$$

4. Set

$$R = \{ \begin{matrix}+ if {W}_{v}^{k} > 0 \\ - if {W}_{v}^{k} \leq 0\end{matrix}$$

5. For each cluster k, generate R₊^{j}(j) and R₋^{k}(j) for 0<j≦V which may act as the top j positive and top j negative reasons for selecting claim i into cluster k where R₊^{k}(j) are the top j variables ordered by Wᵥ^{k} and R₋^{k}(j) are the bottom j variables ordered by Wᵥ^{k}

Referring to Table 11, cluster 1, for example, is best identified as containing claims involving joint surgery, spinal surgery, or any kind of surgery; while cluster 2 is best identified as containing lacerations with surgery, or lacerations to the upper or lower extremities. Cluster 3 is best identified by containing claims where the claimant lives in areas with low percentages of seniors, short periods of time from the report date to the statute of limitations, and few neck or trunk injuries.

TABLE 11

| Cluster | Number | | | |
|---|---|---|---|---|
| Number | Claims | Reason 1 | Reason 2 | Reason 3 |
| 1 | 1,050 | TXT_JOINT_SURGERY (+) | TXT_SPINAL_SURGERY (+) | TXT_SURGERY (+) |
| 2 | 181 | TXT_LACERATION_SURGERY | TXT_LACERATION_UPPER | TXT_LACERATION_LOWER (+) |
| | | (+) | (+) | |
| 3 | 1,330 | RSENIOR_CLMT (−) | BILADST_LAG (−) | TXT_NECK_TRUNK (−) |
| 4 | 912 | TXT_JOINT_LOWER (+) | TXT_JOINT_INJURY (+) | TXT_LOWER_EXTREMITIES (−) |
| 5 | 511 | REPORTLAG (−) | ACCOPENLAG (−) | SUIT_WITHIN30DAYS (−) |
| 6 | 238 | TXT_LACERATION_HEAD (+) | TXT_LACERATION_NECK | TXT_LACERATION_LOWER (+) |
| | | | (+) | |
| 7 | 601 | RTTCRIME_CLMT (−) | RPOP25_CLMT (−) | REDUCIND_CLMT (−) |
| 8 | 909 | TGTATTYIND (−) | ACCIDENTYEAR (−) | TXT_SPINAL_CORD_BACK_NECK (−) |
| 9 | 475 | TXT_FRAUCTURE_LOWER (+) | TXT_FRACTURE_NECK (+) | TXT_FRACTURE (+) |
| 10 | 490 | TXT_FRACTURE_NECK (+) | TXT_FRACTURE (+) | TXT_FRACTURE_HEAD (+) |

### Using Decision Trees for Further Classification:

A decision tree is a tool for classifying and partitioning data into more homogeneous groups. It can provide a process by which, in each step, a data set (e.g., a cluster) is split over one of the attributes—resulting in two smaller datasets—with one containing smaller and the other one bigger values for the attribute on which the split occurred. The decision tree is a supervised technique, and a target variable is selected, which is one of the attributes of the dataset. The resulting two sub-groups after the split thus have different mean target variable values. A decision tree can help find patterns in how target variables are distributed, and which key data attributes correlate with high or low target variable values.

In fraud detection applications, a binary target such as SIU Referral Flag, which has values of 0 (not referred) and 1 (referred), can be selected to further explore a cluster. As previously explained, clusters with reason codes aligned with fraud hypotheses or those with higher rates of SIU referral compared to average rates are considered for further investigation.

In exemplary embodiments of the present invention, one of the ways to further investigate a cluster, once formed, as described above, is to apply a decision tree algorithm to that cluster. For example, in a BI fraud detection application, a cluster with a much higher rate of SIU referral than average of all claims in the analysis universe can be further partitioned to explore what attributes contribute to the SIU referral.

Implementing a decision tree using packaged software, or custom developed computer code, the optimal split can, for example, be selected by maximizing the Sum of Squares (SS) and/or LogWorth values. Therefore, such software generally suggests a list of “Split Candidates” ranked by their SS and LogWorth scores.

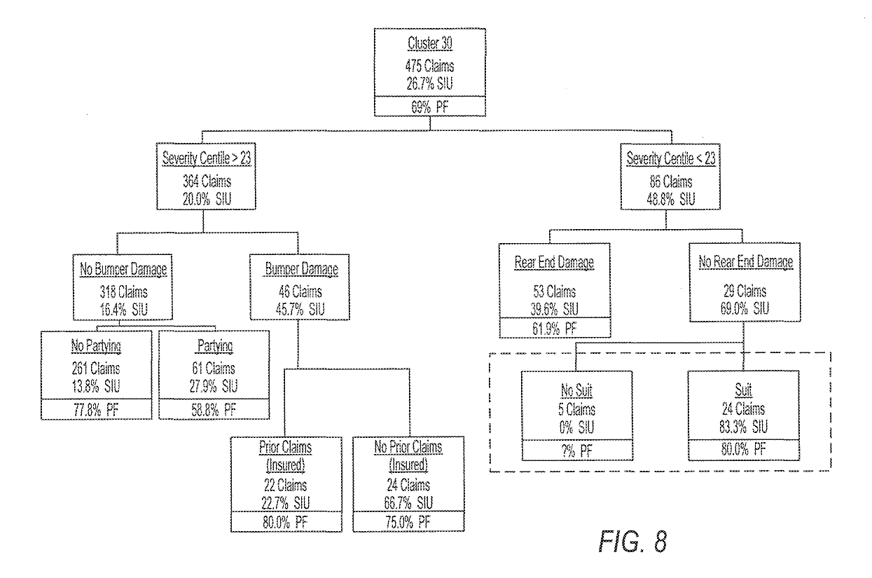

In the exemplary decision tree illustrated in FIG. 8, a first split occurs based on the claim severity score, which is a predicted score of the claim cost. “Severity Score” is the optimal split candidate based on the algorithm, and since it is aligned with one of the hypotheses around soft fraud, it is a plausible split. It can be seen that claims with low predicted cost were referred more to the SIU, which validates the soft fraud hypothesis. As noted above, a severity score can itself be generated via a multivariate predictive model, such as for example, those described in U.S. patent application Ser. No. 12/590,804 referred to above (and incorporated herein by reference). In that context each “Injury Group”—analogous to a cluster in the present context—can have its component claims scored as to severity, as therein described and claimed.

On the next split of the claims with the severity score lower than 23, an optimal split candidate is the “rear end damage” to the car. This variable also makes sense for the business mindset and is aligned with soft fraud hypothesis.

The third split on the far right branch, however, is a case where the variable that was mathematically optimal, i.e., the lag days between REPORT DATE and Litigation, was not selected for split. To perform a close-to-optimal split that makes sense, the best variable to replace was whether or not a lawsuit was filed. Based on this split, out of the 29 claims, 5 did not have a suit and were not referred to SIU; but from the 24 that had a suit, only 20 were referred to SUI.

### UI Example

By way of an additional example, the following describes a process for creating an ensemble of unsupervised techniques for fraud detection in UI claims. This involves combining multiple unsupervised and supervised detection methods for use in scoring claims for the purpose of mitigating unemployment insurance fraud.

Fraud in the UI industry is a significant cost, ultimately born as a tax by businesses that pay into the system. Employers in each state pay a tax (premium) into a fund that pays benefits (claims) to workers who were laid off. Although the laws differ by state, generally speaking, workers are eligible to file a claim for UI benefits if they were laid off, are able to work and are looking for work.

Benefit payments in the UI system are based on earnings for the applicant during the base period. The benefit is then paid out on a weekly basis. Each week, the applicant must certify that he/she has not worked and earned any wages, (or if they have, to indicate how much was earned). Any earnings are then removed from the benefit before it is paid out. Typically, the claimant is approved for a weekly benefit that has a maximum cap (usually ending after 26 weeks of payment, although recent extensions to the federal statutes have made this up to 99 weeks in some cases).

Individuals who knowingly conceal specifics of their eligibility for UI may be committing fraud. Fraud can be due to a number of reasons, such as, for example, understating earnings. In the U.S. today, roughly 50% of UI fraud is due to benefit year overpayment fraud—the type of fraud committed when the claimant understates earnings and receives a benefit to which he or she is not entitled. Although the majority of overpayment cases are due to unintentional clerical errors, a sizable portion are determined to be the result of fraud, where the applicant willfully deceives the state in order to receive the financial benefit.

In the typical UI fraud detection analytical effort, certain pieces of information are available to detect fraud. Broadly speaking, the information covers the eligibility, initial claim, payments or continuing claims, and the resulting adjudication information, i.e., overpayment and fraud determinations. Information derived from initial claims, continuing claims/payments, or eligibility can be used to construct potential predictors of fraud. Adjudication information is the result, indicating which claims turned out to involve fraud or overpayments.

Representative pieces of information available from these data sources are set forth in Table 12 below:

TABLE 12

| | | Representative Data |
|---|---|---|
| Data Source | Description | Elements |
| Initial Claims | Information provided by | Program under |
| | the claimant or applicant at | which the applicant |
| | the time the initial claim | applies |
| | for UI is filed. | Maximum benefit |
| | | amount |
| | | Expected weekly |
| | | benefit amount |
| | | Wages |
| | | Employer/Industry |
| | | Occupation |
| | | Years of experience |
| | | Location/worksite |
| | | Reason for |
| | | separation |
| | | Date, time of filing |
| | | Method used to file |
| | | the initial |
| | | application (e.g., |
| | | phone, internet) |
| Demographics | Demographic information | Age |
| | about the claimant | Gender |
| | | Race/ethnicity |
| | | Home ZIP Code |
| | | Veteran status |
| | | Union membership |
| | | Citizenship status |
| Payments/Continuing | Weekly level information | Date, time the |
| Claims | describing the continuing | continuing claim |
| | certification where the | was filed |
| | claimant certifies he/her | Pay week to which |
| | work and earnings during | the claim applies |
| | the week | Hours worked |
| | | during the week |
| | | Earnings during the |
| | | week |
| | | Payment made to |
| | | the claimant |
| | | Taxes withheld |
| | | Weekly benefit |
| | | amount to which the |
| | | claimant is eligible |
| | | Work search |
| | | requirements for the |
| | | claimant that week |
| | | If work was |
| | | performed, for |
| | | which company/ |
| | | industry |
| | | Method of access to |
| | | file the request (e.g., |
| | | phone, internet) |
| Historical wage | Historical wages for | Employer |
| information | individuals and the | Time period for |
| | employers where the | earnings |
| | individuals worked. | Hours worked |
| | | Earnings |
| | | Occupation |
| | | Industry |

Many states utilize federal databases to identify improper UI payments based on when workers have to report earnings to the IRS. However, this process does not apply to self-employed individuals, and is easy to manipulate for predominantly cash businesses and occupations. When the wage is hard to verify, the applicant has an increased opportunity to commit fraud. Other types of fraud are similarly difficult to detect as they are hard to verify, such as eligibility requirements (e.g., the applicant is not eligible due to the reason for separation from a previous employer, or is not able and available to work if a job came up, or is not searching for work, etc.). As with fraud in other industries and insurance applications, fraud in UI tends to be larger where the claim or certain aspects of the claim are harder to verify.

To select the appropriate types of predictive variables in the UI space, variables on self-reported elements of the claim that are difficult to verify, or take a long time to verify, are collected. In UI, these are self-reported earnings, the time and date the applicant reported the earnings, the occupation, years of experience, education, industry, and other information the applicant provides at the time of the initial application, and the method by which the individual files the claim (phone versus Internet). Behavioral economic theories suggest that applicants may be more likely to deceive when reporting information through an automated system such as an automated phone screen or a website.

In this example, the specific methods for detecting anomalies fraud in the UI space can include clustering methods as well as association rules, likelihood analysis, industry and occupational seasonal outliers, occupational transition outliers, social network, and behavioral outliers related to how the individual applicant files continuing claims over the benefit lifetime. Additionally, an ensemble process can be employed by which these methods can be variously combined to create a single Fraud Score.

As described above in connection with the auto BI example, claims can be clustered using unsupervised clustering methods to identify natural homogeneous pockets with higher than average fraud propensity. In this case, due to the business case for UI, the following five different clustering experiments are designed to address some of the fraud hypotheses grounded in observing anomalous behavior—for example, getting a high weekly benefit amount for a given education level, occupation and industry:

1) Clustering Based on Account History and the Applicant's History in the System:

This experiment includes 11 variables on account and the applicant's past activity such as: Number of Past Accounts, Total Amount Paid Previously, Application Lag, Shared Work Hours, Weekly Hours Worked.

2) Clustering Based on Applicant Demographics and Payment Information:

This experiment includes 17 variables on applicant's demographics such as age, union membership, U.S. citizenship, as well as information about the payment such as number of weeks paid, tax withholding, etc.

Unlike applicant demographic data, which is known at the time of initial filing, the payment related data (e.g., number of weeks paid) are not known on the initial day of filing. Therefore, considerations should be made when applying this model to catch fraud at the time of filing.

3) Clustering Based on the Applicant's Occupation and Demographics and Payment Information:

This experiment is similar to number 2 above with the difference that applicant's occupation indicators are added to tease out and further differentiate the clusters and discover anomalous applications.

4) Clustering Based on Employment History, Occupation and Payment Information:

This aims to cluster based on the applicant's occupation, industry in which the applicant worked and the amount of benefits the applicant received.

5) Clustering Based on the Combination of the Variables:

This captures all of the variables to create the most diverse set of variables about an application. While the cluster descriptions have a higher degree of complexity in terms of the combination of the variable levels and are harder to explain, they are more specific and detailed.

### Variable Standardization:

As discussed above in connection with the auto BI example, the method of standardization for the values of individual values has a large impact on the results of a clustering method. In this example, RIDIT is used on each variable separately. In this case, as in the auto BI case, the RIDIT transformation is preferred over the Linear Transformation and Z-Score Transformation methods in terms of post-transform distributions of each variable as well as the results of the clustering.

### Number of Clusters:

As described above in connection with the auto BI example, picking the appropriate number of clusters is key to the success and effectiveness of clustering for fraud detection. The number of clusters selected depends on the number of variables, underlying correlations and distributions. After RIDIT transformation, multiple numbers of clusters are considered.

The data for each experiment are individually examined and a recommended minimum number of clusters is determined based on the scree plots. The minimum number of clusters chosen is based on the internal cluster homogeneity, total variation explained, diminishing returns from adding additional clusters, and size of clusters. In each case, homogeneity is measured within each cluster using the variance of each variable, the total variance explained by the clusters, the amount of improvement in variance explained by adding a marginal cluster, and the number of claims per cluster.

However, to attain the highest fraud rate within a cluster in each experiment, all the experiments are conducted with a maximum of 50 clusters to create highest differentiation among the clusters. Table 13 below shows the highest fraud rate found in clusters for each of the experiments:

TABLE 13

| Experiment | | Top | |
|---|---|---|---|
| (variable | # of | Lift | |
| set) | Vars | (%) | Sample Variables |
| Account & | 11 | 161% | Number of Past Account, Total Amount Paid |
| Applicant's | | | Previously, Application Lag, Shared Work |
| History | | | Hours, Weekly Hours Worked |
| Applicant | 17 | 112% | Applicant demo (Age, union member, |
| Demo & | | | citizen, handicapped, etc) Payment |
| Payment | | | Info (# weeks paid, tax, WBA) |
| Occupation, | 40 | 95% | Applicant demo, Payment Info, Occupation |
| demo, & | | | (SOC codes), Education level |
| Payment | | | |
| Employment | 55 | 124% | Employment History, Payment Info, |
| History & | | | Occupation |
| Payment | | | |
| COMBO | 66 | 101% | Employment History, Payment Info, |
| | | | Occupation, Account History, |
| | | | Application info, EDUC_CD |

### Cluster Profiling:

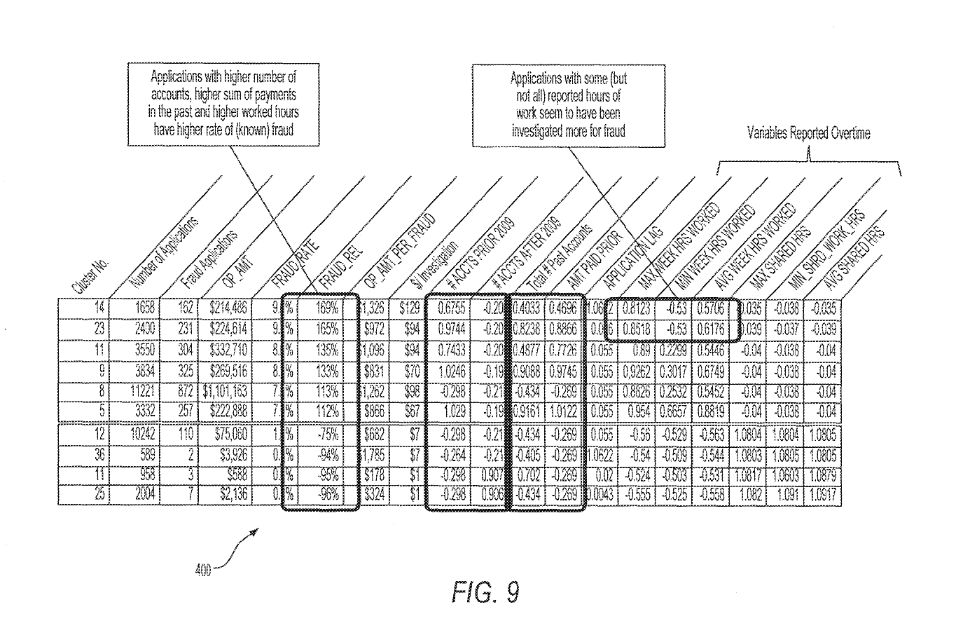

As described above in connection with the auto BI example, each cluster is profiled by calculating the average of the relevant predictive variables within each cluster. The clusters can then be evaluated based on a heat map to enable patterns, similarities and differences between the different clusters to be readily identifiable. As illustrated in the heat map 400 depicted in FIG. 9, some clusters have much higher levels of fraud (FRAUD_REL). Additionally, these clusters tend to have more past accounts and larger prior paid amounts. More fraud is also associated with clusters with higher maximum weeks and hours reported, but lower minimum hours reported. Thus, claims for full work in some weeks and no work in other weeks are identified by the clustering method as a unique subgroup. It turns out that this subgroup is predictive of fraud. Clusters with less fraud exhibit the opposite patterns in these specific variables.

In addition to analyzing which clusters tend to contain more fraudulent claims, individual claims may be evaluated based on the distance an individual claim is from the cluster to which it belongs. It should be noted that in this clustering example, it is assumed that the clustering method is a “hard” clustering method, or that a claim is assigned to one and only one cluster. Examples of hard clustering methods include k-means, bagged clustering, and hierarchical clustering. “Soft” clustering methods, such as probabilistic k-means or Latent Dirichlet Analysis, or other methods provide probabilities that the claim is assigned to each cluster. Use of such soft methods is also contemplated by the present invention—just not for the present example.

For hard clustering methods, each claim is assigned to a single cluster. The other claims in the cluster are the peer group of claims, and the cluster should be homogeneous in the type of claims within the cluster. However, it is possible that a claim has been assigned to this cluster but is not like the other claims. That could happen because the claim is an outlier. Thus, the distance to the center of the cluster should be calculated. Here, the Mahalanobis Distance is preferred (e.g., over the Euclidean Distance) in terms of identifying outliers and anomalies, as it factors in the correlation between the variables in the dataset. Whether a given application is far from the center of its cluster depends on the distribution of other data points around the center. A data point may have a shorter Euclidean distance to center, but if the data are highly concentrated in that direction, it may still be considered as an outlier (in this case the Mahalonobis distance will be a larger value).

The Euclidean Distance D_{i,d}=\sqrt{Σⱼ₌₁^{J}(xⱼ− x̅_̅{̅j̅,̅d̅}̅)²}, where D_{i,d} is the distance measure for observation i to cluster d (assuming i=1, . . . , where N=number of claims and d=1, . . . , D where D=number of clusters). Here, j is the number of variables, and x̅_̅{̅j̅,̅d̅}̅ is the average for variable j within cluster d

$$\overline{{x}_{j , d}} = \frac{1}{{N}_{d}} {\sum }_{i = 1}^{{N}_{d}} {x}_{i , d} ;$$

in other words, the average of the variable j across all claims i=1, . . . , N_{d} within cluster d, where N_{d} is the number of claims in cluster d. Thus, what is calculated is the square root of the sum of squares across the variable to the average of each cluster. The Mahalanobis Distance is a similar measure, except that the distances involve the covariances as well. Written in matrix notation, this is M_{i,d}²=(X−μ)^{T}Σ⁻¹(X−μ). As above, each claim has a given Mahalanobis Distance to each cluster center. As the claim is assigned to only 1 cluster, then Mᵢ²=M_{i,d}². For clustering methods where the claim is not assigned to a single cluster, than the distance M² is the average of the distance to all cluster centers, weighted by the probability that the claim belongs to each potential cluster.

For each cluster, a histogram of the Mahalanobis Distance (M²) can be produced to facilitate the choice of cut-off points in M² to identify individual applications as outliers.

Claims can be identified as outliers based on multiple potential tests. The process can be as follows:

For each cluster:
a. Calculate the distances to the cluster center for each claim, these are M?
b. Calculate how many claims fall outside X standard deviations from the cluster mean distance. Loop through X having potential values of 3, 4, 5, 6
   i. Outlier indicator=1 if M²>mean(M²)+X*standard deviation(M²). Otherwise 0
   ii. If the proportion of claims flagged as outlier indicator=1 is larger than 10%, than the value of X is unacceptably small
   iii. If the proportion of claims flagged as outlier indicator is 0 then the value of X is unacceptably small
   iv. If there is a local maximum in the distribution not being captured by the value for X, then shift the value of X such that the local maximum is captured as an outlier
      After this process, each claim will be tagged not only with a cluster, but also with a distance to its peers in that cluster, and an indicator if the cluster is an outlier against its peers in the cluster.

### Shared Employer/Employee Social Network:

Another type of unsupervised analytical method, the network analysis, can achieve fraud detection through the construction of social networks based on associations in past claims. If the individuals associated with each claim are collected and a network is constructed over time, fraud tends to cluster among certain subsets of individuals, sometimes called communities, rings, or cliques. Here, the network database can be constructed as follows:

1. Maintain a database of unique employers and employees encountered on UI claims. These represent “nodes” in the social network. Additionally, track the wages that an employee earns with the employer. If the amount is immaterial (e.g., less than 5% of the employee's earnings) than do not count the association.

2. For each employer, draw a connection to all other employers where an employee worked for both firms in a material capacity. These connections are called “edges”.

3. Remove weak links. This depends on the exact network, but links should be removed if:
a. Only 1-2 employees were shared between 2 employers.
b. The percentage of employees shared (# shared/total)<1% for both employers. This is an immaterial connection.
c. In cases where most employers are connected to each other, only the top 10 to 20 connections may be kept. This could happen if the network is highly connected, in cases of a very small community where everyone has worked for everyone else, for example.

### Overlay the UI Fraud on Top of the Network:

For any employees who have committed fraud, or employers found to commit fraud, increase the “fraud count” for any associated nodes on the network. Employee committed fraud would count towards the last employer under which the fraud was committed (or multiple, if multiple employers during the past benefit year).

Fraud has been demonstrated to circulate within geometric features in the network (small communities or cliques, for example). This allows the insurer to track which small groups of lawyers and physicians tend to be involved in more fraud, or which claimants have appeared multiple times. As cases that were never investigated cannot have fraud, this type of analysis helps uncover those rings of individuals where past behavior and association with known fraud sheds suspicion on future dealings.

Fraud for a given node can be predicted based on the fraud in the surrounding nodes (sometimes called the “ego network”). In other words, fraud tends to cluster together in certain nodes and cliques, and is not randomly distributed across the network. Communities identified through known community detection algorithms, fraud within the ego network of a node, or the shortest distance to a known fraud case are all potential predictive variables, if named information is available. Identification of these cliques or communities is highly processor intensive. Computational algorithms exist to detect connected communities of nodes in a network. These algorithms can be applied to detect specific communities. Table 14 below shows such an example, demonstrating that some identified communities have higher rates of fraud than others, solely identified by the network structure. In this case, 63 k employers were utilized to construct the total network, with millions of links between them.

TABLE 14

| Community | Claims (000) | % Fraud |
|---|---|---|
| 1 | 10 | 10.1% |
| 2 | 40 | 12.3% |
| 3 | 25 | 7.2% |
| 4 | 60 | 9.6% |
| 5 | 30 | 6.9% |
| 6 | 20 | 16.1% |

An additional representation of this information is to look at the amount of fraud in “adjacent” employers and see if that predicts anything about fraud in a given employer. Thus, for each employer, an identification can be made of all employers who are “connected” by the definition given in the steps above. This makes up the “ego network” for each employer, or the ring of employers with whom the given employer has shared employees. Totaling the fraud for each employer's ego network, then grouping the employers based on the rate of fraud in the ego network, results in the finding that employers with high rates of fraud in their ego network are more likely to have high rates of fraud themselves (see Table 15 below).

TABLE 15

| Rate of | | |
|---|---|---|
| Fraud in Ego | | |
| Network | Claims (000) | % Fraud |
| 0-10% | 280 | 4.4% |
| 10%-11% | 100 | 9.3% |
| 11%-13% | 135 | 11.7% |
| 13%+ | 95 | 13.7% |

### Reporting Inconsistencies:

At the time of an initial claim for UI insurance, the claimant must report some information, such as date of birth, age, race, education, occupation and industry. The specific elements'required differ from state to state. These data are typically used by the state for measuring and understanding employment conditions in the state. However, if the reported data from individuals are examined carefully, anomalies based on inconsistent reporting can be found, which might be suggestive of identity fraud. It is possible that a third party is using the social security number of a legitimate person to claim a benefit, but may not know all the details for that person.

Although this can be applied to many data elements, this example walks through generating these types of anomalies for individuals based on the occupation reported from year to year. This process will produce a matrix to identify outliers in reported changes in occupation:

1) Identify all claimants reporting more than one initial claim in the database.

2) For each pair of claims 1^{st} and 2^{nd}), identify the first reported occupation and the second reported occupation.

3) Aggregating across all claimants produces a matrix of size N×N, where N=number of occupations available in the database. The columns of the matrix should represent the 1^{st} reported occupation, while the rows should represent the 2^{nd} reported occupation.

4) For each column, divide each cell by the total for that column. The resulting numbers represent the probability that an individual from a given 1^{st} occupation (column) will report another 2^{nd} occupation the next time the individual files a claim.

Table 16 below provides an example, showing the Standard Occupation Codes (SOC). This represents the upper corner of a larger matrix. This is interpreted as follows: Applicants who file a claim and report working in a Management Occupation (SOC 11), will report the same SOC in the next claim 47% of the time, a Business and Financial Occupation (SOC 13) 8.7% of the time, and so forth. The outlier or anomaly is a claimant who reports SOC 17 in a subsequent claim as an architect. This should be flagged as an outlier.

TABLE 16

| | | 1^{st} Occupation | | | |
|---|---|---|---|---|---|
| | | | 13 | | |
| | | | Business and | 15 | 17 |
| | | 11 | Financial | Computer and | Architecture and |
| | | Management | Operations | Mathematical | Engineering |
| SOC | Description | Occupations | Occupations | Occupations | Occupations |
| 11 | Management | 47.0% | 9.4% | 3.6% | 2.7% |
| | Occupations | | | | |
| 13 | Business and | 8.7% | 55.8% | 0.8% | 3.7% |
| | Financial | | | | |
| | Operations | | | | |
| | Occupations | | | | |
| 15 | Computer and | 1.9% | 0.5% | 73.6% | 1.5% |
| | Mathematical | | | | |
| | Occupations | | | | |
| 17 | Architecture and | 0.01% | 4.1% | 7.3% | 70.9% |
| | Engineering | | | | |
| | Occupations | | | | |
| . . . | . . . | . . . | . . . | . . . | . . . |

The process for this is repeated by a computer using the 2-digit Major SOC, 3-digit SOC, 4-digit SOC, 5-digit SOC and 6-digit SOC. The computer can choose the appropriate level of information (which digit code) and the cut-off for the indicator of an anomaly. The cut-offs chosen should range from 0.05% to 5% in increments of 0.05% to identify the appropriate cut-off. The following decision process is applied by the computer:

1) For a given level of information (e.g., 2-digit SOC code):
a. Calculate transition probabilities
b. For a given cut-off (e.g., 0.05%)
i. Flag all claims which fall under the cut-off given by a cell.
ii. Aggregate all claims.
iii. If the number of claims identified by the system is >5%, then the cut-off or level of detail are inappropriate.
c. Repeat across all cut-offs.

2) Repeat across all levels of detail.

3) Choose the deepest level of detail and cut-off that meet the requirement of flagging less than 5% of claims.

This process should be repeated for data elements with reasonable expected changes, such as education or industry. Fixed or unchanging pieces of information should be assessed as well, such as race, gender, or age. For something like age, where the data element has a natural change, the expected age should be calculated using the time that has passed since the prior claim was filed to infer the individual's age.

### Seasonality Outliers:

Some industries have high levels of seasonal employment, and perform lay-offs during the off season. Examples include agriculture, fishing, and construction, where there are high levels of employment in the summer months and low levels of employment in the winter months. Another outlier or anomaly is when a claim is filed for an individual in a specific industry (or occupation) during the expected working season. These individuals may be misrepresenting their reasons for separation, and therefore committing fraud.

Seasonal industries and occupations can be identified using a computer by processing through the numerous codes to identify the codes where the aggregate number of filings is the highest. Then, individuals are flagged if they file claims during the working season for these seasonal industries. The process to identify the seasonal industries is as follows:

1) For each industry (or occupation), aggregate the number of claims by month (1-12) or week of the year (1-52)

2) Create a histogram of these claims, where the x-axis is the date from step 1 and the y axis is the count of claims during that time period

3) Any industry or occupation where the count of unemployment filings for the minimum period *10<maximum count of employment filings is considered a seasonal industry

4) Determine the seasonal period for this industry by the “elbow” or “scree point” of the distribution. This is the point where the slope of the distribution slows dramatically from steep to shallow. If such points do not exist, then choose the lowest 10% of months (or weeks) to represent the seasonal indicators

5) Any claims in the working period are anomalies.

### Behavioral Outliers:

Another type of outlier is an anomalous personal habit. Individuals tend to behave in habitual ways related to when they file the weekly certification to receive the UI benefit. Individuals typically use the same method for filing the certification (i.e., web site versus phone), tend to file on the same day of the week, and often file at the same time each day. The goal is to find applicants and specific weekly certifications where the applicant had established a pattern then broke the pattern in a material way, presenting anomalous or highly unexpected behavior.

Probabilistic behavioral models can be constructed for each unique applicant, updating each week based on that individual's behavior. These models can then be used to construct predictions for the method, day of week, or time by which/when the claimant is expected to file the weekly certification. Changes in behavior can be measured in multiple ways, such as:

1) Count of weeks where the individual files outside a specified prediction interval, such as 95%

2) Change in model parameters that measure variance in the prediction (how certain the model is that the individual will react in a specific way)

3) Probability for a filing under a specific model: P(Filing|Model)

The methods applied to identify anomalies can be the method of access, day of week of the weekly certification, and the log in time.

### Discrete Event Predictions:

The method of access and day of week are both discrete variables. In this example, the method of access (MOA) can take the values {Web, Phone, Other} and the day of week (DOW) can take values {1, 2,3,4,5,6,7}. A Multinomial-Dirichlet Bayesian Conjugate Prior model can be used to model the likelihood and uncertainty that an individual will access using a specific method on a specific day. It should be understood that other discrete variables can be used.

For MOA, for example, the process will generate indicators that the applicant is behaving in an anomalous way:

1) For an individual applicant, gather and sort all weekly certifications in order of time from earliest to latest
2) The MOA model: M˜Multinomial({Web, Phone, Other}, {αᵢ}, i=1, 2,3) and {αᵢ}˜Dirichlet(αᵢ⁰) where αᵢ⁰ is the prior distribution.

3) Set prior:
a. For the 1^{st} week, the prior distribution is set based on historical MOA access methods for other claimants in their first week, normalized such that sum({α_{i}})=3.5
b. For subsequent weeks, the prior will be set as the posterior {a_{post,i}} after the update (step 6 below)

4) Calculate prediction interval
a. The probability and variance that the claimant will log in is given by the Multinomial and Dirichlet distributions.
   i. Expected probability, μ=αᵢ/sum({α_{i}}). For example, P(Web|{αᵢ})=α_{web}/sum(αₚₕₒₙₑ, α_{web}, αₒₜₕₑᵣ).
   ii. Expected variance: using the Beta distribution, the variance is given as: σ²=αβ/[(α+β)²(α+β+1)], where β=sum(αᵢ)−aᵢ.
b. Calculate the prediction intervals for k={2, 3, . . . , 20} using the normal as β±kσ calculated from step 4

5) Evaluate actual data and create anomaly flag if necessary
a. Obtain the actual method of access for the week: m
b. Calculate the likelihood: L=P(M=m|{αᵢ}).
c. Identify if L is outside the prediction interval of the expected method from 4b. If so, flag as an anomaly
d. Repeat for all intervals as identified in 4b

6) Update prior
a. Calculate the posterior {α_{post,i}} using the Conjugate Prior Relationship: {α_{post,i}}={αᵢ}+m. In other words, increment by a value of 1 the α associated with the actual MOA m. Other values of a in the vector remain unchanged.
b. This posterior value of {α_{post,i}} will be used as the prior for the subsequent week for the applicant

7) Calculate changes in expected variable
σₚₒₛₜₑᵣᵢₒᵣ can be calculated and compared to the a calculated in step 4.a.ii. Calculate the change as δ=σₚₒₛₜₑᵣᵢₒᵣ/σ. If δ>0.1, then flag as an anomaly.

### Access Time Outliers:

In addition to the Method of Access and Day of Week outliers created by the process described above, anomalies and outliers can be created for the time that an applicant logs in to the system to file a weekly certification, assuming that that the time stamp is captured.

The process of utilizing a probability model, calculating the likelihood, and updating the posterior remain the same as described above, however, the distribution is different. In this case, a Normal-Gamma Conjugate Prior model is used. These steps outline the same process but instead replacing with the appropriate mathematical formulas:

1) For an individual applicant, gather and sort all weekly certifications in order of time from earliest to latest.

2) Convert the time in HH:MM:SS format to a numeric format: T=HH+MM/60+SS/60².

3) The model is that the time of log in is normally distributed: T˜Normal(μ, σ²), then the parameters are jointly distributed as a Normal-Gamma: (μ, σ⁻²)˜NG(μ⁰, κ⁰, α⁰, β⁰).

4) Set prior:
a. For the 1^{st} week, the prior distribution is set based on historical times of access methods for other claimants in their first week, where μ⁰=historical average, κ⁰=0.5, α⁰=0.5, β⁰=1.0
b. For subsequent weeks, the prior will be set as the posterior from the prior week after updating: (μ⁰, κ⁰, α⁰, β⁰)ₜ₊₁=(μ*, κ*, α*, β*)ₜ. The updates are made by the equations given in step 7 below.

5) Calculate prediction interval
a. The probability and variance for the time that the claimant will log in is given by the Normal and NG distributions.
   i. Expected probability: μ
   ii. Expected variance: σ²=β/α.
b. Calculate the prediction intervals for k={2, 3, . . . , 20} using the normal as μ±kσ calculated above.

6) Evaluate actual data and create an anomaly flag if necessary
a. Obtain the actual method of access for the week: m
b. Calculate the likelihood: L=P(T=t|μ, σ²).
c. Identify if L is outside the expected prediction interval. If so, flag as an anomaly.
d. Repeat for all intervals.

7) Update prior

a. Calculate the posterior parameters using the Conjugate Prior Relationship given in the following formulas, where J=1. Here, the sub-index n=1, . . . , N for each claimant.

$${μ}_{n}^{*} = \frac{{κ}_{n}^{0} {μ}_{n}^{0} + J {\overline{T}}_{n}}{{κ}_{n}^{0} + J}$$

$${κ}_{n}^{*} = {κ}_{n}^{0} + J$$

$${α}_{n}^{*} = {α}_{n}^{0} + J / 2$$

$${β}_{n}^{*} = {β}_{n}^{0} + 0.5 {\sum }_{j = 1}^{J} {( {T}_{n , j} - {\overline{T}}_{n} )}^{2} + \frac{{κ}_{n}^{0} {J ( {\overline{T}}_{n} - {μ}_{n}^{0} )}^{2}}{2 {κ}_{n}^{0} + J}$$

b.μₚₒₛₜₑᵣᵢₒᵣ=μ* and σₚₒₛₜₑᵣᵢₒᵣ²=β*/α*
c. This posterior value of the parameters, (μ*, κ*, α*, β*)ₜ, will be used as the prior for the subsequent week for the applicant, (μ⁰, κ⁰, α⁰, β⁰)ₜ₊₁

8) Calculate changes in expected variable
a. Note that σₚₒₛₜₑᵣᵢₒᵣ can be calculated and compared to σₚᵣᵢₒᵣ.
   Calculate the change as δ=σₚₒₛₜₑᵣᵢₒᵣ/σₚᵣᵢₒᵣ. If δ>0.1, then flag as an anomaly.

### Ensemble of Anomalies:

Once all anomalies have been identified, these disparate indicators must be combined into an Ensemble Fraud Score. This example considers the combination of these anomaly indicators, which can take the value {0,1}. However, if the different indicators are represented by the confidence they have been violated, then they can be represented as the inverse of the confidence: 1/confidence and combined using the same process.

In constructing the Ensemble Fraud Score, linear combinations of the underlying indicators can be created: S=Σⱼ₌₁^{J}Iⱼαⱼ where Iⱼ is the anomaly indicator, J is the total number of anomaly indicators to be combined, and αⱼ are the weights. To set the weights:

1) Consider the correlation of all indicators Iⱼ. If all pairwise correlations are less than 0.2, then set all αⱼ=1. Otherwise, proceed to step 2.

2) If a subset of variables are inter-correlated, in other words, where a small subset of variables have correlations>0.5, then:
a. Use a Principal Components Analysis (PCA) to derive weights γₖ for the subset of variables k<j.
b. Calculate the eigenvalues of the first eigenvector in the covariance matrix. These should be used as the values for γₖ.
c. For the subset of k variables, the weights are: αₖ=γₖ/Σγₖ.
d. Repeat for all subsets of inter-correlated variables.
e. Variables not included in the inter-correlation analysis should be given weights αⱼ=1.

### Reason Codes:

In the case of the Ensemble Fraud Score (S) from above, reason codes can be used to describe the reason that the individual score is obtained. In this case, the reasons are the underlying anomaly indicators Iⱼ. If Iⱼ=1 then the claimant has this reason. The reasons are ordered based on the size of the weights, Reasons maintained by the system for each claimant scored are passed along with the Ensemble Fraud Score.

Appendix C is a glossary of variables that can be used in UI clustering.

### II. Association Rules Instantiation

The second principal instantiation of the invention described herein utilizes association rules. This instantiation is next described.

Association rules can be used to quantify “normal behavior” for, for example, insurance claims, as tripwires to identify outlier claims (which do not meet these rules) to be assigned for additional investigation. Such rules assign probabilities to combinations of features on claims, and can be thought of as “if-then” statements: if a first condition is true, then one may expect additional conditions to also be present or true with a given probability. According to various exemplary embodiments of the present invention, these types of association rules can be used to identify claims that break them (activating tripwires). If a claim violates enough rules, it has a higher propensity for being fraudulent (i.e., it presents an “abnormal” profile) and should be referred for additional investigation or action.

The association rules creation process produces a list of rules. From that a critical number of such rules can be used in the association rules scoring process to be applied to future claims for fraud detection.

There are well-known and academically accepted algorithms for quantifying association rules. The Apriori Algorithm is one such algorithm that produces rules of the form: Left Hand Side (LHS) implies Right Hand Side (RHS) with an underlying Support, Confidence, and Lift. This relationship can be represented mathematically as: {LHS}=>{RHS}|(Support, Confidence, Lift). In such algorithms, support is defined as the probability of the LHS event happening: P(LHS)=Support. Confidence is defined as the conditional probability of the RHS given the LHS: P(RHS|LHS)=Confidence. The Lift is defined as the likelihood that the conditions are non-independent events: P(LHS & RHS)/[P(LHS)*P(RHS)]=Lift.

The typical use of association rules is to associate likely events together. This is often used in sales data. For example, a grocery store may notice that when a shopping basket includes butter and bread, then 90% of the time the basket also includes milk. This can be expressed as an association rule of the form {Butter=TRUE, Bread=TRUE}=>{Milk=TRUE}, where the Confidence is 90%. Exemplary embodiments of the present invention employ the underlying novel concept of inverting the rule and utilizing the logical converse of the rule to identify outliers and thus fraudulent claims. In the example above, this translates to looking for the 10% of shoppers who purchase butter and bread but not milk. That is an “abnormal” shopping profile.

As with the clustering instantiation described above, the association rules instantiation should begin with a database of raw claims information and characteristics that can be used as a training set (“claims” is understood in the broadest possible sense here, as noted above). Using such a training set, rules can be created, and then applied to new claims or transactions not included in the training set. From such a database, relevant information can be extracted that would be useful for the association rules analysis. For example, in an automobile BI context, different types and natures of injuries may be selected along with the damage done to different parts of the vehicle.

Claims that are thought to be normal are first selected for the analysis. These are claims that, for example, were not referred to an SIU or similar authority or department for additional investigation. These can be analyzed first to provide a baseline on which the rules are defined.

A binary flag for suspicious types of injuries can be generated, for example. In general, as previously discussed, suspicious types of claims include subjective and/or objectively hard to verify damages, losses or injuries. In the example of BI claims, soft tissue injuries are considered suspicious as they are more difficult to verify, as compared to a broken bone, burn, or more serious injury, which can be palpitated, seen on imaging studies, or that has otherwise easily identifiable symptoms and indicia. In the auto BI space, soft tissue claims are considered especially suspicious and it is considered common knowledge that individuals perpetrating fraud take advantage of these types of injuries (sometimes in collusion with health professionals specializing in soft tissue injury treatment) due to their lack of verifiability. This example illustrates that the inventive association rules approach can sort through even the most suspicious types of claims to determine those with the highest propensity to be fraudulent.

To generate the association rules, any predictive numeric and non-binary variables should be transformed into binary form. Then, for example, binary bins can be created based on historical cut points for the claim. These cut points can be, for example, the median numeric variables selected during the creation process. Other types of averages (i.e., mean, mode, etc.) could also be used in this algorithm, but may arrive at suboptimal cut points in some cases. The choice of the central measure should be selected such that the variable is cut as symmetrically as possible. Viewing each variable's histogram can enable determination of the correct choice. Selection of the most symmetric cut point helps ensure that arbitrary inclusion of very common variable values in rule sets is avoided as much as possible. Similarly, discrete numeric variables with fewer than ten distinct values should be treated as categorical variables to avoid the same pitfall. Such empirical binary cut points can be saved for use in the association rules scoring process.

Binary 0/1 variables are created for all categorical attributes selected during the creation process. This can be accomplished by creating one new variable for each category and setting the record level value of that variable to 1 if the claim is in the category and 0 if it is not. For instance, suppose that the categorical variable in question has values of “Yes” and “No”. Further suppose that claim 1 has a value of “Yes” and claim 2 has a value of “No”. Then, two new variables can be created with arbitrarily chosen but generally meaningful names. In this example, Categorical_Variable_Yes and Categorical_Variable_No will suffice. Since claim 1 has a value of “Yes”, Catergorical_Variable_Yes would be set to 1 and Categorical_Variable_No would be set to 0. Likewise for claim 2, Categorical_Variable_Yes would be set to 0 and Categorical_Variable_No would be set to 1. This can be continued for all categorical values and all categorical variables selected during the creation process.

Known association rules algorithms can be used to generate potential rules that will be tested against the claims and fraud determinations of those claims that were referred to the SIU. The LHS may comprise multiple conditions, although here and in the Apriori Algorithm, the RHS is generally restricted to a single feature. As an example, let LHS={fracture injury to the lower extremity=TRUE, fracture injury to the upper extremity=TRUE} and RHS={joint injury=TRUE}. Then, the Apriori Algorithm could be leveraged to estimate the Support, Confidence, and Lift of these relationships. Assuming, for example, that the Confidence of this rule is 90%, then it is known that in claims where there are fractures of the upper and lower extremities, 90% of these individuals also experience a joint injury. That is the “normal” association seen. Thus, for the purpose of fraud detection, claims with a joint injury without the implied initial conditions of fractures to the upper and/or lower extremities are being sought out. This is a violation of the rule, indicating an “abnormal” condition.

Using association rules and features of the claims related to the various types of injury and various body parts affected, multiple independent rules can be constructed with high confidence. If the set of rules covers a material proportion of the probability space of the RHS condition, then the LHS conditions provide alternate different—but nonetheless legitimate—pathways to arrive at the RHS condition. Claims that violate all of these paths are considered anomalous. It is true that any claim violating even a single rule might be submitted to SIU for further investigation. However, to avoid a high false positive rate, a higher threshold can be used. The threshold can be determined by examining the historical fraud rate and optimizing against the number of false positives that are achieved.

According to exemplary embodiments, setting the rules violation thresholds begins by evaluating the rate of fraud among all claims violating a single rule. If the rate of fraud is not better than the rate of fraud found in the set of all claims referred to SIU, then the threshold can be increased. This may be repeated, increasing the threshold until the rate of fraud detected exceeds that of all claims referred to SIU. In some cases, a single rule violation may outperform a combination of rules that are violated. In such circumstances, multiple thresholds may be used. Alternatively, the threshold level can be set to the highest value found in all possible combinations.

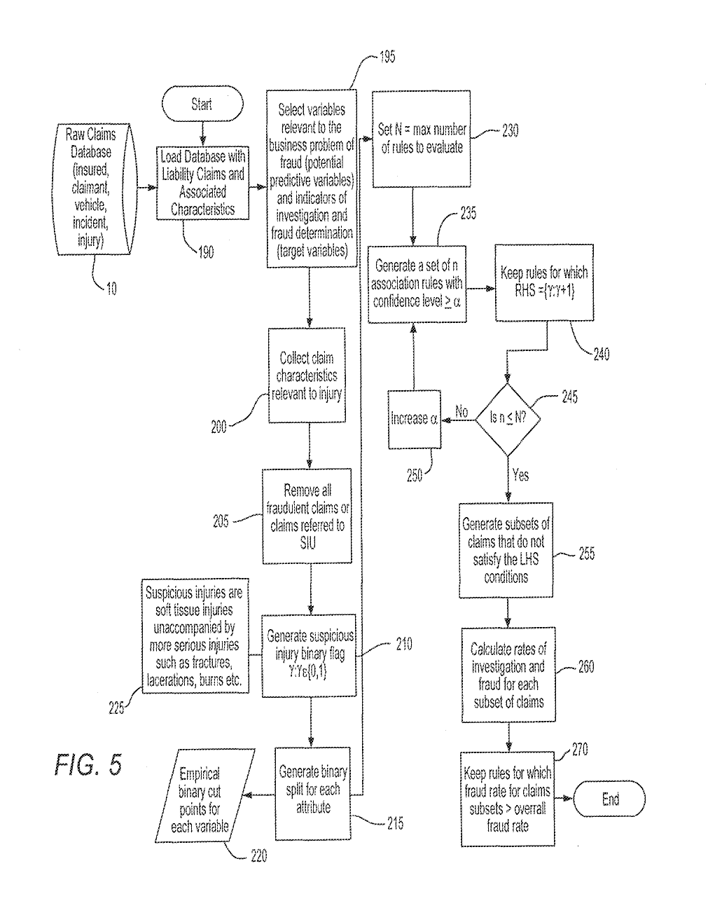

FIG. 5 illustrates an exemplary process for creating the association rules. Claims are extracted and loaded from raw claims database 10, keeping only those claims not referred to SIU or found/known to be fraudulent (steps 190-205). These are considered the “normal” claims. A suspicious claim type indicator is generated for those claims that involve only soft tissue injuries (step 210). This can be accomplished by generating a new variable and setting its value to 1 when the claim contains soft tissue injuries but does not contain other more serious injuries such as fractures, lacerations, burns, etc., and setting the value to 0 otherwise. Variables are transformed into binary form (step 215). Then, these binary variables are analyzed using an algorithm, such as the Apriori Algorithm, for example, with a minimum confidence level set to minimize the total number of rules created, such as, for example, fewer than 1,000 total rules (steps 230-270). Rules in which the RHS contains the suspicious claims indicator are kept (step 240). These rules define the “normal” claims with suspicious injury types. Rules for which the fraud rate of claims violates the rule of being less than or equal to the overall fraud rate are discarded, thus leaving the association rules at step 270 for use.

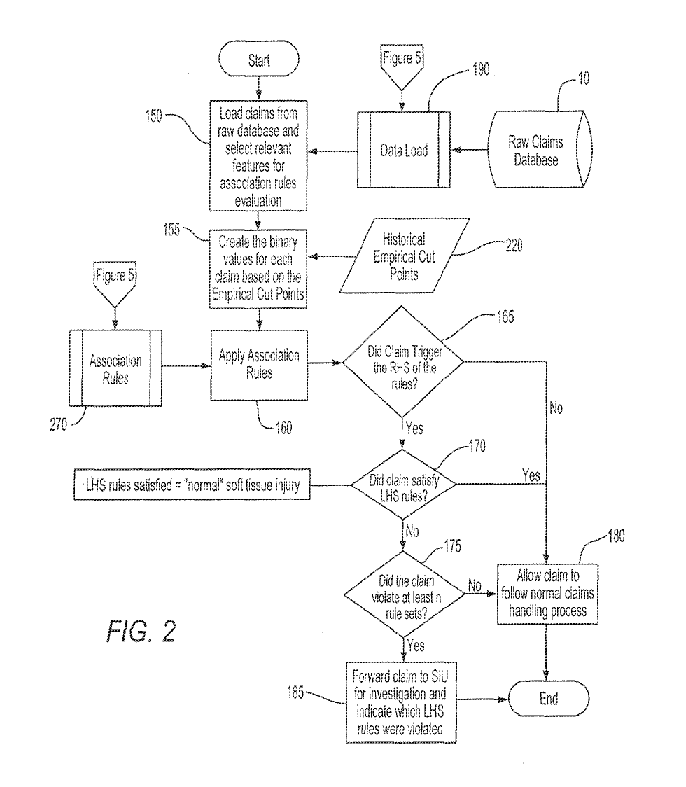

Once association rules have been created based on a training set, an exemplary scoring process for the association rules can be applied to new claims. Such a process is described in FIG. 2. The raw data describing the claims are loaded from database 10 at the time for scoring (step 150). Claims may be scored multiple times during the lifetime of a claim, potentially as new information is known. Relevant information including the variables used for evaluation, the empirical binary cut points 220 (generated in the process depicted in FIG. 5), and the required number of rules violated prior to submission for investigation are all derived in the association rules creation process and are extracted from the original raw data. For each numeric claim attribute included in the scoring, the predictive variables are transformed to binary indicators (step 155).

The association rules generated may have the logical form IF {LHS conditions are true} THEN {RHS conditions are true with probability S}. To apply the association rules (generated at step 270 of FIG. 5) for fraud detection (step 160 of FIG. 2), claims should be first be tested to see if they meet the RHS conditions (step 165). Claims that do not meet any of the RHS conditions are sent through the normal claims handling process (step 180).

If a claim meets the RHS conditions for any claims, then the claims may be tested against the LHS conditions (step 170). If the claim meets the RHS and LHS conditions, then the claim is also sent through the normal claims handling process (step 180), recalling that this is appropriate because, in this example, the rules defined a “normal” claim profile.

If the claim meets the RHS conditions but does not meet the LHS conditions for a critical number of rules at step 170, which is predefined in the association rules creation process, then the claim may be routed to the SIU for further investigation (step 185). For example, assume that exemplary predefined association rules are the following:

1) {Head Injury=TRUE}=>{Neck Injury=TRUE}

2) {Joint Sprain=TRUE}=>{Neck Sprain=TRUE}

3) {Rear Bumper Vehicle Damage=TRUE}=>{Neck Sprain=TRUE}

Using this rule set, and further assuming that the critical value is violation two rules, non-“normal” claims may be identified. For example, if a claim presents a Neck Injury with no Head Injury, and a Neck Sprain without damage to the rear bumper of the vehicle, this violates the “normal” paradigm inherent in the data a sufficient number of two times, and the claim can be referred to the SIU for further investigation as having a certain likelihood of involving fraud. This illustrates the “tripwires” described above, which refers to violation of a normal profile. If enough tripwires are pulled, something is assumably not right.

Thus, to summarize, in applying the association rule set the claims are evaluated against the subsequent conditions of each rule—the RHS. Claims that satisfy the RHS are evaluated against the initial condition—the LHS. Claims that satisfy the RHS but do not satisfy the LHS of a particular rule are in violation of that rule, and are assigned for additional investigation if they meet the threshold number of total rules violated. Otherwise, the claims are allowed to follow the normal claims handling procedure.

To further illustrate these methods, next described are exemplary processes for creating association rules and, using those rules, scoring insurance claims for potential fraud. Appendix E sets forth an exemplary algorithm to find a set of association rules with which to evaluate new claims; and Appendix F sets forth an exemplary algorithm to score such claims using association rules.

As previously discussed, the goal of association rules is to create a set of tripwires to identify fraudulent claims. Thus, a pattern of normal claim behavior can be constructed based on the common associations between claim attributes. For example, as noted above, 95% of claims with a head injury also have a neck injury. Thus, if a claim presents a neck injury without a head injury, this is suspicious. Probabilistic association rules can be derived from raw claims data using a commonly known method such as, for example, the Apriori Algorithm, as noted above, or, alternatively using various other methods. Independent rules can be selected which form strong associations between claim attributes, with probabilities greater than, for example, 95%. Claims violating the rules can be deemed anomalous, and can thus be processed further or sent to the SIU for review. Two example scenarios are next presented. An automobile bodily injury claim fraud detector, and a similar approach to detect potential fraud in an unemployment insurance claim context.

### Auto BI Example

### Input Data Specification

Example variables (see also the list of variables in Appendix D):
Day of week when an accident occurred (1=Sunday to 7=Saturday)
Claimant Part Front
Claimant Part Rear
Claimant Part Side
Count of damaged parts in claimant's vehicle
Total number of claims for each claimant over time
Lag between litigation and Statute Limit
Lag between Loss Reported and Attorney Date
Primary Driver Front
Primary Driver Rear
Primary Driver Side
Indicates if primary insured's car is luxurious (0=Standard, 1=Luxury)
Age of primary insured's vehicle
Percent Claims Referred to SIU, Past 3 Years (Insured or Claimant)
Count of SIU referrals in the prior 3 years (policy level) in the prior 3 years
Suit within 30 days of Loss Reported Date
Suit 30 days before Expiration of Statute

### Outliers:

The ultimate goal of the association rules is to find outlier behavior in the data. As such, true outliers should be left in the data to ensure that the rules are able to capture truly normal behavior. Removing true outliers may cause combinations of values to appear more prevalent than represented by the raw data. Data entry errors, missing values, or other types of outliers that are not natural to the data should be imputed. There are many methods of imputation discussed broadly in the literature. A few options are discussed below, but the method of imputation depends on the type of “missingness”, type of variable under consideration, amount of “missingness”, and to some extent user preference.

### Continuous Variable Imputation:

For continuous variables without good proxy estimators, and with only a few values missing, mean value imputation works well. Given that the goal of the rules is to define normal soft tissue injury claims, a threshold of 5% missing values, or the rate of fraud in the overall population (whichever is lower) should be used. Mean imputation of more than this amount may result in an artificial and biased selection of rules containing the mean value of a variable since the mean value would appear more frequently after imputation than it might appear if the true value were in the data.

If the historical record is at least partially complete, and the variable has a natural relationship to prior values then a last value imputed forward method can be used. Vehicle age is a good example of this type of variable. If the historical record is also missing, but a good single proxy estimator is available, the proxy should be used to impute the missing values. For instance, if age is entirely missing a variable such as driving experience could be used as a proxy estimator. If the number of missing values is greater than the threshold discussed above and there is no obvious single proxy estimator, then methods such as multiple imputation (MI) may be used.

### Categorical Variable Imputation:

Categorical variables may be imputed using methods such as last value carried forward if the historical record is at least partially complete and the value of the variable is not expected to change over time. Gender is a good example of such a variable. Other methods, such as MI, should be used if the number of missing values is less than a threshold amount, as discussed above, and good proxy estimators do not exist. Where good proxy estimators do exist they should be used instead. As with continuous variables, other methods of imputation, such as, for example, logistic regression or MI should be used in the absence of a single proxy estimator and when the number is missing values is more than the acceptable threshold.

### Creating the RHS Soft Tissue Injury Flag:

As noted above, soft tissue injuries include sprains, strains, neck and trunk injuries, and joint injuries. They do not include lacerations, broken bones, burns, or death (i.e. items which are impossible to fake). If a soft tissue injury occurs in conjunction with one of these, set the flag to 0. For instance, if an individual was burned and also had a sprained neck, the soft tissue injury flag would be set to 0. The theory being that most people who were actually burned would not go through the trouble of adding a false sprained neck. Items included in the soft tissue injury assessment must occur in isolation for the flag to be set to 1.

### Binning Continuous Variables:

Discrete numeric variables with five or fewer distinct values are not continuous and should be treated as categorical variables. Numeric variables must be discretized to use any association rules algorithm since these algorithms are designed with categorical variables in mind. Failing to bin the variables can result in the algorithm selecting each discrete value as a single category—thus rendering most numeric variables useless in generating rules. For instance, suppose damage amount is a variable under consideration and the claims under consideration have amounts with dollars and cents included. It is likely that a high number of claims 98% or better) will have unique values for this variable. As such, each individual value of the variable will have very low frequency on the dataset, making every instance appear as an anomaly. Since the goal is to find non-anomalous combinations to describe a “normal” profile, these values will not appear in any rules selected rendering the variable useless for rules generation.

### Number of Bins:

Generally, 2 to 6 bins performs best, but the number of bins is dependent on the quality of the rules generated and existing patterns in the data. Too few bins may result in a very high frequency variable which performs poorly at segmenting the population into normal and anomalous groups. Too many bins will create low support rules which may result in poor performing rules or may require many more combination of rules making the selection of the final set of rules much more complex.

The operative algorithm automates the binning process with input from the user to set the maximum number of bins and a threshold for selecting the best bins based on the difference between the bin with the maximum percentage of records (claims) and the bin with the minimum percentage of records (claims). Selecting the threshold value for binning is accomplished by first setting a threshold value of 0 and allowing the algorithm to find the best set of bins. As discussed above, rules are created and the variables are evaluated to determine if there are too many or too few bins. If there are too many bins, the threshold limit can be increased, and vice-versa for too few bins.

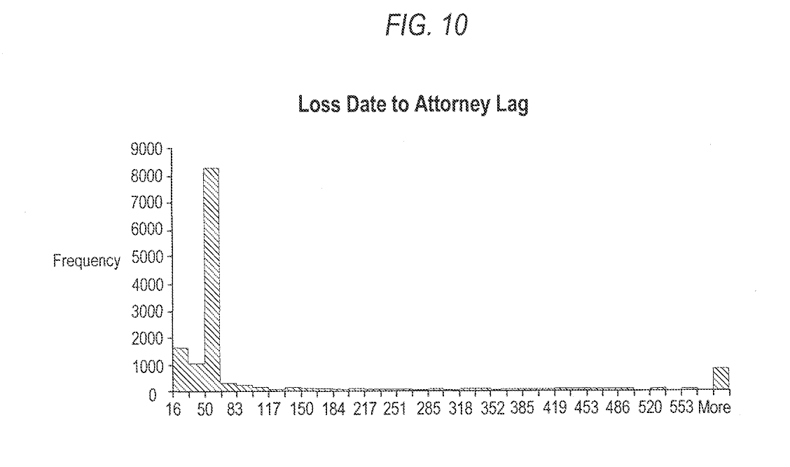

FIG. 10 graphically depicts the variable Lag between Loss Reported and Attorney Date which is the time in days between loss date and the date the attorney was hired. Note that there is a natural peak at ˜50 days with a higher frequency below 50 days than above 50 days. The exact split is at 45.5 days, which suggests that the variable Lag between Loss Reported and Attorney Date should have bins of:

1. Less than 45.5 days

2.45.5 days

3. More than 45.5 days

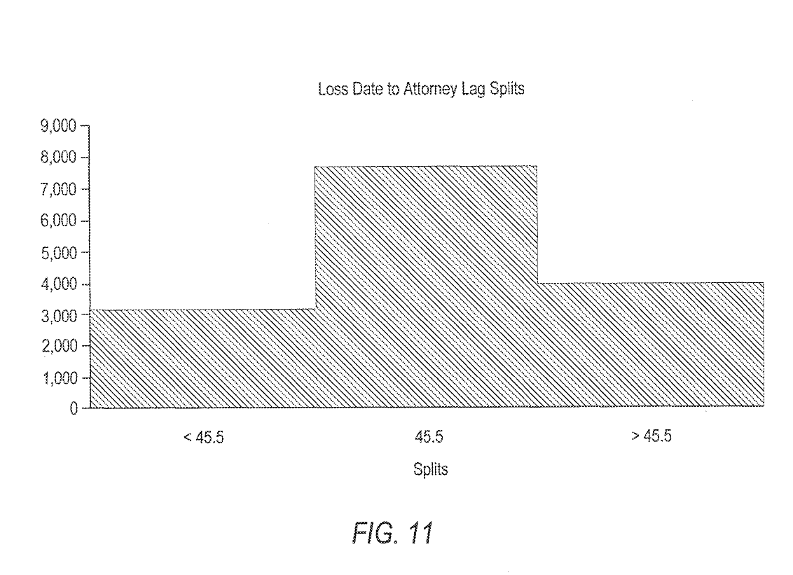

FIG. 11 graphically depicts the splits using such three bins.

### Bin Width:

In general, bins should be of equal width (as to number of records in each) to promote inclusion of each bin in the rules generation process. For example, if a set of four bins were created so that the first bin contained 1% of the population, the second contained 5%, the third contained 24%, and the fourth contained the remaining 70%, the fourth bin would appear in most or every rule selected. The third bin may appear in a few rules selected and the first and second bins would likely not appear in any rules. If this type of pattern appears naturally in the data (as in the graphs above), the bins should be formed to include as equal a percentage of claims in each bucket as possible. In this example, two bins would be produced—a first one combining the first three bins, with 30% of the claims, and a second bin, being the fourth bin, with 70% of the claims.

### Binary Bins:

Creating binary bins has the advantage of increasing the probability that each variable will be included in at least one rule, but reduces the amount of information available. Thus, this technique should only be used when a particular variable is not found in any selected rules but is believed to be important in distinguishing normal claims from abnormal claims.

Binary bins can be created using either the median, mode, or mean of the numeric variable. Generally, the median is preferred; however, the choice of the central measure should be selected such that the variable is cut as symmetrically as possible. Viewing each variable's histogram will aid determination of the correct choice.

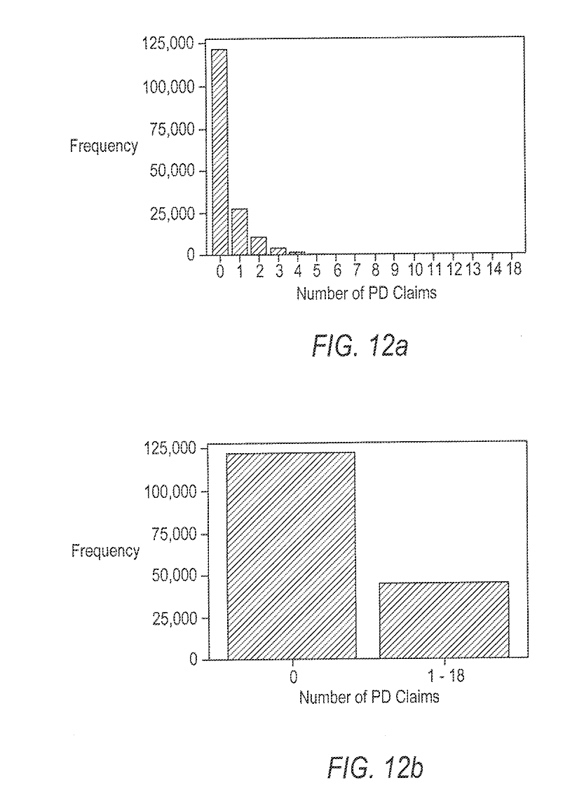

For example, FIGS. 12a and 12b graphically depict the number of property damage (“PD”) claims made by the claimant in the last three years. FIG. 12b indicates a natural binary split of 0 and greater than 0.

### Splitting Categorical Variables:

Depending on the algorithm employed to create rules, categorical variables may need to be split into 0/1 binary variables. For instance, the variable gender would be split into two variables male and female. If gender=‘male’ then the male variable would be set to 1 and female would be set to 0, and vice versa for a value of ‘female’. Other common categorical variables (and their values) may include:
Day of week when an accident occurred (1=Sunday to 7=Saturday)
Indicates if accident state is the same as claimant's state (0=no, 1=yes)
Claimant Part Front (0=no, 1=yes)
Claimant Part Rear (0=no, 1=yes)
Claimant Part Side (0=no, 1=yes)
Indicates if an accident occurred during the holiday season (1=November, December, January)
Primary Part Front (0=no, 1=yes)
Primary Part Rear (0=no, 1=yes)
Primary Part Side (0=no, 1=yes)
Indicates if primary insured's state is the same as claimant's state (0=no, 1=yes)
Indicates if primary insured's car is luxurious (0=Standard, 1=Luxury)

### Algorithmic Binning Process:

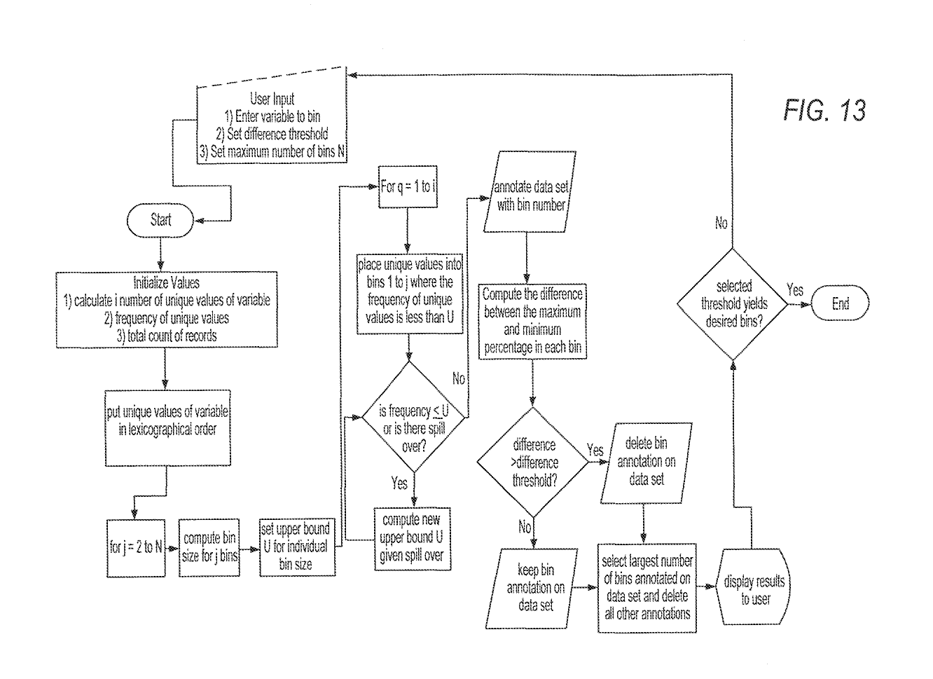

The following algorithm (see also FIG. 13) automates the binning process to produce the “best” equal height bins. “Best” is defined to be the set of bins in which the difference in population between the bin containing the maximum population percentage and the bin containing the minimum percentage of the population is smallest given a user input threshold value. The algorithm favors more bins over fewer bins when there is a tie.

| | |
|---|---|
| 1. | Set threshold to τ |
| 2. | Set max desired bins to N |
| 3. | Let V = variable to bin |
| 4. | Let i = {number of unique values of V} |
| 5. | Step 1: compute nᵢ = {frequency of i unique values of V} |
| 6. | Step 2: compute T = Σ₁ⁿ nᵢ (total count of all values) |
| 7. | Step 3: put unique values i of V in lexicographical order |
| 8. | Step 4: For j = 2 to N : compute Bⱼ = T/j (bin size for j bins) |
| 9. | Set b=1 |
| 10. | Set u = 0 |
| 11. | Set U=Bⱼ(upper bound) |
| 12. | For q = 1 to i: |
| 13. | u = Σ₁^{q} nᵢ |
| 14. | If u > U then |
| 15. | Bⱼ=(T−u)/(j−b) ... reset bin size to gain equal height...current |
| | bin |
| 16. | is larger than specified bin width |
| 17. | b=b+1 |
| 18. | U = b × Bⱼ |
| 19. | Else If u = U then |
| 20. | b=b+1 |
| 21. | U = b × Bⱼ |
| 22. | End If |
| 23. | End For: q |
| 24. | End For: j |
| 25. | Step 5: For each bin j : compute pₖ={percentage of population in bin |
| | k} |
| 26. | Compute Dⱼ = max(pₖ) − min(pₖ) |
| 27. | If Dⱼ < τ then set Dⱼ = τ |
| 28. | Step 6: Compute BestBin = arminⱼ(Dⱼ) : |
| 29. | If tie then set BestBin = armaxₘ(BestBinₘ) ... |
| 30. | largest number of bins among m ties |

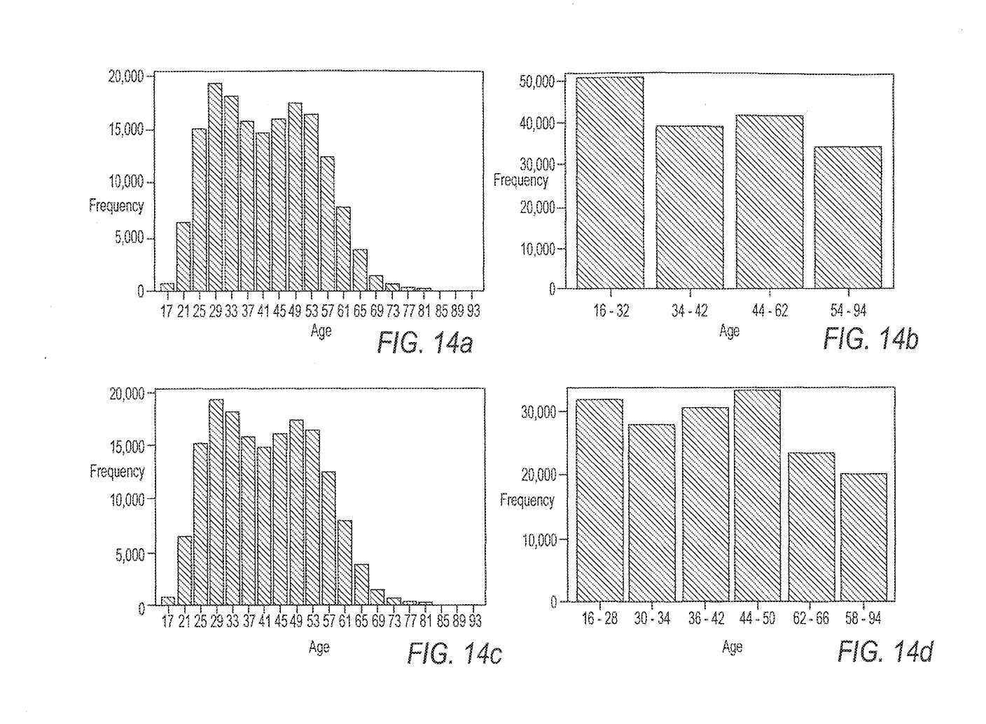

FIGS. 14a-14d show the results of applying the algorithm to the applicant's age with a maximum of 6 bins and threshold values of 0.0 and 0.10, respectively. With a threshold of 0, 4 bins are selected with a slight height difference between the first bin and the other two bins. With a threshold of 0.10 (bins are allowed to differ more widely) 6 bins are selected and the variation is larger between the first two bins and the last four bins.

### Variable Selection:

An initial set of variables to consider for association rules creation is developed to ensure that variables known to associate with fraudulent claims are entered into the list. The variable list is generally enhanced by adding macro-economic and other indicators associated with the claimant or policy state or MSA (Metropolitan Statistical Area). Additionally, synthetic variables such as date lags between the accident date and when an attorney is hired or distance measures between the accident site and the claimant's home address are also often included. Synthetic variables, properly chosen, are often very predictive. As noted above, the creation of synthetic variables can be automated in exemplary embodiments of the present invention

Highly correlated variables should not be used as they will create redundant but not more informative rules. For example an indicator variable for upper body joint and lower body joint sprains should be chosen rather than a generic joint sprain variable. Most variables from this initial list are then naturally selected as part of the association rules development. Many variables which do not appear in the LHS given the selected support and confidence levels are eliminated from consideration. However, it is possible that some variables which do not appear in rules initially may become part of the LHS if highly frequent variables which add little information are removed.

Variables with high frequency values may result in poor performing “normal” rules. For example, the most soft tissue injuries are to the neck and trunk. A rule describing the normal soft tissue injury claim would indicate that a neck and trunk injury is normal if a variable indicating this were used. However, this rule may not perform well as it would indicate that any joint injury is anomalous. However, individuals with joint injuries may not commit fraud at higher rates. Thus, the rule would not segment the population into high fraud and low fraud groups. When this occurs, the variable should be eliminated from the rules generation process.

TABLE 17

| LHS Rules | RHS | Confidence | Support |
|---|---|---|---|
| txt_Spinal_Sprains = 1 | =>txt_Neck_and_Trunk | 69% | 81% |
| txt_Spinal_Sprains = 1 and tgtlosssevadj = 0+ | =>txt_Neck_and_Trunk | 44% | 94% |
| txt_Spinal_Sprains = 1 and totclmcnt_cprev3 = 1 and pa_loss_centile_45chg | =>txt_Neck_and_Trunk | 31% | 85% |
| txt_Spinal_Sprains = 1 and FraudCmtClaim = 1 and totclmcnt_cprev3 = 1 | =>txt_Neck_and_Trunk | 37% | 69% |
| txt_Spinal_Sprains = 1 and txt_ERwoPolSc2 and attylit_lag = 181-365 | =>txt_Neck_and_Trunk | 92% | 63% |
| txt_Spinal_Sprains = 1 and txt_ERwoPolSc2 and attyst_lag = 366-730 | =>txt_Neck_and_Trunk | 94% | 91% |
| txt_Spinal_Sprains = 1 and FraudCmtClaim = 1 and biladatty_lag = 22-56 | =>txt_Neck_and_Trunk | 45% | 94% |
| txt_Spinal_Sprains = 1 and attylit_lag = 181-365 | =>txt_Neck_and_Trunk | 14% | 70% |
| txt_Spinal_Sprains = 1 and FraudCmtClaim = 1 and lisst_lag = 181-365 | =>txt_Neck_and_Trunk | 26% | 55% |
| txt_Spinal_Sprains = 1 and totclmcnt_cprev3 = 1 and lossrtpdtattrny_lag = 36-56 | =>txt_Neck_and_Trunk | 27% | 63% |
| txt_Spinal_Sprains = 1 and FraudCmtClaim = 1 and nabcmtpld = 7.6-10 | =>txt_Neck_and_Trunk | 1% | 1% |
| txt_Spinal_Sprains = 1 and nabcmtplcs = 7-8 | =>txt_Neck_and_Trunk | 92% | 91% |
| txt_Spinal_Sprains = 1 and FraudCmtClaim = 1 and nablosscatyl = 11-25 | =>txt_Neck_and_Trunk | 58% | 86% |
| txt_Spinal_Sprains = 1 and nablosscatyl = 11-25 | =>txt_Neck_and_Trunk | 89% | 79% |
| txt_Spinal_Sprains = 1 and numDaysPriorAcc = <=0 | =>txt_Neck_and_Trunk | 94% | 53% |

As shown in Table 17, spinal sprains occur in all rules in which the RHS is a neck and trunk injury. This is a somewhat uninformative and expected result. Removing the variable from consideration may allow other information to become apparent in the rules, thus providing better insight into normal injury and behavior combinations. Table 18 below shows a sample of rules with support and confidence in the same range, but with more informative information.

TABLE 18

| | | | Sup- |
|---|---|---|---|
| LHS Rules | RHS | Confidence | port |
| tgtlosssevadj = 0+ and | =>txt_Neck_and_Trunk | 43% | 95% |
| rttcrime_clmt = 9-10 | | | |
| and attylit_lag = | | | |
| 181-365 | | | |
| rsenior_clmt and | =>txt_Neck_and_Trunk | 31% | 87% |
| totclmcnt_cprev3 = 1 | | | |
| and attyst_lag = | | | |
| 366-729 | | | |
| lossrtpdtattrny_lag = | =>txt_Neck_and_Trunk | 36% | 69% |
| 36-56 and | | | |
| totclmcnt_cprev3 = 1 | | | |
| and biladatty_lag = | | | |
| 22-56 | | | |
| totclmcnt_cprev3 = 1 | =>txt_Neck_and_Trunk | 92% | 64% |
| and attylit_lag = | | | |
| 181-365 | | | |
| tgtlosssevadj = 0+ and | =>txt_Neck_and_Trunk | 91% | 93% |
| attyst_lag = 366-729 | | | |

### Generating Subsets:

Normal Profile:

The goal of the association rule scoring process is to find claims that are abnormal, by seeing which of the “normal” rules are not satisfied (i.e., the tripwires having been “tripped”). However, association rules are geared to finding highly frequent item sets rather than anomalous combinations of items. Thus, rules are generated to define normal and any claim not fitting these rules is deemed abnormal. Accordingly, as noted, rules generation is accomplished using only data defining the normal claim. If the data contains a flag identifying cases adjudicated as fraudulent, those claims should be removed from the data prior to creation of association rules since these claims are anomalous by default, and not descriptive of the “normal” profile. Rules can then be created, for example, using the data which do not include previously identified fraudulent claims.

Abnormal or Fraudulent Profile:

Optionally, additional rules may be created using only the claims previously identified as fraudulent and selecting only those rules which contain the fraud indicator on the RHS. In practice, the results of this approach are limited when used independently. However, combining rules which identify fraud on the RHS with rules that identify normal soft tissue injuries may improve predictive power. This is accomplished by running all claims through the normal rules and flagging any claims which do not meet the LHS condition but satisfy the RHS condition. These abnormal claims can then, for example, be processed through the fraud rules, and claims meeting the LHS condition are flagged for further investigation. Examples of these types of rules are shown in Table 19 below.

TABLE 19

| LHS Rules | RHS | Confidence | Support |
|---|---|---|---|
| totclmcnt_cprev3 = 1 | =>Soft_Tissue_Injury | 0.4% | 99% |
| and attylit_lag = | | | |
| 181-365 | | | |
| FraudCmtClaim = 1 | =>Soft_Tissue_Injury | 0.4% | 98% |
| and nabcmtpld = 7.6-10 | | | |
| nablosscatyl = 11-25 | =>Soft_Tissue_Injury | 0.7% | 99% |
| and rincomeh = 55-70 | | | |
| clmntDrvrNotlnvlvd = D | =>Soft_Tissue_Injury | 5.4% | 96% |
| and rttcrime_clmt = | | | |
| 9-10 | | | |

Note that these anomalous rules have a very low support (the probability of the LHS event even happening is low) but high confidence (if and when the LHS event does occur, the RHS event almost always occurs). Thus, the LHS occurs very infrequently when a soft tissue injury is indicated.

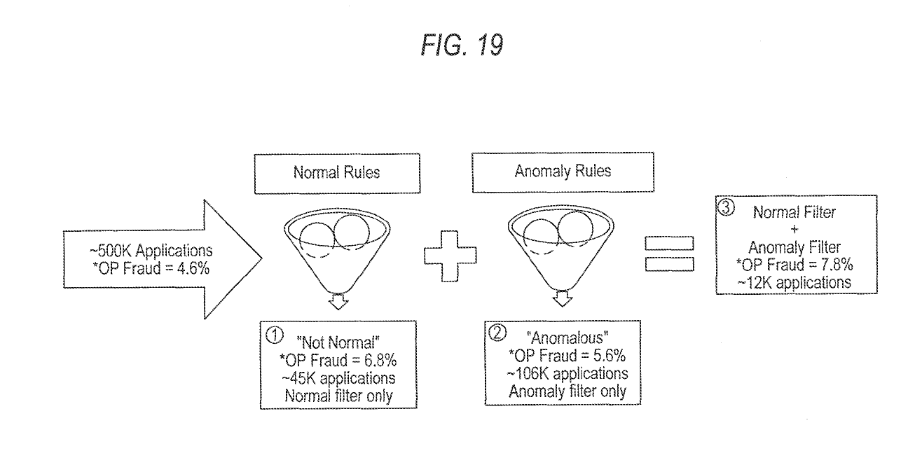

FIG. 19 illustrates the use of association rules to capture the pattern of both “normal” claims and “anomalous” claims, and the benefit of using both profiles in claim scoring according to exemplary embodiments of the present invention. With reference thereto, for an example set of 500,000 claims, where the incidence of fraud is 4.6%, by generating rules to capture the “normal” claim profile, filtering out all such normal claims, and only investigating claims that are thus “not normal”, the set of claims is whittled down to about 45,000. These claims have an incidence of fraud of approximately 6.8%, a distinct improvement over the initial set. Corroborating the methods of the present invention, if only an anomalous claim profile is generated using the association rules, and that is used to filter out claims to investigate (as opposed to use of the normal filter, which informs which claims not to investigate), a subset of approximately 106,000 claims was found, of which only 5.6% were found to have an incidence of fraud. Still an improvement, but not the same improvement as the normal filter. However, by applying both filters, i.e., first filtering out the 455,000 normal claims, and then of the remaining 45,000 “not normal” claims, filtering those of the not normal claims that satisfy the “anomalous” profile, and investigating those, a set of about 12,000 claims was found, with a rate of fraud of about 7.8%. Thus, although by itself a set of anomaly rules is not the best way to isolate fraud, by combining it with a normal filter, a significant increase in the fraud incidence for such claims can be realized.

### Generating Rules:

### Support and Confidence:

As previously noted, there are multiple algorithms for quantifying association rules. The Apriori Algorithm, frequent item sets, predictive Apriori, teritus, and generalized sequential pattern generation algorithms, for example, all produce rules of the form: LHS implies RHS with underlying Support and Confidence. Again, support is the probability of the LHS event happening: P(LHS)=Support; confidence is the conditional probability of the RHS given the LHS: P(RHS|LHS)=Confidence.

For example, let LHS={fracture injury to the lower extremity=TRUE, fracture injury to the upper extremity=TRUE} and RHS={joint injury=TRUE}. Fractures are less common events in auto BI claims and fractures to both upper and lower extremities are rare. Thus the support of this rule might be only 3%. However, when fractures of both upper and lower extremities exist, other joint injuries are commonly found. The Confidence of this rule might be 90%. This indicates that in claims where there are fractures of the upper and lower extremities, 90% of these individuals also experience a joint injury. The probability of the full event would be 2.7%. That is, 2.7% of all BI claims would fit this rule.

### Determining Support Criteria:

Most association rules algorithms require a support threshold to prune the vast number of rules created during processing. A low support threshold (˜5%) would create millions or even tens of millions of rules making the evaluation process difficult or impossible to accomplish. As such, a higher threshold should be selected. This can be done incrementally, for example, by choosing an initial support value of 90% and increasing or decreasing the threshold until a manageable number of rules is produced. Generally 1,000 rules is a good upper bound, but that may be increased as computing power, RAM and computing speed all increase. The confidence level can—for example, further reduce the number of rules to be evaluated.

### Evaluating Rules Based on Confidence:

In auto BI claims, fraud tends to happen in claims where there are injuries to the neck and/or back, as these are easier to fake than fractures or more serious injuries. This is a particular instance of the general source of fraud, which is subjective self-reported bases for a monetary or other benefit, where such bases are hard or impossible to independently verify. Using association rules and features of the claims related to the types of injury and body part affected, multiple independent rules with high support and confidence can be constructed. The goal is to find rules that describe “normal” BI claims containing only soft tissue injuries. What is desired are rules of the form LHS=>{soft tissue injury} in which the rules are of high Confidence. If the RHS is present without the LHS, a violation of the rule occurs. Support is used to reduce the number of rules to the least possible number needed to produce the highest rate of true positives and lowest rate of false negatives when compared against the fraud indicator. Table 20 below sets forth examplary output of an association rules algorithm with various metrics displayed.

TABLE 20

| LHS Rules | RHS | Confidence | Support |
|---|---|---|---|
| clmntDrvrNotlnvlvd = D and numDaysPriorAcc = 31-180 and attylit_lag = 181-365 | =>Soft_Tissue_Injury | 98.3% | 93.9% |
| FraudCmtClaim = 1 and nabcmtpld = 7.6-10 | =>Soft_Tissue_Injury | 98.2% | 92.3% |
| nablosscatyl = 11-25 and rincomeh = 55-70 | =>Soft_Tissue_Injury | 92.7% | 97.4% |
| lossCuasePD = 62 and attylit_lag = 181-365 and rincomeh = 55-70 | =>Soft_Tissue_Injury | 0.9% | 96.8% |
| rttcrime_clmt = 9-10 and txt_ERwoPolSc2 and tgtlosssevadj = 0+ | =>Soft_Tissue_Injury | 1.5% | 93.2% |
| nabcmtpld = 7.6-10 and nablosscatyl = 11-25 and reducind_clmt = 71-80 | =>Soft_Tissue_Injury | 2.3% | 88.5% |
| totclmcnt_cprev3 = 1 and biladatty_lag = 22-56 and attylit_lag = 181-365 | =>Soft_Tissue_Injury | 0.4% | 0.6% |
| FraudCmtClaim = 1 and nabcmtpld = 7.6-10 and rttcrime_clmt = 9-10 | =>Soft_Tissue_Injury | 0.4% | 1.0% |
| linkedPDline and txt_ERwoPolSc2 and tgtlosssevadj = 0+ | =>Soft_Tissue_Injury | 0.5% | 1.0% |

The first three would be kept in this example since they have high confidence and high support. This indicates that the claim elements in the LHS occur quite frequently (are normal) and that when they occur there are often soft tissue injuries. Thus, these describe normal soft tissue injuries. The next three rules have high confidence, but low support. These are abnormal soft tissue injuries. These may be considered for a secondary set of anomalous rules, as described above in connection with FIG. 19. The last three are not normal and are not soft tissue injuries when the LHS occurs. These rules should be removed.

### Evaluating Rules Based on the Fraud Level of the Subpopulation:

To evaluate individual rules one can, for example, first subset the data into those claims that satisfy the RHS condition (they are soft tissue injuries). Then, find all claims that violate the LHS condition and compare the rate of fraud for this subpopulation to the overall rate of fraud in the entire population. Keep the LHS if the rule segments the data such that cases satisfying the LHS have a higher rate of fraud than the overall population. Eliminate rules that have the same or a lower rate of fraud compared to the overall population.

TABLE 21
Rule: {Vehicle Age <7 years, # Days Prior Accident >117, # Claims
per Claimant = 1}

Normal

| | | No | Yes |
|---|---|---|---|
| Fraud | No | 92% | 94% |
| | Yes | 8% | 6% |

Normal rules can then, for example, be tested on the full dataset. Table 21 above depicts the outcome of a particular rule (columns add to 100%). Note that the fraud rate for the population meeting the rule (Normal=Yes) is 6% compared to the fraud rate for the population which does not meet the rule at 8%. This indicates a well performing rule which should be kept. When evaluating individual rules, the threshold for keeping a rule should be set low. Generally, for example, if there is improvement in the first decimal place, the rule should be initially kept. A secondary evaluation using combinations of rules will further reduce the number of rules in the final rule set.

Once all LHS conditions are tested and the set of LHS rules to keep are determined, test the combined LHS rules against those cases which meet the RHS condition. If the overall rate of fraud is higher than the rate of fraud in the full population, then the set of rules performs well. Given that each rule individually performs well, the combined set generally performs well. However, combining all LHS rules may also eliminate truly fraudulent cases resulting in a large number of false negatives. Thus, different combinations of rules must be tested to find those combinations which result in low false negative values and high rates of fraud.

TABLE 22

| | | | # Flagged | | Expected |
|---|---|---|---|---|---|
| | # Claims | # Flagged & | & Known | % Known | Unknown |
| Rule | Flagged | SIU | Fraud | Fraud | Fraud |
| inlocTOCmtLT2miles, NabLossCatyL_[−∞-21.0], | 1,929 | 284 | 161 | 61% | 903 |
| primlnsVhcleAge_[−∞-6.5], clmntDmgPartCnt_[−∞-0.5] | | | | | |
| noFault_ind, totclmcnt_cprev3_[−∞-1.5] | 749 | 115 | 58 | 60% | 367 |
| inlocTOCmtLT2miles, NabLossCatyL_[−∞-21.0], | 228 | 31 | 22 | 75% | 155 |
| primlnsVhcleAge_[−∞-6.5], FraudCmtClaim_[−∞-1.5] | | | | | |
| noFault_ind, BILADATTY_LAG_[−∞-39.5] | 52 | 5 | 8 | 76% | 26 |

Note the behavior of rules violated versus the SIU referral rate in Table 22 above. As more rules are violated fewer of the resulting claims in the subpopulation were historically selected for investigation, but the subpopulation has a much higher rate of fraud. This is the desired behavior as it indicates that the rules are uncovering potentially previously unknown fraud. Table 22 illustrates how the number of claims identified as known fraud and the expected numbers of claims with previously unknown fraud change as multiple rules can be combined. Applying only the first rule yields a known fraud rate of 55% and an expected 903 claims with previously unknown fraud. At first this may seem very good and that perhaps only the first rule should be applied. However, the lower known fraud rate gives less confidence about the actual level of fraud in the expected fraudulent claims. There is less confidence that all 903 claims will in fact be fraudulent. Combining the first two rules does not improve this appreciably giving further evidence that more rules are needed. The jump to 75% known fraud after adding in the third rule provides much more confidence that the 155 suspected fraudulent claims will contain a very high rate of fraud. Including the fourth rule does not improve the known fraud rate but significantly reduces the number of potentially fraudulent claims from 155 to 26. Thus, for example, applying the first three rules in combination provides the best solution. The fourth rule is not thrown out immediately as it may combine well with other rules. If after checking all combinations, the fourth rule performs as it does in this example, then it would be eliminated.

The ultimate set of rule combinations results in the confusion matrix depicted in Table 23 below, which exhibits a good predictive capability. Note that the 6% of claims predicted to be fraudulent, but not currently flagged as fraudulent, are the expected claims containing unknown currently undetected fraud. These claims are not considered false positives. Also note that the false negative rate is very low at 1%. Therefore the overall combination of rules performs well. The final list of exemplary rules is provided below.

TABLE 23

Predicted Fraud

| | | No | Yes | |
|---|---|---|---|---|
| Fraud | No | 82% | 6% | 88% |
| | Yes | 1% | 11% | 12% |
| | | 83% | 17% | |

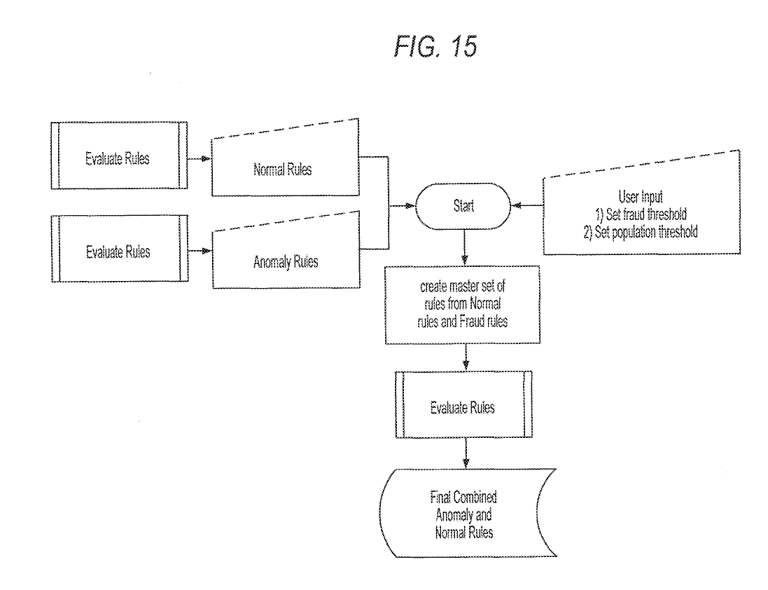

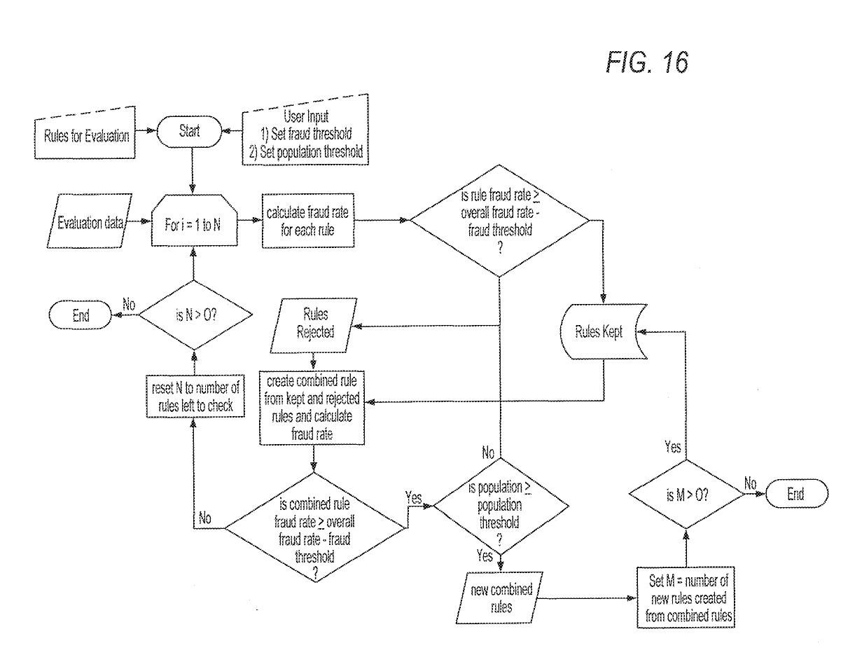

Exemplary Algorithm for Exhaustively Testing Rules for Inclusion (see also FIGS. 15 and 16):

| | |
|---|---|
| 1. | Set fraud rate acceptance threshold to τ |
| 2. | Set records threshold to ρ |
| 3. | Let A be the set of all applications |
| 4. | Let P be the set of normal rules |
| 5. | Let Λ be the set of normal rules |
| 6. | Step 1: Test individual “normal” rules |
| 7. | For each rule rᵢε P |
| 8. | Find Φ ⊂ A such that Φ = {αⱼεA : αⱼ ∩ rᵢ = φ} |
| 9. | If F(Φ) ≧ F(A) + τ and \|Φ\| ≧ ρ then keep rule rᵢ |
| 10. | Step 2: Let R ⊂ P be the set of all rules kept in Step 1 |
| 11. | Let Θ ⊂ P be the set of all rules rejected in Step 1 |
| 12. | For each r_{q}ε R |
| 13. | For each ηₖε Θ |
| 14. | Find Ψ ⊂ A such that Ψ = {αⱼεA : (αⱼ ∩ r_{q}) ∪ (αⱼ ∩ |
| | ηₖ) = φ} |
| 15. | Find Φ ⊂ A such that Φ = {αⱼεA : αⱼ ∩ rᵢ = φ} |
| 16. | If F(Ψ) ≧ F(Φ) + τ and \|Φ\| ≧ ρ then keep rule ηₖ |
| 17. | Define new rule θ = (r_{q} ∩ ηₖ) |
| 18. | Step 3: Repeat Step 2 over all new rules θ until no new rules are |
| | defined |
| 19. | Step 4: Test individual “anomalous” rules |
| 20. | For each rule rᵢε Λ |
| 21. | Find Φ ⊂ A such that Φ = {αⱼεA : αⱼ ∩ rᵢ ≠ φ} |
| 22. | If F(Φ) ≧ F(A) + τ and \|Φ\| ≧ ρ then keep rule rᵢ |
| 23. | Step 5: Let R ⊂ Λ be the set of all rules kept in Step 1 |
| 24. | Let Θ ⊂ Λ be the set of all rules rejected in Step 1 |
| 25. | For each r_{q}ε R |
| 26. | For each ηₖε Θ |
| 27. | Find Ψ ⊂ A such that Ψ = {αⱼεA : (αⱼ ∩ r_{q}) ∪ (αⱼ ∩ |
| | ηₖ) ≠ φ} |
| 28. | Find Φ ⊂ A such that Φ = {αⱼεA : αⱼ ∩ rᵢ ≠ φ} |
| 29. | If F(Ψ) ≧ F(Φ) + τ and \|Φ\| ≧ ρ then keep rule ηₖ |
| 30. | Define new rule θ = (r_{q} ∩ ηₖ) |
| 31. | Step 6: Repeat Step 5 over all new rules θ until no new rules are |
| | defined |

### Final Rules List:

Table 24 below lists the final rules produced is this example.

TABLE 24

| LHS | RHS | Support | Confidence |
|---|---|---|---|
| inlocTOCmtLT2miles, NabLossCatyL_[−∞-21.0], primInsVhcleAge_[−∞-6.5], | Soft_Tissue_Injury | 60% | 95% |
| clmntDmgPartCnt_[−∞-0.5] | | | |
| inlocTOCmtLT2miles, primInsVhcleAge_[−∞-6.5], FraudCmtClaim_2 | Soft_Tissue_Injury | 77% | 89% |
| inlocTOCmtLT2miles, NabCmtPlcL_[−∞-8.9], numDaysPriorAcc_[−∞-116.8] | Soft_Tissue_Injury | 66% | 88% |
| inlocTOCmtLT2miles, NabLossCatyL_[−∞-21.0], primInsVhcleAge_[−∞-6.5], | Soft_Tissue_Injury | 76% | 88% |
| FraudCmtClaim_2 | | | |
| inlocTOCmtLT2miles, NabLossCatyL_[−∞-21.0], BILADATTY_LAG_[−∞-40.0], | Soft_Tissue_Injury | 64% | 88% |
| numDaysPriorAcc_[−∞-116.8] | | | |
| inlocTOCmtLT2miles, NabLossCatyL_[−∞-21.0], NabCmtPlcL_[−∞-8.9], | Soft_Tissue_Injury | 63% | 88% |
| BILADATTY_LAG_[−∞-40.0], numDaysPriorAcc_[−∞-116.8] | | | |
| noFault_ind, totclmcnt_cprev3_1 | Soft_Tissue_Injury | 61% | 87% |
| noFault_ind, holiday_acc | Soft_Tissue_Injury | 80% | 87% |
| noFault_ind, holiday_acc, AccClmtStateInd | Soft_Tissue_Injury | 68% | 87% |
| noFault_ind, AccClmtStateInd | Soft_Tissue_Injury | 69% | 87% |
| noFault_ind, BILADATTY_LAG_[−∞-40.0] | Soft_Tissue_Injury | 70% | 86% |
| noFault_ind, holiday_acc, BILADATTY_LAG_[−∞-40.0] | Soft_Tissue_Injury | 64% | 85% |
| noFault_ind, n_claimant_role_idCNT_4 | Soft_Tissue_Injury | 63% | 85% |
| txt_ERwPolatSc1, primInsClmtStateInd | Soft_Tissue_Injury | 69% | 85% |
| rsenior_clmt_[−∞-9.8] | Soft_Tissue_Injury | 60% | 98% |
| rpop25_clmt_[−∞-11.8] | Soft_Tissue_Injury | 55% | 98% |
| acc_day_4 | Soft_Tissue_Injury | 55% | 97% |
| rttcrime_clmt_[−∞-10.5] | Soft_Tissue_Injury | 53% | 97% |
| rdensity_clmt_[−∞-17.5] | Soft_Tissue_Injury | 52% | 96% |
| reducind_clmt_[−∞-75.8] | Soft_Tissue_Injury | 52% | 96% |
| PA_Loss_centile_BILAD_[−∞-64.5] | Soft_Tissue_Injury | 50% | 96% |
| rincomeh_clmt_[−∞-64.5] | Soft_Tissue_Injury | 50% | 96% |

### Association Rules Scoring (Auto BI Example)

As noted above, once a set of association rules has been generated form a sample set of claims (training set) it can then, in exemplary embodiments, be used to score new claims. The following describes scoring of claims for the exemplary Auto BI example described above.

### Input Data Specifications

This can be essentially the same as set forth above in connection with the auto BI clustering example.

### Missing Data Imputation:

For a claim coming into the system, the values of each of the 128 variables can be populated and then standardized, as noted above. In exemplary embodiments, this may be done through the following process:

Impute Missing Values:

a. If the variable value is not present for a given claim, the value must be imputed based on the Missing Value Imputation Instructions provided. This must be replicated for each variable to ensure values are provided for each variable for a given claim.

b. For example, if a claim does not have a value for the variable ACCOPENLAG (lag in days between the accident date and the BI line open date) is not present, and the instructions require using a value of 5 days, then the value of this variable for the claim can be set to 5.

Variable Split Definitions:

Each of the 128 predictive variables can be transformed into a binary flag. This may be accomplished by utilizing the Variable Split Definitions from the Seed Data. These split definitions are rules of the form IF-THEN-ELSE that split each numeric variable into a binary flag. For example:
IF ACCOPENLAG>=30 THEN ACCOPENFLAG BINARY=1 ELSE ACCOPENFLAG BINARY=0;
   Note that this is only required for those variables that make up the set of rules to be scored, rather than the entire 128 variable set. The following variables in Table 25 below are an example:

TABLE 25

| Variable | Split Value |
|---|---|
| rsenior_clmt | 9.8 |
| rpop25_clmt | 11.8 |
| rttcrime_clmt | 10.5 |
| reducind_clmt | 75.8 |
| rincomeh_clmt | 64.5 |
| rdensity_clmt | 17.5 |
| primInsVhcleAge | 6.5 |
| numDaysPriorAcc | 116.8 |
| NabCmtPlcL | 8.8 |
| NabLossCatyL | 21 |
| BILADATTY_LAG | 40 |
| BILADLT_LAG | 272.8 |

Categorical variables not coded as 0/1 can be split into 0/1 binary variables. For example acc_day (the day of the week the accident takes place) consists of the values 1-7. Each value would become its own variable and would have the value 1 if the original variable corresponds, and 0 otherwise. For example, a variable acc_day_{—}3 might be created and acc_day_{—}3=1 when acc_day=3 and acc_day_{—}3=0 otherwise.

The following variables can benefit from this process:
acc_day
n_claimant_role_idCNT
totclmcnt_cprev3
FraudCmtClaim
   The following are exemplary binary 0/1 categorical variables used in scoring:
holiday_acc
noFault_ind
txt_ERwPolatSc1
primInsClmtStateInd
inlocTOCmtLT2 mile
AccClmtStatelnd
   Subset Claims with a Soft Tissue Injury:

The association rules scoring process in this example is focused on claims with a soft tissue injury, such as a back injury, for the reasons described above. Thus, the first step in the scoring process is to select only those claims which have a soft tissue injury. If there is no soft tissue injury, these claims are not flagged for referral to the SIU in the same way.

If the claim involves a claimant with a soft tissue injury, then the following process can, for example, be used to forward claims to the SIU:

### Apply LHS Rules and Subset Those With 1+Rule Hits:

A series of rules are generated using the Seed Data (see, e.g., Table 26). These rules are of the form: {LHS Condition}=>{RHS Condition}. First, all claims are evaluated against the LHS conditions on the rules. If a claim does not meet any of the LHS conditions, then it is not forwarded on to the SIU. If it meets any of the LHS conditions for any of the rules, then proceed to the next step.

For example, a rule might be: {Claimant Rear Bumper Damage, Insured Front End Damage}=>{Neck Injury}. A claim flagged by this rule is flagged because it has both rear bumper damage for the claimant and front end damage for the insured (i.e., the insured vehicle rear-ended the claimant vehicle).

TABLE 26

| LHS | RHS | Support | Confidence |
|---|---|---|---|
| inlocTOCmtLT2miles, NabLossCatyL_[−∞-21.0], primInsVhcleAge_[−∞-6.5], | Soft_Tissue_Injury | 60% | 95% |
| clmntDmgPartCnt_[−∞-0.5] | | | |
| inlocTOCmtLT2miles, primInsVhcleAge_[−∞-6.5], FraudCmtClaim_2 | Soft_Tissue_Injury | 77% | 89% |
| inlocTOCmtLT2miles, NabCmtPlcL_[−∞-8.9], numDaysPriorAcc_[−∞-116.8] | Soft_Tissue_Injury | 66% | 88% |
| inlocTOCmtLT2miles, NabLossCatyL_[−∞-21.0], primInsVhcleAge_[−∞-6.5], | Soft_Tissue_Injury | 76% | 88% |
| FraudCmtClaim_2 | | | |
| inlocTOCmtLT2miles, NabLossCatyL_[−∞-21.0], BILADATTY_LAG_[−∞-40.0], | Soft_Tissue_Injury | 64% | 88% |
| numDaysPriorAcc_[−∞-116.8] | | | |
| inlocTOCmtLT2miles, NabLossCatyL_[−∞-21.0], NabCmtPlcL_[−∞-8.9], | Soft_Tissue_Injury | 63% | 88% |
| BILADATTY_LAG_[−∞-40.0], numDaysPriorAcc_[−∞-116.8] | | | |
| noFault_ind, totclmcnt_cprev3_1 | Soft_Tissue_Injury | 61% | 87% |
| noFault_ind, holiday_acc | Soft_Tissue_Injury | 80% | 87% |
| noFault_ind, holiday_acc, AccClmtStateInd | Soft_Tissue_Injury | 68% | 87% |
| noFault_ind, AccClmtStateInd | Soft_Tissue_Injury | 69% | 87% |
| noFault_ind, BILADATTY_LAG_[−∞-40.0] | Soft_Tissue_Injury | 70% | 86% |
| noFault_ind, holiday_acc, BILADATTY_LAG_[−∞-40.0] | Soft_Tissue_Injury | 64% | 85% |
| noFault_ind, n_claimant_role_idCNT_4 | Soft_Tissue_Injury | 63% | 85% |
| txt_ERwPolatSc1, primInsClmtStateInd | Soft_Tissue_Injury | 69% | 85% |
| rsenior_clmt_[−∞-9.8] | Soft_Tissue_Injury | 60% | 98% |
| rpop25_clmt_[−∞-11.8] | Soft_Tissue_Injury | 55% | 98% |
| acc_day_4 | Soft_Tissue_Injury | 55% | 97% |
| rttcrime_clmt_[−∞-10.5] | Soft_Tissue_Injury | 53% | 97% |
| rdensity_clmt_[−∞-17.5] | Soft_Tissue_Injury | 52% | 96% |
| reducind_clmt_[−∞-75.8] | Soft_Tissue_Injury | 52% | 96% |
| PA_Loss_centile_BILAD_[−∞-64.5] | Soft_Tissue_Injury | 50% | 96% |
| rincomeh_clmt_[−∞-64.5] | Soft_Tissue_Injury | 50% | 96% |

### Apply RHS Rules and Calculate Violation Count:

In exemplary embodiments, for each claim, the appropriate RHS conditions can be evaluated that correspond to the LHS conditions which flagged each claim. In the example from the prior section, the claim involves rear bumper damage to the claimant and front end damage to the insured. Then, the claim is compared against the right hand side of the rule: Does the claim also have a Neck Injury?

If there is no neck injury, then the claim has violated a rule. The count of all violations can then be summed over all rules that apply to each claim.

Select Claims that Fail to Trigger a Critical Number of RHS:

Once all rules have been evaluated against the claims, then the claims which have a violation count larger than the critical number can be forwarded to the SIU. The critical number can be set based on the training set data. In this example, the critical number is 4. Claims with 4 or more violations will be forwarded to the SIU for further investigation.

### Business Exceptions:

There are potential exceptions to the rule for forwarding claims to the STU. These business rules would be customized to a particular user's individual claims department, for example, but all exceptions would keep a claim from being forwarded to the SIU. For example, as already noted above, if the claim involves death, do not forward the claim to the SIU.

### UI Example

### Association Rule Creation:

Next described is an exemplary process of creating association rules for fraud detection in Unemployment Insurance (UI) claims. The goal of the association rules is to create a set of tripwires to identify fraudulent claims. A pattern of normal claim behavior is constructed based on the common associations between the claim attributes. For example, 75% of claims from blue collar workers are filed in the late fall and winter. Probabilistic association rules are derived on the raw claims data using a commonly known method such as the frequent item sets algorithm (other methods would also work). Independent rules are selected which form strong associations between attributes on the application, with probabilities greater than 95%, for example. Applications violating the rules are deemed anomalous and are process further or sent to the SIU for review.

### Input Data Specification

Example Variables:
Eligibility Amount
Transition Account
Application Submission Month
Union Member
Age
Education
SOC Code
NAICS Code
Seasonal Worker
Military Veteran

### Outliers:

The ultimate goal of the association rules is to find outlier behavior in the data. As such, true outliers should be left in the data to ensure that the rules are able to capture normal behavior. Thus, removing true outliers may cause combinations of values to appear more prevalent than represented by the raw data. Data entry errors, missing values, or other types of outliers that are not natural to the data should be imputed. There are many methods of imputation available, but the method of imputation depends on the type of “missingness”, type of variable under consideration, amount of “missingness”, and to some extent user preference.

The following discussion is similar to that presented above for the Auto BI example. It is repeated here for ready reference.

### Continuous Variable Imputation:

For continuous variables without good proxy estimators and with few values missing, mean value imputation works well. Given that the goal of the rules being developed is to define normal UI claims, a threshold of 5% or the rate of fraud in the overall population (whichever is lower) should be used. Mean imputation of more than this amount may result in an artificial and biased selection of rules containing the mean value of a variable since the mean value would appear more frequently after imputation than it might appear if the true value were in the data.

If the historical record is at least partially complete and the variable has a natural relationship to prior values then last value imputed forward can be used. Applicant age and gender are good examples of this type of variable. If the historical record is also missing, but a good single proxy estimator is available, the proxy should be used to impute the missing values. For instance, if Maximum Eligible Benefit Amount is entirely missing a variable such as SOC could be used to develop an estimate. If the number of missing values is greater than the threshold discussed above and there is no obvious single proxy estimator, then methods such as MI should be used.

### Categorical Variable Imputation:

Categorical variables may be imputed using methods such as last value carried forward if the historical record is at least partially complete and the value of the variable is not expected to change over time. Gender is a good example. Other methods such as MI should be used if the number of missing values is less than a threshold amount as discussed above and good proxy estimators do not exist. Where good proxy estimators do exist they should be used instead. As with continuous variables, other methods of imputation such as logistic regression or MI should be used in the absence of a single proxy estimator and when the number is missing values is more than the acceptable threshold.

### Determining the RHS:

The RHS can be determined entirely by the association rules algorithm or a common RHS may be selected to generate rules which have more meaning and provide an organized series of rules for scoring. In this example, a grouping of the SOC industry codes was used.

### Binning Continuous Variables:

Discrete numeric variables with five or fewer distinct values are not continuous and should be treated as categorical variables. Numeric variables must be discretized to use any association rules algorithm since these algorithms are designed with categorical variables in mind. Failing to bin the numeric variables will result in the algorithm selecting each discrete value as a single category rendering most numeric variables useless in generating rules. For instance, suppose eligibility amount is a variable under consideration and the claims under consideration have amounts with dollars and cents included. It is likely, that a high number of claims 98% or better) will have unique values for this variable. As such, each individual value of the variable will have very low frequency on the dataset making every instance an anomaly. Since the goal is to find non-anomalous combinations, these values will not appear in any rules selected rendering the variable useless for rules generation.

### The Number of Bins:

Generally, 2 to 6 bins performs best, but the number of bins is dependent on the quality of the rules generated and existing patterns in the data. Too few bins may result in a very high frequency variable which performs poorly at segmenting the population into normal and anomalous groups. Too many bins (as in the extreme example above) will create low support rules which may result in poor performing rules or may require many more combination of rules making the selection of the final set of rules much more complex.

The algorithm below automates the binning process with input from the user to set the maximum number of bins and a threshold for selecting the best bins based on the difference between the bin with the maximum percentage of records and the bin with the minimum percentage of records. Selecting the threshold value for binning is accomplished by first setting a threshold value of 0 and allowing the algorithm to find the best set of bins. As discussed above, rules are created and the variables are evaluated to determine if there are too many or too few bins. If there are too many bins, the threshold limit can be increased and vice versa for too few bins.

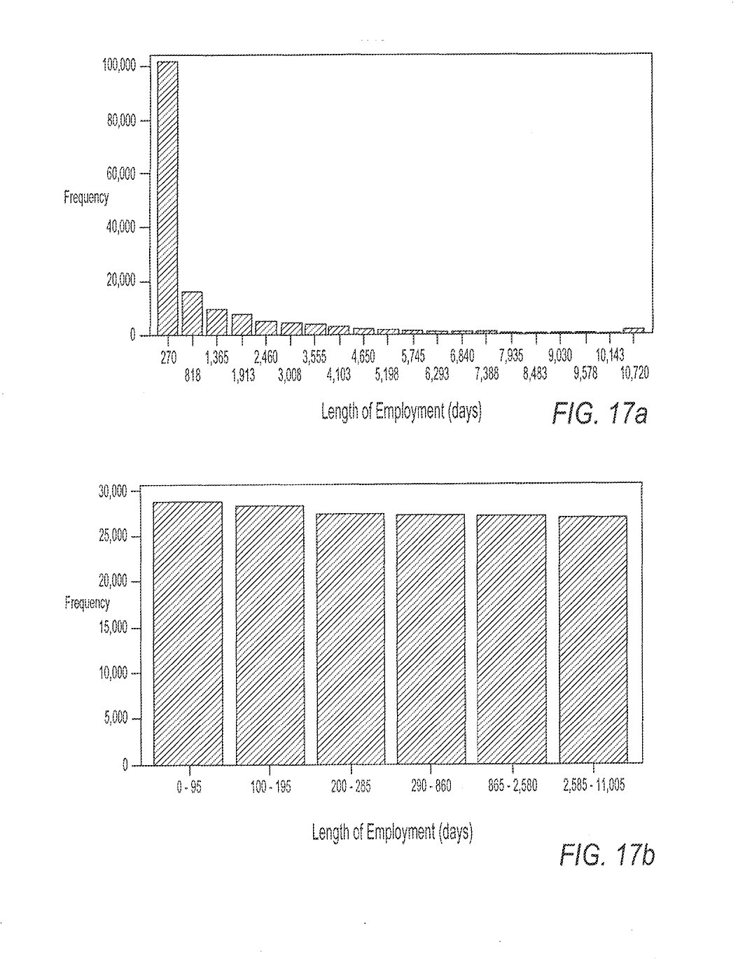

Because there are multiple RHS components representing different industries and different industries likely have unique distributions of variables, binning must be accomplished for each RHS independently. The graph depicted in FIG. 17a shows the length of employment in days for the construction industry. The distribution does not have a definite center making binary binning a less appropriate approach for this variable. The chart depicted in FIG. 17b shows the results of finding six equal height bins with the chart on the left showing the distribution before binning and the chart on the right showing the distribution after binning.

### Bin Height:

Bins should be of equal height to promote inclusion of each bin in the rules generation process. For example, if a set of four bins were created so that the first bin contained 1% of the population, the second contained 5%, the third contained 24%, and the fourth contained the remaining 70%, the fourth bin would appear in most or every rule selected. The third bin may appear in a few rules selected and the first and second bins would likely not appear in any rules. If this type of pattern appears naturally in the data (as in the graphs above), the bins should be formed to include as equal a percentage of claims in each bucket as possible. In this example, two bins would be produced with 30% and 70% of the claims in each bin respectively.

### Binary Bins:

Creating binary bins has the advantage of increasing the probability that each variable will be included in at least one rule, but reduces the amount of information available. Thus, this technique should only be used when a particular variable is not found in any selected rules but is believed to be important in distinguishing normal claims from abnormal claims.

Binary bins are created using either the median, mode, or mean of the numeric variable. Generally, the median works best. However, the choice of the central measure should be selected such that the variable is cut as symmetrically as possible. Viewing each variable's histogram will aid determination of the correct choice.

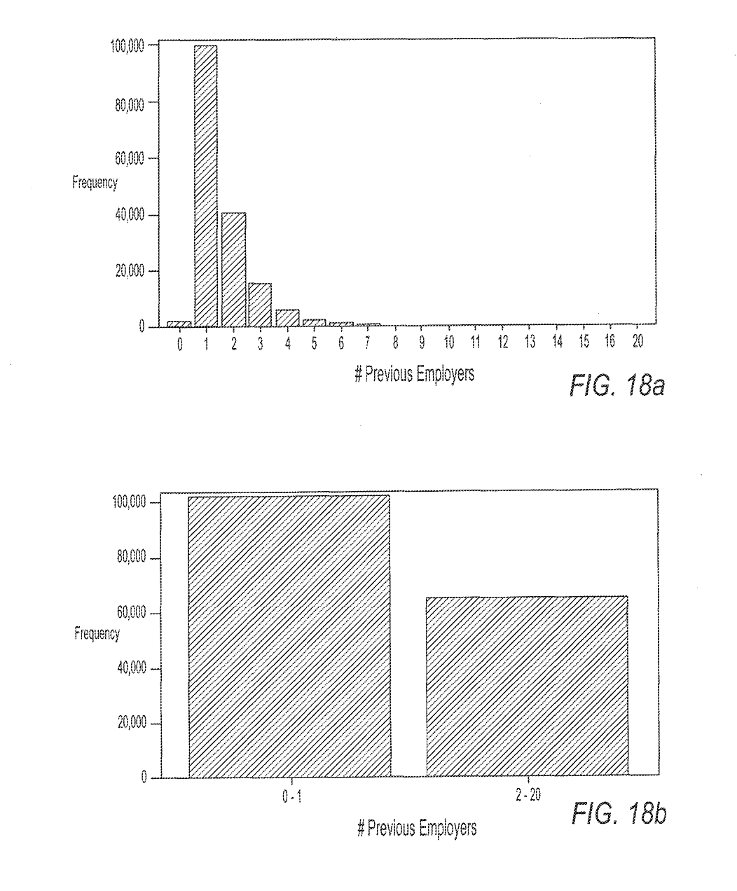

FIG. 18a graphically shows the number of previous employers for blue collar applicants. FIG. 18b shows a natural binary split of 1 and greater than 1.

### Splitting Categorical Variables:

Depending on the algorithm deployed to create rules, categorical variables may need to be split into 0-1 binary variables. For instance, the variable gender would be split into two variables male and female. If gender=‘male’ then the male variable would be set to 1 and it would be set to 0 otherwise and vice versa for the female variable. Other common categorical variables include:
Citizen Indicator (1=Yes, 0=No)
Union Member (1=Yes, 0=No)
Veteran (1=Yes, 0=No)
Handicapped (1=Yes, 0=No)
Seasonal Worker (1=Yes, 0=No)

### Algorithmic Binning Process:

The following algorithm (see also FIG. 13) automates the binning process to produce the best equal height bins (i.e., the set of bins in which the difference in population between the bin containing the maximum population percentage and the bin containing the minimum percentage of the population is smallest given an input threshold value). The algorithm favors more bins over fewer bins when there is a tie.

| | |
|---|---|
| 31. | Set threshold to τ |
| 32. | Set max desired bins to N |
| 33. | Let V = variable to bin |
| 34. | Let i = {number of unique values of V} |
| 35. | Step 1: compute nᵢ = {frequency of i unique values of V} |
| 36. | Step 2: compute T = Σ₁ⁿ nᵢ (total count of all values) |
| 37. | Step 3: put unique values i of V in lexicographical order |
| 38. | Step 4: For j = 2 to N : compute Bⱼ = T/j (bin size for j bins) |
| 39. | Set b=1 |
| 40. | Set u = 0 |
| 41. | Set U=Bⱼ(upper bound) |
| 42. | For q = 1 to i: |
| 43. | u = Σ₁^{q} nᵢ |
| 44. | If u > U then |
| 45. | Bⱼ=(T−u)/(j−b) ... reset bin size to gain equal height...current |
| | bin |
| 46. | is larger than specified bin width |
| 47. | b=b+1 |
| 48. | U = b × Bⱼ |
| 49. | Else If u = U then |
| 50. | b=b+1 |
| 51. | U = b × Bⱼ |
| 52. | End If |
| 53. | End For: q |
| 54. | End For: j |
| 55. | Step 5: For each bin j : compute pₖ={percentage of population in bin |
| | k} |
| 56. | Compute Dⱼ = max(pₖ) − min(pₖ) |
| 57. | If Dⱼ < τ then set Dⱼ = τ |
| 58. | Step 6: Compute BestBin = arminⱼ(Dⱼ) : |
| 59. | If tie then set BestBin = armaxₘ(BestBinₘ) ... |
| 60. | largest number of bins among m ties |

FIGS. 14a-14d (which can be applicable to both auto BI and UI claims) show the results of applying the algorithm to the applicant's age with a maximum of 6 bins and threshold values of 0.0 and 0.10, respectively. With a threshold of 0, 4 bins are selected with a slight height difference between the first bin and the other two bins. With a threshold of 0.10 (bins are allowed to differ more widely) 6 bins are selected and the variation is larger between the first two bins and the last four bins.

### Variable Selection:

An initial set of variables to consider for association rules creation is developed to ensure that variables known to associate with fraudulent claims are entered into the list. The variable list is generally enhanced by adding macro-economic and other indicators associated with the applicant, state, or MSA. Additionally, synthetic variables such as the time between the current application and the last filed application or the total number of past accounts and average total payments from previous accounts.

Highly correlated variables should not be used as they will create redundant but not more informative rules. For example, the weekly benefit amount and the maximum benefit amount are functionally related. Having both of the variables on the data set would likely result in one of them on the LHS and the other on the RHS, but this relationship is known and not informative. Most variables from this initial list are then naturally selected as part of the association rules development. Many variables which do not appear in the LHS given the selected support and confidence levels are eliminated from consideration. However, it is possible that some variables which do not appear in rules initially may become part of the LHS if highly frequent variables which add little information are removed.

Variables with high frequency values may result in poor performing “normal” rules. For example, the construction industry is largely dominated by male workers. A rule describing the normal UI application for this industry would indicate that being male is normal if a variable indicating gender were used. However, this rule may not perform well as it would indicate that any female applicant is anomalous. However, females may not commit fraud at higher rates than males. Thus, the rule would not segment the population into high fraud and low fraud groups. When this occurs, the variable should be eliminated from the rules generation process.

TABLE 27

| LHS | RHS | Support | Confidence |
|---|---|---|---|
| EDUC_CD = DCTR = true, MBA_ELIG_AMT_LIFE =<7605.0 | MAX_ELIG_WBA_AMT=<292.5 | 35% | 97% |
| MBA_ELIG_AMT_LIFE =<7605.0 | MAX_ELIG_WBA_AMT=<292.5 | 99% | 97% |
| MBA_ELIG_AMT_LIFE =<7605.0 TAX_WHLD_BOTH_IND = 0 | MAX_ELIG_WBA_AMT=<292.5 | 85% | 97% |
| MBA_ELIG_AMT_LIFE =<7605.0 EMAIL_IND = NO | MAX_ELIG_WBA_AMT=<292.5 | 80% | 97% |
| NAICS_GROUP = HEALTH CARE AND SOCIAL ASSISTANCE, | MAX_ELIG_WBA_AMT=<292.5 | 99% | 97% |
| MBA_ELIG_AMT_LIFE =<7605.0 | | | |
| MBA_ELIG_AMT_LIFE =<7605.0, ACCT_DT_winter = 1 | MAX_ELIG_WBA_AMT=<292.5 | 23% | 97% |
| MBA_ELIG_AMT_LIFE =<7605.0, ACCT_DT_spring = 1 | MAX_ELIG_WBA_AMT=<292.5 | 16% | 97% |
| MBA_ELIG_AMT_LIFE =<7605.0, ACCT_DT_summer = 1 | MAX_ELIG_WBA_AMT=<292.5 | 41% | 97% |
| MBA_ELIG_AMT_LIFE =<7605.0, ACCT_DT_fall = 1 | MAX_ELIG_WBA_AMT=<292.5 | 20% | 97% |

In Table 27 above, MAX_ELIG_WBAAMT=<292.5 as the RHS with every LHS containing MBA_ELIG_AMT_LIFE=<7605.0. This result is not informative since the RHS is just a multiple of the LHS. Further, the RHS is largely dependent on the industry (Health Care in this case). Thus, other LHS components are also less informative in combination with MAX_ELIG_WBA_AMT on the RHS. Removing both variables would allow other LHS components to enter consideration and promote the Health Care industry NAICS Descriptions on the RHS. Table 28 below shows a sample of rules with support and confidence in the same range, but with more informative information.

TABLE 28

| LHS | RHS | Support | Confidence |
|---|---|---|---|
| GENDER_CD = FEML, | NAICS_GROUP = HEALTH CARE AND SOCIAL ASSISTANCE | 28% | 96% |
| RACE_CD = WHIT, | | | |
| SOC_YEARS = [−∞-10.8] | | | |
| RACE_CD = WHIT, | NAICS_GROUP = HEALTH CARE AND SOCIAL ASSISTANCE | 33% | 96% |
| SOC_YEARS = [−∞-10.8], | | | |
| LEN_OF_EMPL <=1192.0 | | | |
| GENDER_CD = FEML, | NAICS_GROUP = HEALTH CARE AND SOCIAL ASSISTANCE | 38% | 96% |
| RACE_CD = WHIT, | | | |
| SOC_YEARS = [−∞-10.8] | | | |
| GENDER_CD = FEML, | NAICS_GROUP = HEALTH CARE AND SOCIAL ASSISTANCE | 38% | 96% |
| RACE_CD = WHIT, | | | |
| LEN_OF_EMPL =<1192.0 | | | |
| GENDER_CD = FEML, | NAICS_GROUP = HEALTH CARE AND SOCIAL ASSISTANCE | 39% | 95% |
| SOC_YEARS = [−∞-10.8], | | | |
| LEN_OF_EMPL =<1192.0 | | | |

### Generating Subsets:

As noted above repeatedly, the goal of the association rules scoring process is to find claims which are abnormal. However, association rules are geared to finding highly frequent items sets rather than anomalous combinations of items. Thus, rules are generated to define normal and any claim not fitting these rules is deemed abnormal. Accordingly, rules generation is accomplished using only data defining the normal claim. If the data contains a flag identifying cases adjudicated as fraudulent, those claims should be removed from the data prior to creation of association rules since these claims are anomalous by default. Rules are then created using the data which do not include previously identified fraudulent claims.

Optionally, additional rules may be created using only the claims previously identified as fraudulent and selecting only those rules which contain the fraud indicator on the RHS. In practice, the results of this approach are limited when used independently. However, combining rules which identify fraud on the RHS with rules that identify normal UI claims may improve predictive power. This is accomplished by running all claims through the normal rules and flagging any claims which do not meet the LHS condition but satisfy the RHS condition. These abnormal claims are then processed through the fraud rules and claims meeting the LHS condition are flagged for further investigation. Examples of these types of rules are shown in Table 29 below.

TABLE 29

| LHS | RHS | Support | Confidence |
|---|---|---|---|
| EDUC_BUCKET = MSTR | WHITE COLLAR | 6% | 98% |
| app_month = Sep | WHITE COLLAR | 7% | 98% |
| app_month = Aug | WHITE COLLAR | 7% | 97% |
| app_month = Jul | WHITE COLLAR | 8% | 95% |
| APPROX_AGE = | WHITE COLLAR | 8% | 98% |
| [28.2-40.3], | | | |
| EDUC_BUCKET = BCHL | | | |

It is noted that these anomalous rules have a very low support but high confidence. Thus, having a master's degree is not common among all industries, but when it does occur, there is a 98% probability that the applicant works in a White Collar industry.

Use of both normal and anomalous rules is described above in connection with FIG. 19. It should be appreciated that the same considerations apply to Auto BI, UI and essentially any fraud domain.

### Generating Rules:

### Support and Confidence:

As previously discussed, the algorithms for quantifying association rules produce rules of the form: LHS implies RHS with underlying Support and Confidence (Support being the probability of the LHS event happening: P(LHS)=Support; Confidence being the conditional probability of the RHS given the LHS: P(RHS|LHS)=Confidence).

For example, let LHS={Age between 28 and 40, Bachelor's Degree=True} and RHS={White Collar Worker}. Bachelor's degrees are somewhat uncommon in general and are less common in the 28 to 40 age bracket. Thus the support of this is only 8%. However, when among white collar workers aged 28 to 40 having a bachelor's degree is quite common with a confidence of 97%. This tells us that 97% of white collar applicants aged 28 to 40 have bachelor's degrees. The probability of the full event would be 7.8%. That is, 7.8% of all applications would fit this rule.

### Determining Support Criteria:

Most association rules algorithms require a support threshold to prune the vast number of rules created during processing. A low support threshold (˜5%) would create millions or even tens of millions of rules making the evaluation process difficult or impossible to accomplish. As such, a higher threshold should be selected. This can be done incrementally by choosing an initial support value of 90% and increasing or decreasing the threshold until a manageable number of rules is produced. Generally 1,000 rules is a good upper bound. The confidence level will further reduce the number of rules to be evaluated.

### Evaluating Rules Based on Confidence:

Using association rules and features of the application related to the applicant's industry, we construct multiple independent rules with high support and confidence. The goal is to find rules which describe “normal” applications within a particular industry. What is desired are rules of the form LHS=>{industry} in which the rules are of high Confidence. Support is used to reduce the number of rules to the least possible number needed to produce the highest rate of true positives and lowest rate of false negatives when compared against the fraud indicator. Table 30 below sets forth example output of an association rules algorithm with various metrics displayed.

TABLE 30

| LHS | RHS | Support | Confidence |
|---|---|---|---|
| Past Accounts <=1, Base Period Employers <=2, Race = White | Production Occupations | 81% | 91% |
| Race = White, Base Period Employers <=2, Years in SOC <=12 | Production Occupations | 70% | 89% |
| Race = White, Base Period Employers <=2, Gender = Female | Production Occupations | 60% | 83% |
| Transition Account = Yes, Education < High School Grad, Age <27 | Production Occupations | 0.8% | 87% |
| Transition Account = Yes, Union Member = Yes | Production Occupations | 0.9% | 86% |
| Base Period Employers >3, Race = White, Education < High School Grad | Production Occupations | 38% | 29% |
| Length of Employment <=60993.0, Race = White, Education < High School Grad | Production Occupations | 38% | 18% |

The first three would be kept in this example since they have high confidence and high support. This indicates that the applications elements in the LHS occur quite frequently (are normal) and that when they occur they are often found in within the Production Occupations. Thus, these describe normal Production Occupation applications. The next two rules have high confidence, but low support. These are abnormal Production Occupation applications. These may be considered for a secondary set of anomalous rules. The last two rules have lower support and confidence and should be removed altogether.

### Evaluating Rules Based on the Fraud Level of the Subpopulation:

To evaluate individual rules first subset the data into those claims which satisfy the RHS condition (they are soft tissue injuries); then, find all claims that violate the LHS condition and compare the rate of fraud for this subpopulation to the overall rate of fraud in the entire population. Keep the LHS if the rule segments the data such that cases satisfying the LHS have a higher rate of fraud than the overall population. Eliminate rules which have the same or a lower rate of fraud compared to the overall population.

TABLE 31

Normal

| | | No | Yes |
|---|---|---|---|
| Fraud | No | 91.3% | 94.8% |
| | Yes | 8.7% | 5.2% |

{Past Accounts <=1, Base Period Employers <=2, Race = White}=>Production Occupations

Normal rules are tested on the full dataset. Table 31 above depicts the outcome of a particular rule (columns add to 100%). Note that the fraud rate for the population meeting the rule (Normal=Yes) is 5.2% compared to the fraud rate for the population which does not meet the rule at 8.7%. This indicates a well performing rule which should be kept. When evaluating individual rules, the threshold for keeping a rule should be set low. Generally, if there is improvement in the first decimal place, the rule should be initially kept. A secondary evaluation using combinations of rules will further reduce the number of rules in the final rule set.

Once all LHS conditions are tested and the set of LHS rules to keep are determined, test the combined LHS rules against those cases which meet the RHS condition. If the overall rate of fraud is higher than the rate of fraud in the full population, then the set of rules performs well. Given that each rule individually performs well, the combined set generally performs well. However, combining all LHS rules may also eliminate truly fraudulent cases resulting in a large number of false negatives. If this occurs, test combinations of rules beginning with the best performing rule and adding on the next best rule iteratively. Exhaustively test all rules combinations until the set with the highest true positive and true negative rate is found. The ultimate set of rules results in confusion matrix depicted below which exhibits a good predictive capability:

TABLE 32

Predicted Fraud

| | | No | Yes |
|---|---|---|---|
| Fraud | No | 91.9% | 0.7% |
| | Yes | 0.6% | 6.8% |

The best performing set of “normal” rules may still allow a high false positive rate. In this case the secondary set of anomalous rules described above may improve performance. In Table 32 above, applications that fail the “normal” rules exhibit a fraud rate of 6.8% compared to the overall rate of 4.6%. After applying the anomaly rules to the subset of applications failing the normal rules, the fraud rate of the resulting population increases to 7.8%. Thus, applying the second set of rules produces a better outcome.
Algorithm for Exhaustively Testing Rules for Inclusion (see also FIGS. 15 and 16).

| | |
|---|---|
| 32. | Set fraud rate acceptance threshold to τ |
| 33. | Set records threshold to ρ |
| 34. | Let A be the set of all applications |
| 35. | Let P be the set of normal rules |
| 36. | Let Λ be the set of normal rules |
| 37. | Step 1: Test individual “normal” rules |
| 38. | For each rule rᵢε P |
| 39. | Find Φ ⊂ A such that Φ = {αⱼεA : αⱼ ∩ rᵢ = φ} |
| 40. | If F(Φ) ≧ F (A) + τ and \|Φ\| ≧ ρ then keep rule rᵢ |
| 41. | Step 2: Let R ⊂ P be the set of all rules kept in Step 1 |
| 42. | Let Θ ⊂ P be the set of all rules rejected in Step 1 |
| 43. | For each r_{q}ε R |
| 44. | For each ηₖε Θ |
| 45. | Find Ψ ⊂ A such that Ψ = {αⱼεA : (αⱼ ∩ r_{q}) ∪ (αⱼ ∩ |
| | ηₖ) = φ} |
| 46. | Find Φ ⊂ A such that Φ = {αⱼεA : αⱼ ∩ rᵢ = φ} |
| 47. | If F(Ψ) ≧ F(Φ) + τ and \|Φ\| ≧ ρ then keep rule ηₖ |
| 48. | Define new rule θ = (r_{q} ∩ ηₖ) |
| 49. | Step 3: Repeat Step 2 over all new rules θ until no new rules are |
| | defined |
| 50. | Step 4: Test individual “anomalous” rules |
| 51. | For each rule rᵢε Λ |
| 52. | Find Φ ⊂ A such that Φ = {αⱼεA : αⱼ ∩ rᵢ ≠ φ} |
| 53. | If F(Φ) ≧ F(A) + τ and \|Φ\| ≧ ρ then keep rule rᵢ |
| 54. | Step 5: Let R ⊂ Λ be the set of all rules kept in Step 1 |
| 55. | Let Θ ⊂ Λ be the set of all rules rejected in Step 1 |
| 56. | For each r_{q}ε R |
| 57. | For each ηₖε Θ |
| 58. | Find Ψ ⊂ A such that Ψ = {αⱼεA : (αⱼ ∩ r_{q}) ∪ (αⱼ ∩ |
| | ηₖ) ≠ φ} |
| 59. | Find Φ ⊂ A such that Φ = {αⱼεA : αⱼ ∩ rᵢ ≠ φ} |
| 60. | If F(Ψ) ≧ F(Φ) + τ and \|Φ\| ≧ ρ then keep rule ηₖ |
| 61. | Define new rule θ = (r_{q} ∩ ηₖ) |
| 62. | Step 6: Repeat Step 5 over all new rules θ until no new rules are |
| | defined. |

Table 33 below lists the final set of “normal” UI association rules produced:

TABLE 33

| LHS | RHS | Support | Confidence |
|---|---|---|---|
| Past Accounts <=1, Base | {Arts, Design, Entertainment, | 81% | 100% |
| Period Employers <=2, | Sports, and Media Occupations; | | |
| Race = White | Production Occupations} | | |
| Race = White, Base | {Arts, Design, Entertainment, | 70% | 100% |
| Period Employers <=2, | Sports, and Media Occupations; | | |
| Years in SOC <=12 | Production Occupations} | | |
| Race = White, Base | {Arts, Design, Entertainment, | 60% | 100% |
| Period Employers <=2, | Sports, and Media Occupations; | | |
| Gender = Female | Production Occupations} | | |
| Base Period Employers | {Arts, Design, Entertainment, | 53% | 100% |
| <=3, Years in SOC <=13, | Sports, and Media Occupations; | | |
| Past Accounts <=1 | Production Occupations} | | |
| Base Period EMployers | {Arts, Design, Entertainment, | 53% | 100% |
| <=3, Transition Account = | Sports, and Media Occupations; | | |
| No | Production Occupations} | | |
| Base Period Employers | {Arts, Design, Entertainment, | 50% | 100% |
| <=2, Race = White | Sports, and Media Occupations; | | |
| | Production Occupations} | | |
| Base Period Employers | {Arts, Design, Entertainment, | 50% | 100% |
| <=2, Transition Account = | Sports, and Media Occupations; | | |
| No, Years in SOC <=11 | Production Occupations} | | |
| Race = White, | {Arts, Design, Entertainment, | 37% | 100% |
| Education >= BCHL | Sports, and Media Occupations; | | |
| | Production Occupations} | | |
| Base Period Employers | {Arts, Design, Entertainment, | 35% | 100% |
| <=2, Application Month | Sports, and Media Occupations; | | |
| in (May, Jun, Jul, Aug), | Production Occupations} | | |
| Race = White | | | |
| Race = White, Base | {Protective Service Occupations; | 77% | 100% |
| Period Employers <=2, | Construction and Extraction | | |
| Years in SOC <=12 | Occupations; Installation, | | |
| | Maintenance, and Repair | | |
| | Occupations; Transportation and | | |
| | Material Moving Occupations} | | |
| Past Accounts <=1, Base | {Protective Service Occupations; | 65% | 100% |
| Period Employers <=2, | Construction and Extraction | | |
| Race = White | Occupations; Installation, | | |
| | Maintenance, and Repair | | |
| | Occupations; Transportation and | | |
| | Material Moving Occupations} | | |
| Base Period Employers | {Protective Service Occupations; | 58% | 100% |
| <=3, Race = White, | Construction and Extraction | | |
| Transition Account = No | Occupations; Installation, | | |
| | Maintenance, and Repair | | |
| | Occupations; Transportation and | | |
| | Material Moving Occupations} | | |
| Race = White, Base | {Protective Service Occupations; | 45% | 100% |
| Period Employers <=2, | Construction and Extraction | | |
| Gender = Female | Occupations; Installation, | | |
| | Maintenance, and Repair | | |
| | Occupations; Transportation and | | |
| | Material Moving Occupations} | | |
| Base Period Employers | {Protective Service Occupations; | 39% | 100% |
| <=3, Years in SOC <=13, | Construction and Extraction | | |
| Past Accounts <=1 | Occupations; Installation, | | |
| | Maintenance, and Repair | | |
| | Occupations; Transportation and | | |
| | Material Moving Occupations} | | |
| Base Period Employers | {Protective Service Occupations; | 39% | 100% |
| <=3, Transition Account = | Construction and Extraction | | |
| No | Occupations; Installation, | | |
| | Maintenance, and Repair | | |
| | Occupations; Transportation and | | |
| | Material Moving Occupations} | | |
| Base Period Employers | {Protective Service Occupations; | 36% | 100% |
| <=3, Years in SOC <=4 | Construction and Extraction | | |
| | Occupations; Installation, | | |
| | Maintenance, and Repair | | |
| | Occupations; Transportation and | | |
| | Material Moving Occupations} | | |
| Base Period Employers | {Protective Service Occupations; | 33% | 100% |
| <=2, Race = White | Construction and Extraction | | |
| | Occupations; Installation, | | |
| | Maintenance, and Repair | | |
| | Occupations; Transportation and | | |
| | Material Moving Occupations} | | |
| Race = White, | {Protective Service Occupations; | 27% | 100% |
| Education >= BCHL | Construction and Extraction | | |
| | Occupations; Installation, | | |
| | Maintenance, and Repair | | |
| | Occupations; Transportation and | | |
| | Material Moving Occupations} | | |
| Base Period Employers | {Protective Service Occupations; | 24% | 100% |
| <=2, Application Month | Construction and Extraction | | |
| in (May, Jun, Jul, Aug), | Occupations; Installation, | | |
| Race = White | Maintenance, and Repair | | |
| | Occupations; Transportation and | | |
| | Material Moving Occupations} | | |
| Past Accounts <=1, Base | {Personal Care and Service | 80% | 100% |
| Period Employers <=2, | Occupations; Community and | | |
| Race = White | Social Service Occupations; | | |
| | Education, Training, and Library | | |
| | Occupations} | | |
| Base Period Employers | {Personal Care and Service | 65% | 100% |
| <=2, Race = White | Occupations; Community and | | |
| | Social Service Occupations; | | |
| | Education, Training, and Library | | |
| | Occupations} | | |
| Race = White, Base | {Personal Care and Service | 61% | 100% |
| Period Employers <=2, | Occupations; Community and | | |
| Gender = Female | Social Service Occupations; | | |
| | Education, Training, and Library | | |
| | Occupations} | | |
| Race = White, Base | {Personal Care and Service | 57% | 100% |
| Period Employers <=2, | Occupations; Community and | | |
| Years in SOC <=12 | Social Service Occupations; | | |
| | Education, Training, and Library | | |
| | Occupations} | | |
| Base Period Employers | {Personal Care and Service | 48% | 100% |
| <=2, Race = White | Occupations; Community and | | |
| | Social Service Occupations; | | |
| | Education, Training, and Library | | |
| | Occupations} | | |
| Past Accounts <=1, Race = | {Personal Care and Service | 48% | 100% |
| White | Occupations; Community and | | |
| | Social Service Occupations; | | |
| | Education, Training, and Library | | |
| | Occupations} | | |
| Base Period Employers | {Personal Care and Service | 47% | 100% |
| <=3, Years in SOC <=13, | Occupations; Community and | | |
| Past Accounts <=1 | Social Service Occupations; | | |
| | Education, Training, and Library | | |
| | Occupations} | | |
| Base Period Employers | {Personal Care and Service | 47% | 100% |
| <=3, Transition Account = | Occupations; Community and | | |
| No | Social Service Occupations; | | |
| | Education, Training, and Library | | |
| | Occupations} | | |
| Base Period Employers | {Personal Care and Service | 47% | 100% |
| <=2, Transition Account = | Occupations; Community and | | |
| No, Education = | Social Service Occupations; | | |
| 12GRD | Education, Training, and Library | | |
| | Occupations} | | |
| Base Period Employers | {Personal Care and Service | 46% | 100% |
| <=2, Race = White, | Occupations; Community and | | |
| Education >= BCHL | Social Service Occupations; | | |
| | Education, Training, and Library | | |
| | Occupations} | | |
| Base Period Employers | {Personal Care and Service | 46% | 100% |
| <=2, Application Month | Occupations; Community and | | |
| in (May, Jun, Jul, Aug), | Social Service Occupations; | | |
| Race = White | Education, Training, and Library | | |
| | Occupations} | | |
| Base Period Employers | {Personal Care and Service | 46% | 100% |
| <=2, Past Accounts <=1 | Occupations; Community and | | |
| | Social Service Occupations; | | |
| | Education, Training, and Library | | |
| | Occupations} | | |
| Gender = Female, Race = | {Personal Care and Service | 45% | 100% |
| White, Length of | Occupations; Community and | | |
| Employment <=3.3 | Social Service Occupations; | | |
| Years | Education, Training, and Library | | |
| | Occupations} | | |
| Base Period Employers | {Personal Care and Service | 43% | 100% |
| <=3, Race = White, | Occupations; Community and | | |
| Transition Account = No | Social Service Occupations; | | |
| | Education, Training, and Library | | |
| | Occupations} | | |
| Race = White, Years in | {Personal Care and Service | 39% | 100% |
| SOC <=12, Gender = | Occupations; Community and | | |
| Female | Social Service Occupations; | | |
| | Education, Training, and Library | | |
| | Occupations} | | |
| Base Period Employers | {Personal Care and Service | 32% | 100% |
| <=2, Application Month | Occupations; Community and | | |
| in (May, Jun, Jul, Aug), | Social Service Occupations; | | |
| Race = White | Education, Training, and Library | | |
| | Occupations} | | |
| Base Period Employers | {Personal Care and Service | 30% | 100% |
| <=2, Gender = Female, | Occupations; Community and | | |
| Race = White | Social Service Occupations; | | |
| | Education, Training, and Library | | |
| | Occupations} | | |
| Past Accounts <=1, | {Personal Care and Service | 30% | 100% |
| Gender = Female, Race = | Occupations; Community and | | |
| White | Social Service Occupations; | | |
| | Education, Training, and Library | | |
| | Occupations} | | |
| Past Accounts <=1, Base | {Healthcare Practitioners and | 84% | 100% |
| Period Employers <=2, | Technical Occupations; | | |
| Race = White | Healthcare Support Occupations} | | |
| Race = White, Base | {Healthcare Practitioners and | 68% | 100% |
| Period Employers <=2, | Technical Occupations; | | |
| Gender = Female | Healthcare Support Occupations} | | |
| Base Period Employers | {Healthcare Practitioners and | 62% | 100% |
| <=2, Race = White | Technical Occupations; | | |
| | Healthcare Support Occupations} | | |
| Race = White, Base | {Healthcare Practitioners and | 60% | 100% |
| Period Employers <=2, | Technical Occupations; | | |
| Years in SOC <=12 | Healthcare Support Occupations} | | |
| Base Period Employers | {Healthcare Practitioners and | 58% | 100% |
| <=2, Transition Account = | Technical Occupations; | | |
| No, Education = | Healthcare Support Occupations} | | |
| 12GRD | | | |
| Base Period Employers | {Healthcare Practitioners and | 56% | 100% |
| <=3, Years in SOC <=13, | Technical Occupations; | | |
| Past Accounts <=1 | Healthcare Support Occupations} | | |
| Base Period Employers | {Healthcare Practitioners and | 56% | 100% |
| <=3, Transition Account = | Technical Occupations; | | |
| No | Healthcare Support Occupations} | | |
| Past Accounts <=1, | {Healthcare Practitioners and | 55% | 100% |
| Gender = Female, Race = | Technical Occupations; | | |
| White | Healthcare Support Occupations} | | |
| Gender = Female, Race = | {Healthcare Practitioners and | 51% | 100% |
| White, Length of | Technical Occupations; | | |
| Employment <=3.3 | Healthcare Support Occupations} | | |
| Years | | | |
| Base Period Employers | {Healthcare Practitioners and | 45% | 100% |
| <=2, Race = White | Technical Occupations; | | |
| | Healthcare Support Occupations} | | |
| Past Accounts <=1, Race = | {Healthcare Practitioners and | 45% | 100% |
| White | Technical Occupations; | | |
| | Healthcare Support Occupations} | | |
| Base Period Employers | {Healthcare Practitioners and | 42% | 100% |
| <=2, Past Accounts <=1 | Technical Occupations; | | |
| | Healthcare Support Occupations} | | |
| Base Period Employers | {Healthcare Practitioners and | 41% | 100% |
| <=3, Race = White, | Technical Occupations; | | |
| Transition Account = No | Healthcare Support Occupations} | | |
| Base Period Employers | {Healthcare Practitioners and | 37% | 100% |
| <=2, Race = White, | Technical Occupations; | | |
| Education >= BCHL | Healthcare Support Occupations} | | |
| Base Period Employers | {Healthcare Practitioners and | 37% | 100% |
| <=2, Race = White, | Technical Occupations; | | |
| Education >= BCHL | Healthcare Support Occupations} | | |
| Base Period Employers | {Healthcare Practitioners and | 37% | 100% |
| <=2, Application Month | Technical Occupations; | | |
| in (May, Jun, Jul, Aug), | Healthcare Support Occupations} | | |
| Race = White | | | |
| Past Accounts <=1, Base | {Computer and Mathematical | 84% | 100% |
| Period Employers <=2, | Occupations; Life, Physical, and | | |
| Race = White | Social Science Occupations; | | |
| | Architecture and Engineering | | |
| | Occupations} | | |
| Base Period Employers | {Computer and Mathematical | 80% | 100% |
| <=2, Past Accounts <=1 | Occupations; Life, Physical, and | | |
| | Social Science Occupations; | | |
| | Architecture and Engineering | | |
| | Occupations} | | |
| Race = White, Base | {Computer and Mathematical | 68% | 100% |
| Period Employers <=2, | Occupations; Life, Physical, and | | |
| Gender = Female | Social Science Occupations; | | |
| | Architecture and Engineering | | |
| | Occupations} | | |
| Base Period Employers | {Computer and Mathematical | 62% | 100% |
| <=2, Race = White | Occupations; Life, Physical, and | | |
| | Social Science Occupations; | | |
| | Architecture and Engineering | | |
| | Occupations} | | |
| Race = White, Base | {Computer and Mathematical | 60% | 100% |
| Period Employers <=2, | Occupations; Life, Physical, and | | |
| Years in SOC <=12 | Social Science Occupations; | | |
| | Architecture and Engineering | | |
| | Occupations} | | |
| Base Period Employers | {Computer and Mathematical | 58% | 100% |
| <=2, Transition Account = | Occupations; Life, Physical, and | | |
| No, Education = | Social Science Occupations; | | |
| 12GRD | Architecture and Engineering | | |
| | Occupations} | | |
| Base Period Employers | {Computer and Mathematical | 56% | 100% |
| <=3, Years in SOC <=13, | Occupations; Life, Physical, and | | |
| Past Accounts <=1 | Social Science Occupations; | | |
| | Architecture and Engineering | | |
| | Occupations} | | |
| Base Period Employers | {Computer and Mathematical | 56% | 100% |
| <=3, Transition Account = | Occupations; Life, Physical, and | | |
| No | Social Science Occupations; | | |
| | Architecture and Engineering | | |
| | Occupations} | | |
| Gender = Female, Race = | {Computer and Mathematical | 51% | 100% |
| White, Length of | Occupations; Life, Physical, and | | |
| Employment <=3.3 | Social Science Occupations; | | |
| Years | Architecture and Engineering | | |
| | Occupations} | | |
| Base Period Employers | {Computer and Mathematical | 45% | 100% |
| <=2, Race = White | Occupations; Life, Physical, and | | |
| | Social Science Occupations; | | |
| | Architecture and Engineering | | |
| | Occupations} | | |
| Past Accounts <=1, Race = | {Computer and Mathematical | 45% | 100% |
| White | Occupations; Life, Physical, and | | |
| | Social Science Occupations; | | |
| | Architecture and Engineering | | |
| | Occupations} | | |
| Base Period Employers | {Computer and Mathematical | 42% | 100% |
| <=2, Past Accounts <=1 | Occupations; Life, Physical, and | | |
| | Social Science Occupations; | | |
| | Architecture and Engineering | | |
| | Occupations} | | |
| Base Period Employers | {Computer and Mathematical | 41% | 100% |
| <=3, Race = White, | Occupations; Life, Physical, and | | |
| Transition Account = No | Social Science Occupations; | | |
| | Architecture and Engineering | | |
| | Occupations} | | |
| Base Period Employers | {Computer and Mathematical | 37% | 100% |
| <=2, Application Month | Occupations; Life, Physical, and | | |
| in (May, Jun, Jul, Aug), | Social Science Occupations; | | |
| Race = White | Architecture and Engineering | | |
| | Occupations} | | |
| Past Accounts <=1, Base | {Farming, Fishing, and Forestry | 76% | 100% |
| Period Employers <=2, | Occupations; Building and | | |
| Race = White | Grounds Cleaning and | | |
| | Maintenance Occupations; NA} | | |
| Base Period Employers | {Farming, Fishing, and Forestry | 68% | 100% |
| <=3, Past Accounts <=1 | Occupations; Building and | | |
| | Grounds Cleaning and | | |
| | Maintenance Occupations; NA} | | |
| Race = White, Base | {Farming, Fishing, and Forestry | 66% | 100% |
| Period Employers <=2, | Occupations; Building and | | |
| Years in SOC <=12 | Grounds Cleaning and | | |
| | Maintenance Occupations; NA} | | |
| Base Period Employers | {Farming, Fishing, and Forestry | 58% | 100% |
| <=2, Race = White | Occupations; Building and | | |
| | Grounds Cleaning and | | |
| | Maintenance Occupations; NA} | | |
| Race = White, Base | {Farming, Fishing, and Forestry | 57% | 100% |
| Period Employers <=2, | Occupations; Building and | | |
| Gender = Female | Grounds Cleaning and | | |
| | Maintenance Occupations; NA} | | |
| Base Period Employers | {Farming, Fishing, and Forestry | 47% | 100% |
| <=3, Years in SOC <=13, | Occupations; Building and | | |
| Past Accounts <=1 | Grounds Cleaning and | | |
| | Maintenance Occupations; NA} | | |
| Base Period Employers | {Farming, Fishing, and Forestry | 47% | 100% |
| <=3, Transition Account = | Occupations; Building and | | |
| No | Grounds Cleaning and | | |
| | Maintenance Occupations; NA} | | |
| Base Period Employers | {Farming, Fishing, and Forestry | 47% | 100% |
| <=2, Application Month | Occupations; Building and | | |
| in (May, Jun, Jul, Aug), | Grounds Cleaning and | | |
| Race = White | Maintenance Occupations; NA} | | |
| Race = White, | {Farming, Fishing, and Forestry | 30% | 100% |
| Education >= BCHL | Occupations; Building and | | |
| | Grounds Cleaning and | | |
| | Maintenance Occupations; NA} | | |
| Base Period Employers | {Farming, Fishing, and Forestry | 24% | 100% |
| <=3, Years in SOC <=4 | Occupations; Building and | | |
| | Grounds Cleaning and | | |
| | Maintenance Occupations; NA} | | |
| Past Accounts <=1, Base | {Food Preparation and Serving | 82% | 100% |
| Period Employers <=2, | Related Occupations; Sales and | | |
| Race = White | Related Occupations} | | |
| Race = White, Base | {Food Preparation and Serving | 69% | 100% |
| Period Employers <=2, | Related Occupations; Sales and | | |
| Gender = Female | Related Occupations} | | |
| Race = White, Base | {Food Preparation and Serving | 66% | 100% |
| Period Employers <=2, | Related Occupations; Sales and | | |
| Years in SOC <=12 | Related Occupations} | | |
| Base Period Employers | {Food Preparation and Serving | 63% | 100% |
| <=2, Race = White | Related Occupations; Sales and | | |
| | Related Occupations} | | |
| Base Period Employers | {Food Preparation and Serving | 57% | 100% |
| <=3, Years in SOC <=13, | Related Occupations; Sales and | | |
| Past Accounts <=1 | Related Occupations} | | |
| Base Period Employers | {Food Preparation and Serving | 57% | 100% |
| <=3, Transition Account = | Related Occupations; Sales and | | |
| No | Related Occupations} | | |
| Race = White, Base | {Food Preparation and Serving | 45% | 100% |
| Period Employers <=2, | Related Occupations; Sales and | | |
| Years in SOC <=12 | Related Occupations} | | |
| Base Period Employers | {Food Preparation and Serving | 42% | 100% |
| <=2, Application Month | Related Occupations; Sales and | | |
| in (May, Jun, Jul, Aug), | Related Occupations} | | |
| Race = White | | | |
| Base Period Employers | {Food Preparation and Serving | 34% | 100% |
| <=2, Transition Account = | Related Occupations; Sales and | | |
| No, Education = | Related Occupations} | | |
| 12GRD | | | |
| Gender = Female, Race = | {Food Preparation and Serving | 33% | 100% |
| White, Length of | Related Occupations; Sales and | | |
| Employment <=3.3 | Related Occupations} | | |
| Years | | | |
| Base Period Employers | {Food Preparation and Serving | 31% | 100% |
| <=2, Past Accounts <=1 | Related Occupations; Sales and | | |
| | Related Occupations} | | |
| Base Period Employers | {Food Preparation and Serving | 31% | 100% |
| <=2, Race = White | Related Occupations; Sales and | | |
| | Related Occupations} | | |
| Past Accounts <=1, Race = | {Food Preparation and Serving | 31% | 100% |
| White | Related Occupations; Sales and | | |
| | Related Occupations} | | |
| Base Period Employers | {Food Preparation and Serving | 29% | 100% |
| <=3, Race = White, | Related Occupations; Sales and | | |
| Transition Account = No | Related Occupations} | | |
| Race = White, | {Food Preparation and Serving | 27% | 100% |
| Education >= BCHL | Related Occupations; Sales and | | |
| | Related Occupations} | | |
| Past Accounts <=1, Base | {Management Occupations; Legal | 85% | 100% |
| Period Employers <=2, | Occupations; Business and | | |
| Race = White | Financial Operations | | |
| | Occupations; Office and | | |
| | Administrative Support | | |
| | Occupations} | | |
| Race = White, Base | {Management Occupations; Legal | 75% | 100% |
| Period Employers <=2, | Occupations; Business and | | |
| Gender = Female | Financial Operations | | |
| | Occupations; Office and | | |
| | Administrative Support | | |
| | Occupations} | | |
| Race = White, Base | {Management Occupations; Legal | 75% | 100% |
| Period Employers <=2, | Occupations; Business and | | |
| Years in SOC <=12 | Financial Operations | | |
| | Occupations; Office and | | |
| | Administrative Support | | |
| | Occupations} | | |
| Base Period Employers | {Management Occupations; Legal | 73% | 100% |
| <=2, Race = White | Occupations; Business and | | |
| | Financial Operations | | |
| | Occupations; Office and | | |
| | Administrative Support | | |
| | Occupations} | | |
| Base Period Employers | {Management Occupations; Legal | 68% | 100% |
| <=3, Years in SOC <=13, | Occupations; Business and | | |
| Past Accounts <=1 | Financial Operations | | |
| | Occupations; Office and | | |
| | Administrative Support | | |
| | Occupations} | | |
| Base Period Employers | {Management Occupations; Legal | 68% | 100% |
| <=3, Transition Account = | Occupations; Business and | | |
| No | Financial Operations | | |
| | Occupations; Office and | | |
| | Administrative Support | | |
| | Occupations} | | |
| Base Period Employers | {Management Occupations; Legal | 57% | 100% |
| <=2, Race = White | Occupations; Business and | | |
| | Financial Operations | | |
| | Occupations; Office and | | |
| | Administrative Support | | |
| | Occupations} | | |
| Base Period Employers | {Management Occupations; Legal | 51% | 100% |
| <=2, Transition Account = | Occupations; Business and | | |
| No, Education = | Financial Operations | | |
| 12GRD | Occupations; Office and | | |
| | Administrative Support | | |
| | Occupations} | | |
| Gender = Female, Race = | {Management Occupations; Legal | 50% | 100% |
| White, Length of | Occupations; Business and | | |
| Employment <=3.3 | Financial Operations | | |
| Years | Occupations; Office and | | |
| | Administrative Support | | |
| | Occupations} | | |
| Base Period Employers | {Management Occupations; Legal | 37% | 100% |
| <=2, Race = White | Occupations; Business and | | |
| | Financial Operations | | |
| | Occupations; Office and | | |
| | Administrative Support | | |
| | Occupations} | | |
| Past Accounts <=1, Race = | {Management Occupations; Legal | 37% | 100% |
| White | Occupations; Business and | | |
| | Financial Operations | | |
| | Occupations; Office and | | |
| | Administrative Support | | |
| | Occupations} | | |
| Base Period Employers | {Management Occupations; Legal | 36% | 100% |
| <=2, Past Accounts <=1 | Occupations; Business and | | |
| | Financial Operations | | |
| | Occupations; Office and | | |
| | Administrative Support | | |
| | Occupations} | | |
| Base Period Employers | {Management Occupations; Legal | 33% | 100% |
| <=3, Race = White, | Occupations; Business and | | |
| Transition Account = No | Financial Operations | | |
| | Occupations; Office and | | |
| | Administrative Support | | |
| | Occupations} | | |
| Race = White, Years in | {Management Occupations; Legal | 30% | 100% |
| SOC <=12, Gender = | Occupations; Business and | | |
| Female | Financial Operations | | |
| | Occupations; Office and | | |
| | Administrative Support | | |
| | Occupations} | | |
| Base Period Employers | {Management Occupations; Legal | 29% | 100% |
| <=2, Race = White, | Occupations; Business and | | |
| Education >= BCHL | Financial Operations | | |
| | Occupations; Office and | | |
| | Administrative Support | | |
| | Occupations} | | |
| Base Period Employers | {Management Occupations; Legal | 29% | 100% |
| <=2, Application Month | Occupations; Business and | | |
| in (May, Jun, Jul, Aug), | Financial Operations | | |
| Race = White | Occupations; Office and | | |
| | Administrative Support | | |
| | Occupations} | | |
| Base Period Employers | {Management Occupations; Legal | 27% | 100% |
| <=2, Gender = Female, | Occupations; Business and | | |
| Race = White | Financial Operations | | |
| | Occupations; Office and | | |
| | Administrative Support | | |
| | Occupations} | | |
| Past Accounts <=1, | {Management Occupations; Legal | 27% | 100% |
| Gender = Female, Race = | Occupations; Business and | | |
| White | Financial Operations | | |
| | Occupations; Office and | | |
| | Administrative Support | | |
| | Occupations} | | |

Table 34 below lists the final set of “anomalous” rules produced:

TABLE 34

| LHS | RHS | Support | Confidence |
|---|---|---|---|
| Transition Account = Yes, | {Healthcare Practitioners | 2.8% | 100% |
| Age in[28, 40] | and Technical Occupations; | | |
| | Healthcare Support | | |
| | Occupations} | | |
| Age in[28, 40], Education 1 | {Healthcare Practitioners | 9.8% | 100% |
| to 2 Years College | and Technical Occupations; | | |
| | Healthcare Support | | |
| | Occupations} | | |
| Application Submission | {Protective Service | 10.9% | 100% |
| Month = Jan, Seasonal | Occupations; Construction | | |
| Worker = Yes | and Extraction Occupations; | | |
| | Installation, Maintenance, | | |
| | and Repair Occupations; | | |
| | Transportation and Material | | |
| | Moving Occupations} | | |
| Union Member = Yes, | {Protective Service | 7.3% | 100% |
| Seasonal Worker = Yes, | Occupations; Construction | | |
| Education = High School Grad | and Extraction Occupations; | | |
| | Installation, Maintenance, | | |
| | and Repair Occupations; | | |
| | Transportation and Material | | |
| | Moving Occupations} | | |
| Age in[28, 40], Education 1 | {Protective Service | 9.9% | 100% |
| to 2 Years College | Occupations; Construction | | |
| | and Extraction Occupations; | | |
| | Installation, Maintenance, | | |
| | and Repair Occupations; | | |
| | Transportation and Material | | |
| | Moving Occupations} | | |
| Age in[41, 54], Seasonal | {Protective Service | 13.6% | 100% |
| Worker = Yes | Occupations; Construction | | |
| | and Extraction Occupations; | | |
| | Installation, Maintenance, | | |
| | and Repair Occupations; | | |
| | Transportation and Material | | |
| | Moving Occupations} | | |
| Application Submission | {Protective Service | 5.1% | 100% |
| Month = Jan, Transition | Occupations; Construction | | |
| Account = Yes, Education = | and Extraction Occupations; | | |
| High School Grad | Installation, Maintenance, | | |
| | and Repair Occupations; | | |
| | Transportation and Material | | |
| | Moving Occupations} | | |
| Application Submission | {Personal Care and Service | 4.3% | 100% |
| Month = Jun, Education = | Occupations; Community | | |
| Masters | and Social Service | | |
| | Occupations; Education, | | |
| | Training, and Library | | |
| | Occupations} | | |
| Education in (High School | {Personal Care and Service | 10.5% | 100% |
| Grad or 1 to 2 Years College, | Occupations; Community | | |
| Age in[30, 42] | and Social Service | | |
| | Occupations; Education, | | |
| | Training, and Library | | |
| | Occupations} | | |
| Application Submission | {Personal Care and Service | 3.4% | 100% |
| Month = Jun, Transition | Occupations; Community | | |
| Account = Yes | and Social Service | | |
| | Occupations; Education, | | |
| | Training, and Library | | |
| | Occupations} | | |
| Age in[41, 54], Seasonal | {Personal Care and Service | 5.9% | 100% |
| Worker = Yes | Occupations; Community | | |
| | and Social Service | | |
| | Occupations; Education, | | |
| | Training, and Library | | |
| | Occupations} | | |
| Age in[41, 54], Seasonal | {Food Preparation and | 3.9% | 100% |
| Worker = Yes | Serving Related | | |
| | Occupations; Sales and | | |
| | Related Occupations} | | |
| Age in[28, 41], Transition | {Food Preparation and | 3.5% | 100% |
| Account = Yes | Serving Related | | |
| | Occupations; Sales and | | |
| | Related Occupations} | | |
| Age in[28, 41], Education 1 | {Food Preparation and | 4.3% | 100% |
| Year College | Serving Related | | |
| | Occupations; Sales and | | |
| | Related Occupations} | | |
| Application Submission | {Food Preparation and | 3.2% | 100% |
| Month = Mar, Education = | Serving Related | | |
| High School Grad | Occupations; Sales and | | |
| | Related Occupations} | | |
| Transition Account = Yes, | {Arts, Design, | 0.8% | 100% |
| Education = High School Grad, | Entertainment, Sports, and | | |
| Age <27 | Media Occupations; | | |
| | Production Occupations} | | |
| Application Submission | {Arts, Design, | 1.2% | 100% |
| Month = Jan, Transition | Entertainment, Sports, and | | |
| Account = Yes, Education = | Media Occupations; | | |
| High School Grad | Production Occupations} | | |
| Transition Account = Yes, | {Arts, Design, | 0.9% | 100% |
| Union Member = Yes | Entertainment, Sports, and | | |
| | Media Occupations; | | |
| | Production Occupations} | | |
| Application Submission | {Management Occupations; | 0.6% | 100% |
| Month in(Sep, Oct), Seasonal | Legal Occupations; | | |
| Worker = Yes | Business and Financial | | |
| | Operations Occupations; | | |
| | Office and Administrative | | |
| | Support Occupations} | | |
| Seasonal Worker = Yes, | {Management Occupations; | 0.5% | 100% |
| Education = High School Grad, | Legal Occupations; | | |
| Age <=52 | Business and Financial | | |
| | Operations Occupations; | | |
| | Office and Administrative | | |
| | Support Occupations} | | |
| Military Veteran = Yes, | {Computer and | 1.6% | 100% |
| Application Submission Month | Mathematical Occupations; | | |
| in (Dec, Aug) | Life, Physical, and Social | | |
| | Science Occupations; | | |
| | Architecture and | | |
| | Engineering Occupations} | | |
| Military Veteran = Yes, | {Computer and | 1.3% | 100% |
| Education = High School Grad | Mathematical Occupations; | | |
| | Life, Physical, and Social | | |
| | Science Occupations; | | |
| | Architecture and | | |
| | Engineering Occupations} | | |
| Age in[28, 40], Education 1 | {Computer and | 5.3% | 100% |
| to 2 Years College | Mathematical Occupations; | | |
| | Life, Physical, and Social | | |
| | Science Occupations; | | |
| | Architecture and | | |
| | Engineering Occupations} | | |
| Application Submission | {Farming, Fishing, and | 1.5% | 100% |
| Month = Mar, Seasonal | Forestry Occupations; | | |
| Worker = Yes | Building and Grounds | | |
| | Cleaning and Maintenance | | |
| | Occupations; NA} | | |
| Age in[28, 40], Education = | {Farming, Fishing, and | 3.6% | 100% |
| High School Grad | Forestry Occupations; | | |
| | Building and Grounds | | |
| | Cleaning and Maintenance | | |
| | Occupations; NA} | | |
| Age in[28, 40], Education 1 | {Farming, Fishing, and | 6.8% | 100% |
| to 2 Years College | Forestry Occupations; | | |
| | Building and Grounds | | |
| | Cleaning and Maintenance | | |
| | Occupations; NA} | | |
| Age in[41, 54], Seasonal | {Farming, Fishing, and | 7.7% | 100% |
| Worker = Yes | Forestry Occupations; | | |
| | Building and Grounds | | |
| | Cleaning and Maintenance | | |
| | Occupations; NA} | | |

Scoring of UI Claims Using. Generated UI Association Rules:

Scoring of UI claims would proceed in similar fashion as described above for scoring Auto BI claims. To lessen the burden on the reader, that material will not be repeated herein, to avoid redundancy.

### III. Recalibration of Inventive Models

It should be appreciated that the inventive models described herein can be periodically re-calibrated so that rules/insights/indicators/patterns/predictive variables/etc. gleaned from previous applications of the unsupervised analytical methods (including the results of associated SIU investigations) can be fed back as inputs to inform/improve/tweak the fraud detection process.

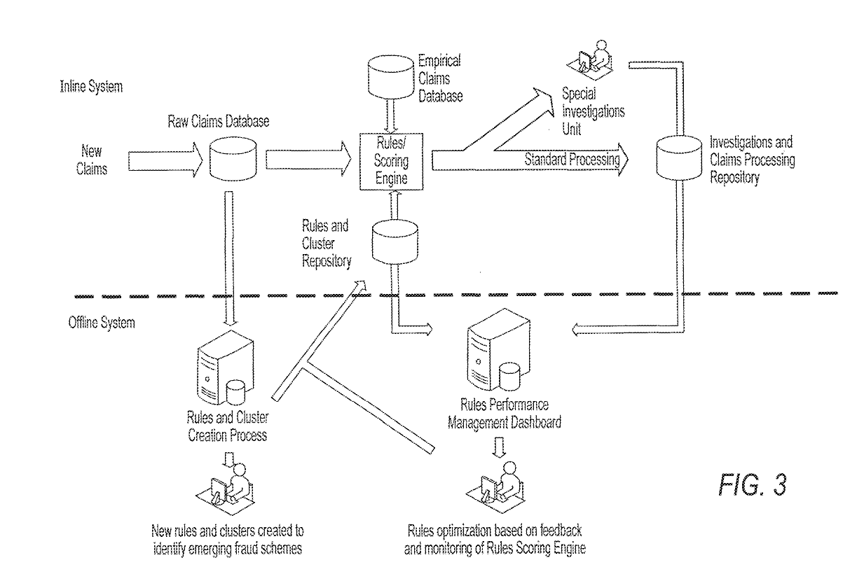

Indeed, periodically, the clusters and rules should be recalibrated and/or new clusters and rules created in order to identify emerging fraud and ensure that the rules scoring engine remains efficient and accurate. Fraud perpetrators often invent new and innovative schemes as their earlier methods become known and recognized by authorities. The inventive unsupervised analytical methods are uniquely postured to capture patterns that may indicate fraud, without knowing what the precise scheme is. An exemplary system for accomplishing this recalibration task is depicted, for example, in FIG. 3. As new claims enter the system, they may be processed according to the current cluster and rules sets. However, those claims are also gathered for new rules and cluster creation aimed at detecting anomalous patterns that are likely to be new fraud schemes. Today's new claims become tomorrow's training set, or augmentation and enhancement of the existing training set.

In addition, a current scoring engine may be monitored with feedback from the SIU and standard claims processing to determine which rules and clusters are detecting fraud most efficiently. This efficiency can be measured in two ways. First, the scoring engine should find a high level of known fraud schemes and previously undetected schemes. Second, the incidence of actual fraud found in claims sent for further investigation should be at least as high, if not higher, than historical rates of fraud detected. The first condition ensures that fraud does not go undetected, and the second condition ensures that the rate of false positives is minimized. Association rules generating many false positives can be modified or eliminated, and new clusters can be created to better identify known fraud patterns. In this way, the scoring engine can be constantly monitored and optimized to create an efficient scoring process.

An example of this type of update for an auto BI claims rule might occur if a rule stating that when the respective accident and claimant addresses are within 2 miles of one another, an attorney is hired within 21 days of the accident, the primary insured's vehicle is less than six years old and the claimant had only a single part damaged, then the claim is likely to be fraudulent. However, upon investigation it may be discovered that when the attorney is hired beyond 45 days after the accident, with the remainder of the rule unchanged, there is a greater likelihood of fraud. In such case, the rule can be adjusted to produce better results. As noted, rules and clustering should be updated periodically to capture potentially fraudulent claims as fraudsters continue to create new as yet undiscovered schemes.

It will be appreciated that, with the inventive embodiments, insights/indicators surface automatically from the unsupervised analytical methods. While plenty of “red flags” that are tribal wisdom or common knowledge also surface, the inventive embodiments can also turn out insights/indicators that are more in-depth or dive deeper and with greater complexity and/or are counterintuitive.

By way of example, the clustering process generates clusters of claims with a high number of known red flags combined with other information not previously known. It is known, for example, that when attorneys show up late in the process, or, for example, the claim is just under threshold values, the claim is often fraudulent. As expected, these indexes fall into clusters of claims with high fraud rates. However, the clustering process also finds that these suspicious claims are separated into two groups, with some claims ending up in one cluster and the remaining claims in another cluster, once other variables are considered beyond attorney involvement. In auto BI, for example, when multiple parts of the vehicle are damaged, these claims end up in a different cluster. The additional information spotlights claims that have a higher likelihood of fraud than claims with the original known red flags but not the added information.

Further, suppose when claims are clustered one of the clusters turns out to have many red flags (e.g., attorney shows up late in the process, smaller claim to avoid notice, etc.). Although the claims adjusters may know that some of these things are bad signals, the inventive approach would identify claims with these traits that were not sent to the SIU. The unsupervised analytics would identify that which was supposedly “already known” but not being followed everywhere.

The association rules analysis “finds” associations that make intuitive sense (e.g., side swipe collisions and neck injuries). Although the experienced investigator may know this rule, the unsupervised analytics turns out these other types of rules as well, including ones that were not previously known. Advantageously, the expert does not need to know all the rules beforehand. By way of an example, suppose that:
Rear end=>Neck Injury 95% of the time
Front end=>Neck Injury 75% of the time
Head injury=>Neck injury 90% of the time
   The association rules algorithm would find these rules and flag claims with neck injuries where there is no head injury, front end damage or rear end damage. These are abnormal and indicative of fraud. If properly implemented, the inventive techniques can far surpass the collective knowledge of even the most seasoned, cynical and detailed team of adjusters or fraud investigators.

### IV. Exemplary Systems

It should be understood that the modules, processes, systems, and features described hereinabove can be implemented in hardware, hardware programmed by software, software instructions stored on a non-transitory computer readable medium or a combination of the above. Embodiments of the present invention can be implemented, for example, using a processor configured to execute a sequence of programmed instructions stored on a non-transitory computer readable medium. The processor can include, without limitation, a personal computer or workstation or other such computing system or device that includes a processor, microprocessor, microcontroller device, or is comprised of control logic including integrated circuits such as, for example, an Application Specific Integrated Circuit (ASIC). The instructions can be compiled from source code instructions provided in accordance with a suitable programming language. The instructions can also comprise code and data objects provided in accordance with a suitable structured or object-oriented programming language. The sequence of programmed instructions and data associated therewith can be stored in a non-transitory computer-readable medium such as a computer memory or storage device, which may be any suitable memory apparatus, such as, but not limited to ROM, PROM, EEPROM, RAM, flash memory, disk drive and the like.

Furthermore, the modules, processes, systems, and features can be implemented as a single processor or as a distributed processor. Further, it should be appreciated that the process steps described herein may be performed on a single or distributed processor (single and/or multicore). Also, the processes, system components, modules, and sub-modules for the inventive embodiments may be distributed across multiple computers or systems or may be co-located in a single processor or system.

The modules, processors or systems can be implemented as a programmed general purpose computer, an electronic device programmed with microcode, a hard-wired analog logic circuit, software stored on a computer-readable medium or signal, an optical computing device, a networked system of electronic and/or optical devices, a special purpose computing device, an integrated circuit device, a semiconductor chip, and a software module or object stored on a computer-readable medium or signal, for example. Indeed, the inventive embodiments may be implemented on a general-purpose computer, a special-purpose computer, a programmed microprocessor or microcontroller and peripheral integrated circuit element, an ASIC or other integrated circuit, a digital signal processor, a hardwired electronic or logic circuit such as a discrete element circuit, a programmed logic circuit such as a PLD, PLA, FPGA, PAL, or the like. In general, any processor capable of implementing the functions or steps described herein can be used to implement embodiments of the method, system, or a computer program product (software program stored on a non-transitory computer readable medium).

Additionally, in some exemplary embodiments, distributed processing can be used to implement some or all of the disclosed methods, where multiple processors, clusters of processors, or the like are used to perform portions of various disclosed methods in concert, sharing data, intermediate results and output as may be appropriate.

Furthermore, embodiments of the disclosed method, system, and computer program product may be readily implemented, fully or partially, in software using, for example, object or object-oriented software development environments that provide portable source code that can be used on a variety of computer platforms. Alternatively, embodiments of the disclosed method, system, and computer program product can be implemented partially or fully in hardware using, for example, standard logic circuits or a VLSI design. Other hardware or software can be used to implement embodiments depending on the speed and/or efficiency requirements of the systems, the particular function, and/or particular software or hardware system, microprocessor, or microcomputer being utilized. Embodiments of the method, system, and computer program product can be implemented in hardware and/or software using any known or later developed systems or structures, devices and/or software by those of ordinary skill in the applicable art from the description provided herein and with a general basic knowledge of the user interface and/or computer programming arts. Moreover, any suitable communications media and technologies can be leveraged by the inventive embodiments.

It will thus be seen that the objects set forth above, among those made apparent from the preceding description, are efficiently attained, and since certain changes may be made in the above constructions and processes without departing from the spirit and scope of the invention, it is intended that all matter contained in the above description or shown in the accompanying drawings shall be interpreted as illustrative and not in a limiting sense.

### APPENDICES

Appendix A—Exemplary Algorithm To Create Clusters Used To Evaluate New Claims
Appendix B—Exemplary Algorithm To Score Claims Using Clusters
Appendix C—Glossary of Variables Used In UI Clustering
Appendix D—Exemplary Variable List For Auto BI Association Rule Creation
Appendix E—Exemplary Algorithm To Find The Set Of Association Rules Generated To Evaluate New Claims
Appendix F—Exemplary Algorithm To Score Claims Using Association Rules

### Appendix A

### Exemplary Algorithm to Create Clusters Used to Evaluate New claims

1) Let V={all variables in consideration for cluster formation}
2) Calculate RIDIT Transform (Brockett):
   1. Let N=Total number of claims
   2. For each vᵢεvεV calculate the percentile pᵢΣ_{j=1;v}_{ⱼ}_{≦v}_{ⱼ}ⁱ[nⱼ/N]; i=1, 2, . . . N
   3. For each vᵢεvεV calculate the cumulative percentile qᵢ=Σ_{j=1;v}_{ⱼ}_{≦v}_{ᵢ}pᵢⁱ; i=1, 2, . . . N
   4. For all vᵢεvεV calculate rᵢ=[(vᵢ+2qᵢ)/Σᵢ₌₁^{N}vᵢ]−1; i=1, 2, . . . N
   5. Store q₁ as the Empirical Historical Quantile
3) Perform Bagged Clustering (Leisch):
   1. Construct β bootstrap training samples R_{N}¹, . . . , R_{N}^{β} of size N by drawing with replacement from the original sample of N RIDIT transformed claims
   2. Run K-means on each set R and store each center k₁₁, k₁₂, . . . , k_{1K}, . . . , k_{βK}
   3. Combine all centers into a new data set K={k₁₁, k₁₂, . . . , k_{1K}, . . . , k_{βK}}
   4. Run a hierarchical cluster algorithm on K and output the resulting dendrogram and set of hierarchical cluster centers H_{K}
   5. Partition the dendrogram at level n and assign each rₖⁱ to the cluster for which rₖⁱ is closest to the cluster center hεHₙ, as measured by the Euclidean distance.
4) For each cluster in hεHₙ calculate S(h) the SIU referral rate and F(S(h)) the fraud rate for SIU referred claims
5) Order clusters in hεHₙ from lowest rate of fraud to highest rate of fraud
6) For all hεHₙ create “reason codes” for each claim, ranking the variables for each claim i and variable v: γ_{i,v}
   a. For each of the n clusters and each of the variables v used in the clustering, calculate the contribution for each variable to the cluster definition δ_{h,v}=\sqrt{hᵥ−μᵥ/σᵥ} where hᵥ is the value of variable v for centroid h, νᵥ is the global mean for variable v and σᵥ is the global standard deviation for variable v.
   b. The reason codes γ_{i,v} correspond to the name of the variable associated with vεV. The reasons are ordered by the distance (δ_{h,v}) descending for each cluster h.
7) If F(S(h₁))<<F(S(hₙ)) and each hᵢ has distinct reason messages then output the clusters as final, otherwise repeat steps 1-5 using an alternate set V

### Appendix B

### Exemplary Algorithm to Score Claims Using Clusters

1) Let V={all variables needed for cluster evaluation}
2), Calculate RIDIT Transform (Brockett):
   1. Let N=Total number of claims
   2. For all vᵢεvεV calculate rᵢ=[(vᵢ+2qᵢ)/Σᵢ₌₁^{N}vᵢ]−1; i=1, 2, . . . , N qᵢ=Largest Empirical Historical Quantile such that vᵢ≦qᵢ
3) Let C be the set of claims to evaluate
4) For each cᵢεC
   1. Let m be the number of variables used to define the clustering.
   2. For each vεV and each claim cᵢ and each cluster center hεHₙ calculate d(h, v)=\sqrt{Σᵢ₌₁^{N}(hᵢ−vᵢ)²} the distance of each variable vεV to each

Cluster Center h;
3. Calculate the total distance for claim cᵢ to center h as Σⱼ₌₁^{m}dⱼ
4. Assign claim cᵢ to the cluster hεHₙ which satisfies argminₕ{Dₕ} the cluster whose total distance is closest to cᵢ
5. If the assigned cluster is designated for SIU referral then refer claim cᵢ to SIU and send the associated reason codes, otherwise allow the claim to follow normal claims processing

APPENDIX C

| All Variables | Variable group | Description | Comments |
|---|---|---|---|
| appl_num | ID | Unique Identifier for Applicant | |
| ACCT_ID | ID | Indicates the year and sequence: 201002 is the second account filed during the year 2010 | |
| NUM_PAST_ACCT_PRIOR_2009 | Account History | Number of Previous Accounts prior 2009 | |
| NUM_PAST_ACCT_AFTER_2009 | Account History | Number of Previous Accounts after 2010 | |
| TOTAL_NUM_PAST_ACCT | Account History | Total Number of previous accounts | |
| APPROX_AGE | Applicant demo | Age | |
| ALIEN_AUTH_DOC_TP | Text field | Alien authorization card type | |
| ALIEN_AUTH_DOC_ID | Text field | Alien authorization document number | |
| LEN_OF_EMPL | Employment History | Length of employment (in days) | |
| SOC | Text field | Occupational code indicated by applicant | |
| SOC_YEARS | Employment History | Year of experience for the given SOC occupation code | |
| LAST_EMPR_NAICS_CD | Text field | NAICS code of most recent employer | |
| BP_EMPLRS | Text field | Count of base period employers | |
| MN_UNION_CD | Text field | Actual union the applicant indicates they belong to | |
| ISSUE_STATE_CD | Text field | MV License is optional; state is listed if applicant provided MV License number at application | |
| APPLICATION_LAG | Application info | Measurement of time from initiation of application to submission of application | |
| WRKFRCE_CNTR_CD | Text field | Code of the workforce center | |
| ZIP_5 | Text field | First five digits of zip code of mail address | |
| COUNTY_CD | Text field | County of mail address | |
| COMMUNITY_CD | Text field | Community Code for mail address | |
| ADDR_MDFCTN_ELAPSED_DATES | Text field | #N/A | Not used in cluster model |
| MAX_ELIG_WBA_AMT | Payment Info | Max eligible weekly benefit amount | |
| MBA_ELIG_AMT_LIFE | Payment Info | Max lifetime eligible benefit amout | |
| NO_OF_ACCTS_WITH_OP_AMT | Payment Info | Num of past accounts (applications) with overpayment | |
| TOT_AMT_PAID_PREV_ACCTS | Account History | Total benefit amount paid in all previous accounts | |
| num_wks_paid | Payment Info | Number of weeks paid for each application | |
| max_wba_paid | Payment Info | Maximum weekly benefit amount paid for each application | |
| min_wba_paid | Payment Info | Minimum weekly benefit amount paid for each application | |
| avg_wba_paid | Payment Info | Average weekly benefit amount paid for each application | |
| max_wk_hrs_wrkd | Application info | Maximum weekly hours worked (self reported) | |
| min_wk_hrs_wrkd | Application info | Minimum weekly hours worked (self reported) | |
| avg_wk_hrs_wrkd | Application info | Average weekly hours worked (self reported) | |
| max_shrd_work_hrs | Application info | Maximum weekly shared work hours (self reported) | |
| min_shrd_work_hrs | Application info | Minimum weekly shared work hours (self reported) | |
| avg_shrd_work_hrs | Application info | Average weekly shared work hours (self reported) | |
| sum_op_amt | Payment Info | Total overpayment amount per application | |
| CTZN_IND | Applicant demo | US Citizenship indicator (1 = Yes, 0 = No) | |
| EDUC_CD | Applicant demo - Education | Level of education | |
| ETHN_CD | Applicant demo - Race, Ethnicity | Ethnicity Code | |
| GENDER_CD | Applicant demo | Gender | |
| HANDICAP_IND | Applicant demo | Handicapped indicator (1 = Yes, 0 = No) | |
| MLT_VET_IND | Applicant demo | Military Veteran Indicator (1 = Yes, 0 = No) | |
| MN_STATE_IND | Applicant demo | MN State resident indicator (1 = Yes, 0 = No) | |
| NAICS_MAJOR_CD | Text field | NAICS Major code of most recent employer (only the first 2 digits for overall industry) | |
| RACE_CD | Applicant demo - Race, Ethnicity | Race Code | |
| SEASONAL_WORK_IND | Applicant demo | Seasonal worker indicator (1 = Yes, 0 = No) | |
| SOC_MAJOR_CD | Text field | Occupation SOC major code (only the first 2 digits for overall industry) | |
| TAX_WHLD_CD | Payment Info | Withholding preference; None, Federal, State, or Federal and State | |
| UNION_MEMBER_IND | Applicant demo | Union member indicator (1 = Yes, 0 = No) | |
| EDUC_CD_ASSC | Applicant demo - Education | Eductation level = associate degree (1 = y, 0 = n) | |
| EDUC_CD_BCHL | Applicant demo - Education | Eductation level = bachelors degree (1 = y, 0 = n) | |
| EDUC_CD_HS | Applicant demo - Education | Eductation level = High school degree (1 = y, 0 = n) | |
| EDUC_CD_MSTR_DCTR | Applicant demo - Education | Eductation level = Master or doctorate degree (1 = y, 0 = n) | |
| EDUC_CD_NOFED | Applicant demo - Education | Eductation level = No formal education (1 = y, 0 = n) | |
| EDUC_CD_SOMECOLLEGE | Applicant demo - Education | Eductation level = some college (1 = y, 0 = n) | |
| EDUC_CD_TILL_10GRD | Applicant demo - Education | Eductation level = 9th grage education (1 = y, 0 = n) | |
| ETHN_CNTA | Applicant demo - Race, Ethnicity | Ethnicity Code = Chose not to answer (1 = y, 0 = n) | |
| ETHN_HSPN | Applicant demo - Race, Ethnicity | Ethnicity Code = Hispanic (1 = y, 0 = n) | |
| ETHN_NHSP | Applicant demo - Race, Ethnicity | Ethnicity Code = Non-Hispanic (1 = y, 0 = n) | |
| GEND_FEMALE | Applicant demo | Gender is Felale (1 = y, 0 = n) | |
| GEND_MALE | Applicant demo | Gender is Male (1 = y, 0 = n) | |
| GEND_UNKNOWN | Applicant demo | Gender is Unknown (1 = y, 0 = n) | |
| HANDICAP_NO | Applicant demo | Applicant is NOT handicapped (1 = y, 0 = n) | |
| HANDICAP_UNKNOWN | Applicant demo | Applicant handicapped status is unkonwn (1 = y, 0 = n) | |
| HANDICAP_YES | Applicant demo | Applicant is handicapped (1 = y, 0 = n) | |
| NACIS_MINING | Employment History | Mining | |
| NAICS_ACCOM_FOOD | Employment History | Accommodation and Food Services | |
| NAICS_AGG_FISH_HUNT | Employment History | Agriculture, Forestry, Fishing and Hunting | |
| NAICS_ARTS_ENTMT | Employment History | Arts, Entertainment, and Recreation | |
| NAICS_CONSTRUCTION | Employment History | Construction | |
| NAICS_EDUCATION | Employment History | Educational Services | |
| NAICS_FSI | Employment History | Finance and Insurance | |
| NAICS_HEALTH_CARE | Employment History | Health Care and Social Assistance | |
| NAICS_INFORMATION | Employment History | Information | |
| NAICS_MGT | Employment History | Management of Companies and Enterprises | |
| NAICS_MNFG | Employment History | Manufacturing | |
| NAICS_NA | Employment History | Not Assigned | |
| NAICS_OTH | Employment History | Other Services (except Public Administration) | |
| NAICS_PROF_SCI_TECH_SRV | Employment History | Professional, Scientific, and Technical Services | |
| NAICS_PUBLIC_ADMIN | Employment History | Public Administration | |
| NAICS_REAL_STATE | Employment History | Real Estate Rental and Leasing | |
| NAICS_RETAIL_TRDE | Employment History | Retail Trade | |
| NAICS_TRANSP_WRHSE | Employment History | Transportation and Warehousing | |
| NAICS_UTIL | Employment History | Utilities | |
| NAICS_WASTE_MGMT | Employment History | Administrative and Support and Waste Management and Remediation Services | |
| NAICS_WHOLSALE_TRDE | Employment History | Wholesale Trade | |
| RACE_ANAI | Applicant demo - Race, Ethnicity | American Indian or Alaska Native | |
| RACE_ASIA | Applicant demo - Race, Ethnicity | Asian | |
| RACE_BLCK | Applicant demo - Race, Ethnicity | Black or African American | |
| RACE_CNTA | Applicant demo - Race, Ethnicity | Choose not to answer | |
| RACE_MTOR | Applicant demo - Race, Ethnicity | More than one race | |
| RACE_NHPI | Applicant demo - Race, Ethnicity | Native Hawaiian or other Pacific Islander | |
| RACE_WHIT | Applicant demo - Race, Ethnicity | White | |
| SOC_ARCH_ENG | Occupation | Architecture and Engineering Occupations | |
| SOC_ARTS_DESIGN_MEDIA | Occupation | Arts, Design, Entertainment, Sports, and Media Occupations | |
| SOC_BIZ_FIN_OPS | Occupation | Business and Financial Operations Occupations | |
| SOC_BLDG_CLEAN_MAINT | Occupation | Building and Grounds Cleaning and Maintenance Occupations | |
| SOC_COMNTY_SOC_WORK | Occupation | Community and Social Service Occupations | |
| SOC_COM_MTH | Occupation | Computer and Mathematical Occupations | |
| SOC_CONSTRUCTION | Occupation | Construction and Extraction Occupations | |
| SOC_EDU_TRN_LIBRY | Occupation | Education, Training, and Library Occupations | |
| SOC_FARM_FISH | Occupation | Farming, Fishing, and Forestry Occupations | |
| SOC_FOOD_SRV | Occupation | Food Preparation and Serving Related Occupations | |
| SOC_HCP | Occupation | Healthcare Practitioners and Technical Occupations | |
| SOC_HC_SUPPORT | Occupation | Healthcare Support Occupations | |
| SOC_INSTL_MAINT_REPR | Occupation | Installation, Maintenance, and Repair Occupations | |
| SOC_LEGAL | Occupation | Legal Occupations | |
| SOC_LIFE_PHYS_SOC | Occupation | Life, Physical, and Social Science Occupations | |
| SOC_MGMT | Occupation | Management Occupations | |
| SOC_NA | Occupation | Not Assigned | |
| SOC_OFFICE_ADMIN | Occupation | Office and Administrative Support Occupations | |
| SOC_PERSONAL_CARE | Occupation | Personal Care and Service Occupations | |
| SOC_PRODCTN | Occupation | Production Occupations | |
| SOC_PROTECTIVE_SRV | Occupation | Protective Service Occupations | |
| SOC_SALES | Occupation | Sales and Related Occupations | |
| SOC_TRANSP | Occupation | Transportation and Material Moving Occupations | |
| TAX_WHLD_CD_BOTH | Payment Info | Tax withheld for both State and Federal | |
| TAX_WHLD_CD_FDRL | Payment Info | Tax withheld for Federal | |
| TAX_WHLD_CD_NONE | Payment Info | No Tax withheld | |
| fraud_ind | Payment Info | Fraud flag (1 = y, 0 = n) | |
| BP_EMPL | Employment History | Number of Base Priod Employers | |

| Field Name | Data | Comment |
|---|---|---|
| APPL_NU | Applicant Number | Unique Identifier for Applicant |
| ACCT_ID | Account ID | Indicates the year and sequence: 201002 is the second account filed during the year 2010 |
| RQST_WK_DT | Request Week Date | Sunday of week for which benefits were requested |
| SRCE_CD | Source Code | Method of request: AWEB = Internet, IVR = Interactive Voice Response |
| OUT_SEQ_WK_IN | Indicates if the request was out of sequence | This element appears to be “N” for all requests |
| RPTD_EARN_IN | Reported earnings | Earnings reported by applicant at time of request for payment |
| AC_IN | Additional Claim indicator | Reported reduction in earnings (enough to define as a new occurrence on unemployment) |
| AC_SEP_DT | Additional Claim Separation Date | Separation date if the reduction earnings is a result of a separation |
| AC_SEP_RSN_CD | Additional Claim Separation Reason | Separation reason if the reduction earnings is a result of a separation |
| RET_TO_WORK_DT | Return to Work Date | Date applicant entered as anticipated return to work |
| HR_WRKD_NU | Hour Worked number | Number of hours worked reported by applicant at time of request for payment |
| SHRD_WORK_HRS | Shared Work Hours | Number of hours worked reported by applicant who is on Shared Work program |
| AUTH_SEQ_NU | Authentication sequence number | Payment sequence (usually 1, unless the applicant recieves an underpayment, then greater than 1) |
| PMT_TYPE_CD | Payment Type Code | REGL = regular payment; UPMT = underpayment when additional payment is issued for week |
| WBA_AM | Weekly Benefit Amount | Weekly benefit amount |
| AUTH_AM | Authorized Amount | Amount of benefits authorized for week |
| SumOfEARN_AM | Sum of Earnings | Sum of earnings reported by applicant at time of request for payment |
| DAYS_DENIED_NU | Number of Days Denied | Number of days benefits are denied as result of overpayment determination |
| ELIG_DED_AM | Eligibility Deduction Amount | Amount deducted from payment due to a non-earnings deduction (Separation Pay, 1-Day Denial, etc.) |
| AUTH_DT | Authorization Date | Date that payment of benefits was authorized for week of request |
| AUTH_PMT_STATUS_CD | Authorized Payment Status Code | Status code of payment for week: PROC = processed; |
| CREATE_DT | Create Date | Timestamp of when the payment request was submitted |
| CREATE_USER | Create User | ID of user who submitted transaction |
| MDFCTN_DT | Modification date | Date of modification of existing record; will match CREATE_DT if no updates have occurred |
| UPDATE_NU | Update Number | Sequencial number of update to existing record |
| OP_AM | Overpayment Amount | Amount determined overpaid for this particular week, if overpayment has been determined |
| ACCT_DT | Account Date | Sunday of the first week for which the account is effective |
| APP_SUBM_DT | Application Submit Date | Timestamp of submission of application for account |
| TRANSITION_ACCT_IN | Transition Account Indicator | Indicator as to whether or not the preceding account ended immediately before this account |
| SOC | Standardized Occupational Code | Occupational code indicated by applicant |
| SOC_YRS | Standardized Occupational Code—Years | Number of years applicant indicated spent in occupation |
| TAX_WHLD_CD | Tax Withholding | Withholding preference; None, Federal, State, or Federal and State |
| APP_SRCE_CD | Application Source Code | Method of application: WEBA = Internet, IVR = Interactive Voice Response |
| UNION_MEMBER_IN | Union Member | Union membership indicated at time of application |
| MN_UNION_CD | Union | Actual union the applicant indicates they belong to |
| SEASONAL_WORK_IN | Seasonal Work Indicator | Seasonal work indicated by applicant at time of application |
| RECALL_DT | Recall Date | Date of expected recall if union indicated |
| BIRTH_YR | Birth Year | Year of birth of applicant |
| GENDER_CD | Gender | Gender |
| ISSUE_STATE_CD | State that issued MV license | MV License is optional; state is listed if applicant provided MV License number at application |
| CTZN_IN | Citizen Indicator | Citizen Indicator |
| MLT_VET_IN | Military Veteran indicator | Military Veteran indicator |
| ETHN_CD | Ethnicity Code | Ethnicity Code |
| RACE_CD | Race Code | Race Code |
| EDUC_CD | Education Code | Level of education |
| HANDICAP_IN | Handicap indicator | Handicap indicator |
| ALIEN_AUTH_DOC_TP | Alien authorization card type | Alien authorization card type |
| ALIEN_AUTH_DOC_ID | Alien authorization document number | Alien authorization document number |
| DATA_PRVC_AUTH_DT | Data Privacy Authorization Date | Date that applicant completed authorization of use of data |
| Application_Lag | Application Lag | Measurement of time from initiation of application to submission of application |
| WRKFRC_CNTR_CD | Workforce Center Code | ID code of Workforce Center to which applicant is assigned for work search purposes |
| COMUTER_RNG_IN | Commuter Range Indicator | |
| ADDR_TYPE_CD | Address Type Code | Indicates mail address versus collections address for applicant |
| ZIP_5 | Zip Code | First five digits of zip code of mail address |
| COUNTY_CD | County Code | County of mail address |
| COMMUNITY_CD | Community Code | Community Code for mail address |
| HOME_NU_PREF | Home Telephone Number Prefix | Area code of home telephone number if provided |
| CELL_NU_PREF | Cell Number Prefix | Area code of cell telephone number if provided |
| OTHR_NU_PREF | Other telephone number prefix | Area code of other telephone number if provided |
| EMAIL_IN | Email Indicator | Indicates whether applicant chooses to receive email correspondence |
| ADDRESS_MDFCTN_DT | Address Modification Date | Date of most recent address modification |
| LAST_EMPR_NAICS_CD | Last Employer NAICS code | NAICS code of most recent employer |
| BP_EMPLRS | Base Period Employers | Count of base period employers |
| OP_AMT | Overpayment Amount | Amount determined overpaid on account, if overpayment has been determined |
| MBA_AM | Maximum Benefit Amount | The maximum amount of benefits that the applicant was eligible to |
| | | receive for the entire life of this account. If the value is null, that |
| | | means that there isn't an “Active” monetary associated with this |
| | | account. |
| LENGTH_OF_EMPLOYMENT | Employment Duration | The number of days for employment begin date to employment end |
| | | date of the separating employer |
| MODIFIED | Employment Duration Modification Indicator | Value of “Modified” or “Not Modified” indicate whether a business |
| | | process modified the employment end date, which could potentially |
| | | make the “LENGTH_OF_EMPLOYMENT” data unreliable |
| PREV_ACCTS | Number of Previous Account | The total number of accounts created in the 5 years prior to the filing |
| | | of the substantive account. If the value is null, there have been no |
| | | accounts filed in the prior 5 years. |
| MOST_RECENT_ACCT_DT | Most Recent Account Date | The Account Date of the most recent of the previous accounts. If the |
| | | value is null, there have been no accounts filed in the prior 5 years. |
| ACCTS_WITH_OP | Number of Accounts With OP | The total number of accounts created in the 5 years prior to the filing |
| | | of the substantive account with a fraud OP |
| SUM_OPS | Sum of Overpayments | The total amount of overpayments for all previous accounts with |
| | | fraud overpayments. If the value is null, there have been no |
| | | accounts with fraud OP's filed in the prior 5 years. |
| TOTAL_PAID_PREV_ACCTS | Amount Paid on Previous Accounts | The total amount paid on the accounts created in the prior 5 years. |
| | | If the value is null, there have been no accounts filed in the prior 5 |
| | | years. |

APPENDIX D
Exemplary Variable List For Auto BI Association Rule Creation
The full list of variables to consider for association rules creation is:

| Variable Name | Description |
|---|---|
| ACC_DAY | Day of week when an accident occurred |
| | (1 = Sunday to 7 = Saturday) |
| ACCCLMTSTATEIND | Indicates if accident state is the same as |
| | claimant's state (0 = no, 1 = yes) |
| ACCIDENTYEAR | Accident Year |
| ACCOPENLAG | Lag (in days) between accident date and BI |
| | line open date |
| ACCPOLEXPLAG | Lag (in days) between accident date and |
| | policy term expiration date |
| ATTYLIT_LAG | Lag between Attorney and Litigation |
| ATTYST_LAG | Lag between Attorney and Statute limit |
| AWARDSETTLE | Cumulative award settlement amounts paid- |
| | to-date (TS) |
| BILAD45_SUIT | Lawsuit known at BILAD + 45 days |
| BILADATTY_LAG | Lag between Attorney and BILAD |
| BILADLT_LAG | Lag between BILAD and Litigation |
| BILADST_LAG | Lag between Statute and BILAD |
| CATYGT50MILE | Claimant located more than 50 miles from |
| | attorney |
| CLMNT_ATTACHED_TRAILER | Claimant Part Attached Trailer |
| CLMNT_BUMPER | Claimant Part Bumper |
| CLMNT_DEPLOYED_AIRBAGS | Claimant Part Deployed Airbag |
| CLMNT_DRIVER_FRONT | Claimant Part Driver Front |
| CLMNT_DRIVER_REAR | Claimant Part Driver Rear |
| CLMNT_DRIVER_SIDE | Claimant Part Driver Side |
| CLMNT_ENGINE | Claimant Part Engine |
| CLMNT_FRONT | Claimant Part Front |
| CLMNT_GLASS_ALL_OTHER | Claimant Part Glass Other |
| CLMNT_HEADLIGHTS | Claimant Part Headlights |
| CLMNT_HOOD | Claimant Part Hood |
| CLMNT_INTERIOR | Claimant Part Interior |
| CLMNT_OTHER | Claimant Part Other |
| CLMNT_PASSENGER_FRONT | Claimant Part Passenger Front |
| CLMNT_PASSENGER_REAR | Claimant Part Passenger Rear |
| CLMNT_PASSENGER_SIDE | Claimant Part Passenger Side |
| CLMNT_REAR | Claimant Part Rear |
| CLMNT_ROLLOVER | Claimant Part Roll Over |
| CLMNT_ROOF | Claimant Part Roof |
| CLMNT_SIDE_MIRROR | Claimant Part Side Mirror |
| CLMNT_TIRES | Claimant Part Tires |
| CLMNT_TRUNK | Claimant Part Trunk |
| CLMNT_UNDER_CARRIAGE | Claimant Part Under carriage |
| CLMNT_UNKNOWN | Claimant Part Unknown |
| CLMNT_WINDSHIELD | Claimant Part Windshield |
| CLMNTDMGPARTCNT | Count of damaged parts in claimant's |
| | vehicle |
| CLMSPERCMT | Number of claims for each claimant |
| FRAUDCMTCATY | Claimant Attorney >50 Miles from |
| | Claimant |
| FRAUDCMTCLAIM | Number of claims for each claimant |
| FRAUDCMTPIN | Distance of insured location to Claimant <=2 |
| | miles |
| HARD_DIAG | Hard to Diagnose Indicator |
| HOLIDAY_ACC | Indicates if an accident occurred during the |
| | holiday season (1 = Nov, Dec, Jan) |
| INLOCTOCMTLT2MILES | Distance of insured location to Claimant <=2 |
| | miles |
| LINKEDPDLINE | Indicates if there is a property damage PD |
| | line linked to a BI line (claimant level) |
| LITST_LAG | Lag between litigation and Statute Limit |
| LOSSRPTDATTY_LAG | Lag between Loss Reported and Attorney |
| | Date |
| NABCMTPLCL | Longest Dist claimant to Plaintiff Counsel |
| NABCMTPLCS | Shortest Dist claimant to Plaintiff Counsel |
| NABLOSSCATYL | Longest Dist Loss location to Claimant |
| | Attorney |
| NABLOSSCATYS | Shortest Dist Loss location to Claimant |
| | Attorney |
| NOFAULT_IND | No-Fault State Indicator |
| NUMDAYSPRIORACC | Number of days since the prior accident |
| | (policy level) for any line in prior 3 years |
| | (TS) |
| OUTSIDEUS | Indicates if the accident occurred outside of |
| | the US (0 = no, 1 = yes) |
| PA_LOSS_CENTILE_45CHG | Claim Severity Model Change from BILAD |
| | to 45 Days |
| PA_LOSS_CENTILE_BILAD | Claim Severity Model Score at BILAD |
| PA_LOSS_CENTILE_BILAD45 | Claim Severity Model Score at 45 Days |
| PRIM_ATTACHED_TRAILER | Primary Part Attached Trailer |
| PRIM_BUMPER | Primary Part Bumper |
| PRIM_DEPLOYED_AIRBAGS | Primary Part Deployed Airbag |
| PRIM_DRIVER_FRONT | Primary Part Driver Front |
| PRIM_DRIVER_REAR | Primary Part Driver Rear |
| PRIM_DRIVER_SIDE | Primary Part Driver Side |
| PRIM_ENGINE | Primary Part Engine |
| PRIM_FRONT | Primary Part Front |
| PRIM_GLASS_ALL_OTHER | Primary Part Glass Other |
| PRIM_HEADLIGHTS | Primary Part Headlights |
| PRIM_HOOD | Primary Part Hood |
| PRIM_INTERIOR | Primary Part Interior |
| PRIM_OTHER | Primary Part Other |
| PRIM_PASSENGER_FRONT | Primary Part Passenger Front |
| PRIM_PASSENGER_REAR | Primary Part Passenger Rear |
| PRIM_PASSENGER_SIDE | Primary Part Passenger Side |
| PRIM_REAR | Primary Part Rear |
| PRIM_ROLLOVER | Primary Part Roll Over |
| PRIM_ROOF | Primary Part Roof |
| PRIM_SIDE_MIRROR | Primary Part Side Mirror |
| PRIM_TIRES | Primary Part Tires |
| PRIM_TRUNK | Primary Part Trunk |
| PRIM_UNDER_CARRIAGE | Primary Part Under carriage |
| PRIM_UNKNOWN | Primary Part Unknown |
| PRIM_WINDSHIELD | Primary Part Windshield |
| PRIMINSCLMTSTATEIND | Indicates if primary insured's state is the |
| | same as claimant's state (0 = no, 1 = yes) |
| PRIMINSLUXURYVEHIND | Indicates if primary insured's car is |
| | luxurious (0 = Standard, 1 = Luxury) |
| PRIMINSVHCLEAGE | Age of primary insured's vehicle |
| PRIMINSVHCLPSNGRINV | Number of passengers in primary insured's |
| | vehicle |
| RDENSITY_CLMT | Population density |
| REDUCIND_CLMT | Education Index |
| REPORTLAG | Lag (in days) between accident date and |
| | report date |
| RINCOMEH_CLMT | Median household income |
| RPOP25_CLMT | Percentage of population in age 0-24 |
| RSENIOR_CLMT | Percentage of population in age 65+ |
| RTRANNEW_CLMT | Transportation, cars and trucks, new (% of |
| | annual expenditure) |
| RTTCRIME_CLMT | Total crime index (based on FBI data) |
| SIU_PCT | Percent Claims Referred to SIU, Past 3 |
| | Years |
| SIUCLMCNT_CPREV3 | Count of SIU referrals in the prior 3 years |
| | (policy level) in the prior 3 years (TS) |
| SUIT_WITHIN30DAYS | Suit within 30 days of Loss Reported Date |
| SUITBEFOREEXPIRATION | Suit 30 days before Expiration of Statute |
| TGTATTYIND | Target: Attorney Involvement |
| TGTLOSSSEVADJ | Adj Loss Severity |
| TGTSUITIND | Target: Lawsuit Indicator |
| TGTUNEXPTDSEV | Target: Unexpected Severity |
| TOTCLMCNT_CPREV3 | Insured Total Claim Count Past 3 Years |
| TXT_BRAIN_INJURY | Text Contains Brain Injury |
| TXT_BRAIN_SCARRING | Text Contains Brain Scarring |
| TXT_BRAIN_SURGERY | Text Contains Brain Surgery |
| TXT_BURN | Text Contains Burn |
| TXT_DEATH | Text Contains Death |
| TXT_DISMEMBERMENT | Text Contains Dismemberment |
| TXT_EMOTIONAL_PSYCH_DISTRESS | Emotional/Psychological Distress |
| TXT_ERSC3 | ER: ER at Loss Scene3 - drop more terms |
| TXT_ERWOPOLSC2 | ER: ER at Loss Scene2 w/o the term |
| | “police” |
| TXT_ERWPOLATSC1 | ER: ER at Loss Scene1 w/ the term “police” |
| TXT_FRACTURE | Text Contains Fracture |
| TXT_FRACTURE_HEAD | Text Contains Fracture Head |
| TXT_FRACTURE_MOUTH | Text Contains Fracture Mouth |
| TXT_FRACTURE_NECK | Text Contains Fracture Neck |
| TXT_FRACTURE_SCARRING | Text Contains Fracture Scarring |
| TXT_FRACTURE_SPRAINS | Text Contains Fracture Sprains |
| TXT_FRACTURE_UPPER | Text Contains Fracture Upper |
| TXT_FRAUCTURE_LOWER | Text Contains Fracture Lower |
| TXT_FRAUCTURE_SURGERY | Text Contains Fracture Surgery |
| TXT_HEAD | Text Contains Head |
| TXT_HEARING_LOSS | Text Contains Hearing Loss |
| TXT_JOINT_INJURY | Text Contains Joint Injury |
| TXT_JOINT_LOWER | Text Contains Joint Lower |
| TXT_JOINT_SCARRING | Text Contains Joint Scarring |
| TXT_JOINT_SPRAINS | Joint Sprain |
| TXT_JOINT_SURGERY | Text Contains Joint Surgery |
| TXT_JOINT_UPPER | Text Contains Joint Upper |
| TXT_LACERATION | Text Contains Laceration |
| TXT_LACERATION_HEAD | Text Contains Laceration Head |
| TXT_LACERATION_LOWER | Text Contains Laceration Lower |
| TXT_LACERATION_MOUTH | Text Contains Laceration Mouth |
| TXT_LACERATION_NECK | Text Contains Laceration Neck |
| TXT_LACERATION_SCARRING | Text Contains Laceration Scarring |
| TXT_LACERATION_SURGERY | Text Contains Laceration Surgery |
| TXT_LACERATION_UPPER | Text Contains Laceration Upper |
| TXT_LOWER_EXTREMITIES | Text Contains Lower Extremities |
| TXT_MOUTH | Text Contains Mouth |
| TXT_NECK_TRUNK | Text Contains Neck Trunk |
| TXT_PARALYSIS | Text Contains Paralysis |
| TXT_PARTYING_PARTY | Text Contains Partying Party |
| TXT_PED_BIKE_SCOOTER | Text Contains Ped Bike Scooter |
| TXT_SCARRING_DISFIGUREMENT | Text Contains Scarring Disfigurement |
| TXT_SPINAL_CORD_BACK_NECK | Text Contains Spinal Cord Back Neck |
| TXT_SPINAL_SCARRING | Text Contains Spinal Scarring |
| TXT_SPINAL_SPRAINS | Spinal Sprain |
| TXT_SPINAL_SURGERY | Text Contains Spinal Surgery |
| TXT_SPRAINS_STRAINS | Sprains and Strains |
| TXT_SURGERY | Text Contains Surgery |
| TXT_UPPER_EXTREMITIES | Text Contains Upper Extremities |
| TXT_VISION_LOSS | Vision Loss |

### Appendix E

### Exemplary Algorithm to Find A_{R}: The Set of Association Rules Generated to Evaluate New claims

1) Create soft tissue injury binary variable:
   a. Let N=total claims
   b. Let cᵢ=claim i
   c. For i=1 to N: If cᵢ contains only soft tissue¹ injuries then sᵢ=1, Else sᵢ=0 ¹Neck, back or joint, strains and sprains
2) Determine empirical cut points:
   a. Let V={all variables in consideration for LHS combinations}
   b. For all VεV:
      i. If vε [symbol] then find m=median(v); Store m as Empirical Cut Point v
      ii. If vᵢ≦m then set \acute{v}ₗ=0, Else set \acute{v}ₗ=1; i=1, 2, . . . , N
      iii. If v not in [symbol] then generate 0-1 binary dummy variables v′_{γ}
3) Initialize α=0.9
4) Set M=maximum number of rules to evaluate
5) Let C_{N}={all claims}
6) Let C_{T}={cᵢ|cᵢ was not referred to SIU and was not determined fraudulent};
   i=1, 2, N;
   Note: C_{T}⊂C_{N} is the set of Normal claims
7) Generate the set A of association rules² from {\acute{V},s} such that Confidence≧α where cᵢεC_{T} ² Using Apriori Algorithm or similar for generating probabilistic association rules
8) Let Aₛ={A: {sᵢ=1}εRHS(aⱼεA)}
9) If |Aₛ|>M then increase α and repeat steps 8 and 9
10) Let F={cᵢ|cᵢεAₛ∩cᵢ not in LHS(Aₛ)}; i=1, 2, . . . , T; claim i has sᵢ=1 but violates LHS rules for rule Aₛ
11) For each Fᵢ calculate the fraud rate R(Fᵢ)
12) Calculate R(C_{T}) the overall rate of fraud for all claims
13) Let A_{R}={Aₛ:R(Fᵢ)>R(C_{T})}; all rules for which LHS violations produce higher rates of fraud than the overall rate of fraud

### Appendix F

### Exemplary Algorithm to Score Claims Using Association Rules

1) Load claims from raw database
2) Create soft tissue injury binary variable:
   1. Let N=total claims
   2. Let cᵢ=claim i
   3. For i=1 to N: If cᵢ contains only soft tissue injuries then sᵢ=1, Else sᵢ=0
3) Create Empirical Cut Points
   1. Let V={all variables needed to evaluate LHS combinations}
   2. For all vεV:
      i. If vε [symbol] then m=Empirical Cut Point
      ii. If vᵢ≦m then set \acute{v}ₗ=0, Else set \acute{v}ₗ=1; i=1, 2, . . . , N
      iii. If v not in [symbol] then generate 0-1 binary dummy variables v′_{γ}
4) Let Cₛ={V∪s|sᵢεRHS(A_{R})}; i=1, 2, . . . , N: keep all claims satisfying the RHS rules
5) For each claim cⱼεCₛ:
   1. Denote
      αₗ^{j}={variable components of cⱼ used to evaluate rule αₗεA_{R}}
   2. Set n=0
   3. Denote r as the violation threshold
   4. Denote r as the total number of rules
   5. For l=1 to r:
      a. If αₗ^{j}εLHS(A_{R}) then STOP: allow claim cⱼ to follow normal claims process
      b. Else if αₗ^{j} not in LHS(A_{R}) then set n=n+1
         i. If n≧τ then STOP: refer claim cⱼ to SIU
         ii. Else If n<τ and l<R then increment l and go to a.
         iii. Else allow claim cⱼ to follow normal claims process

1. A fraud detection method, comprising:
obtaining data relating to a sample set of claims or transactions made to one of an insurer, guarantor, financial institution, and payor;
obtaining external data relating to at least one of the claims, submissions, claimants, incidents and transactions giving rise to the claims or transactions in the set;
using at least in part at least one data processing device, identifying from the data and the external data a set of variables usable to discover patterns in the data;
using the at least one data processing device, discovering patterns in the set of variables that at least one of: indicate a normal profile of said claims or transactions, indicate an anomalous profile of said claims or transactions, and indicate a high propensity of fraud in said claims or transactions;
assigning a new claim, not in the sample set, to at least one of the profiles; and
outputting the identified potentially fraudulent new claims to a user as a basis for an investigative course of action.

2. The method of claim 1, further comprising outputting at least one of: the discovered patterns, reasons why the claim was assigned to the profile to which it was assigned, and a course of action to a user.

3. The method of claim 1, wherein the high propensity of fraud profile is a subset of the anomalous profile.

4. The method of claim 1, wherein the high propensity of fraud profile is a subset of the normal profile.

5. The method of claim 1, wherein the patterns are expressed in a set of association rules.

6. The method of claim 5, wherein the discovered patterns indicate a normal profile for the set of claims, and claims not in the sample set are evaluated as not being normal if a defined set of the association rules are violated.

7. The method of claim 5, wherein the discovered patterns indicate one of an abnormal profile and a fraudulent profile for the set of claims, and claims not in the sample set are evaluated as being abnormal or fraudulent if a defined set of the association rules are satisfied.

8. The method of claim 1, wherein the patterns are expressed in a set of clusters of claims.

9. The method of claim 8, wherein a new claim is assigned to a cluster.

10. The method of claim 8, wherein a new claim is assigned to a cluster based on minimizing the aggregated distance of its component variables to a cluster center.

11. The method of claim 8, wherein ones of the clusters are scored as to likelihood of fraud, and wherein when the new claim is assigned to a scored cluster, it is identified to have the same score as to likelihood of fraud.

12. The method of claim 8, wherein ones of the clusters are scored as to likelihood of fraud, and wherein when the new claim is assigned to a scored cluster, its likelihood of fraud is determined by one of a decision tree based on decomposition of the cluster and aggregate distance from the center of the cluster.

13. The method of claim 1, further comprising referring the identified potentially fraudulent claims to an investigation unit.

14. The method of claim 5, wherein the association rules are of the type Left Hand Side implies Right Hand Side with underlying support confidence and lift.

15. The method of claim 1, further comprising generating synthetic variables from the data and the external data, and utilizing the synthetic variables in the pattern discovery.

16. The method of claim 15, wherein said synthetic variables are at least in part automatically discovered.

17. The method of claim 1, wherein identifying the set of variables includes variables whose values are imputed in part.

18. The method of claim 5, wherein the association rules include expressions of various bins of the set of variables.

19. The method of claim 17, wherein bins for variables can be automatically generated using the at least one data processing device.

20. The method of claim 1, wherein the set of variables includes variables on self-reported claim elements that are one of difficult to verify and take a long time to verify.

21. The method of claim 8, wherein the clusters are generated by unsupervised clustering methods to identify natural homogenous pockets of the data with higher than average fraud propensity.

22. The method of claim 8, wherein the clusters include expressions of various bins of the set of variables.

23. The method of claim 22, wherein bins for variables are automatically generated using the at least one data processing device.

24. The method of claim 8, wherein ones of the clusters are scored as to likelihood of fraud using an ensemble of fraud detection techniques.

25. The method of claim 1, wherein said discovered patterns indicate a normal profile of said claims or transactions, and said normal profile is used to filter out normal claims, leaving not normal claims for further investigation or analysis.

26. The method of claim 1, wherein said discovered patterns indicate both (i) a normal profile of said claims or transactions, and (ii) an anomalous profile of said claims or transactions, and said normal profile is first used to filter out normal claims, followed by applying the anomalous profile to not normal claims to obtain a set of claims for further investigation or analysis.

27. A non-transitory computer readable medium containing instructions that, when executed by at least one processor of a computing device, cause the computing device to:
receive a set of patterns in a set of predictive variables that at least one of:
indicate a normal profile of claims or transactions, indicate an anomalous profile of said claims or transactions, and indicate a high propensity of fraud in said claims or transactions;
receive at least one new claim or transaction;
assign the at least one new claim or transaction to at least one of the profiles; and
output any identified potentially fraudulent new claims to a user as a basis for an investigative course of action.

28. (canceled)

29. (canceled)

30. The non-transitory computer readable medium of claim 27, wherein the patterns are expressed in a set of association rules.

31. (canceled)

32. (canceled)

33. The non-transitory computer readable medium of claim 27, wherein the patterns are expressed in a set of clusters of claims.

34. (canceled)

35. (canceled)

36. (canceled)

37. (canceled)

38. (canceled)

39. (canceled)

40. The non-transitory computer readable medium of claim 27, wherein said predictive variables include synthetic variables that are utilized in the patterns.

41. (canceled)

42. (canceled)

43. (canceled)

44. (canceled)

45. (canceled)

46. A system for fraud detection, comprising:
one or more data processors; and
memory containing instructions that, when executed, cause one or more processors to, at least in part:
obtain data relating to a sample set of claims or transactions made to one of an insurer, guarantor, financial institution, and payor;
obtain external data relating to at least one of the claims, submissions, claimants, incidents and transactions giving rise to the claims or transactions in the set;
identify from the data and the external data a set of variables usable to discover patterns in the data;
discover patterns in the set of variables that at least one of indicate a normal profile of said claims or transactions, indicate an anomalous profile of said claims or transactions, and indicate a high propensity of fraud in said claims or transactions;
assign a new claim, not in the sample set, to at least one of the profiles; and
output the identified potentially fraudulent new claims to a user as a basis for an investigative course of action.

47. (canceled)

48. (canceled)

49. A system for fraud detection, comprising:
one or more data processors; and
memory containing instructions that, when executed, cause one or more processors to, at least in part:
receive a set of patterns in a set of predictive variables that at least one of:
indicate a normal profile of claims or transactions, indicate an anomalous profile of said claims or transactions, and indicate a high propensity of fraud in said claims or transactions;
receive at least one new claim or transaction;
assign the at least one new claim or transaction to at least one of the profiles; and
output any identified potentially fraudulent new claims to a user as a basis for an investigative course of action.

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. The system of claim 49, wherein said instructions further cause the one or more processors to generate synthetic variables from the data and the external data, and utilize the synthetic variables in the pattern discovery.

63. (canceled)

64. (canceled)
